(19) United States
(12) Patent Application Publication
(10) Pub. No.: US 2009/0162475 A1
(43) Pub. Date: Jun. 25, 2009

(54) Gum Structure Mixing Systems And Methods

(75) Inventors: James A. Duggan, Machesney Park, IL (US); Jose Angel Amarista, Morristown, NJ (US); George Albert Barrera, Caledonia, IL (US); Joseph M. Bunkers, Caledonia, IL (US); Arthur W. Upmann, Rockford, IL (US); Miles van Niekerk, Madison, NJ (US); Glenn Thompson Visscher, Morris Plains, NJ (US)

Correspondence Address: REINHART BOERNER VAN DEUREN P.C., 2215 PERRYGREEN WAY, ROCKFORD, IL, 61107, US

(73) Assignee: CADBURY ADAMS USA LLC, Parsippany, NJ (US)

(21) Appl. No.: 12/338,428

(22) Filed: Dec. 18, 2008

Related U.S. Application Data
(60) Provisional application No. 61/016,016, filed on Dec. 21, 2007.
(60) Provisional application No. 61/036,626, filed on Mar. 14, 2008.
(60) Provisional application No. 61/045,764, filed on Apr. 17, 2008.

(51) Int. Cl. A23G 4/00; B29C 47/36

(52) U.S. Cl. 426/3; 366/76.6

(57) ABSTRACT

A system and method for mixing and forming gum structures is provided. The system may include combinations of continuous and batch mixers arranged generally in series for mixing gum base ingredients with subsequent gum ingredients. In one embodiment, the system and method first forms a gum structure that is not a gum base and then adds a subsequent gum ingredient such that the gum structure is less than a gum base in combination with a subsequent gum ingredient. In other embodiments, the system and method includes forming a gum base in addition to some subsequent gum ingredients that are not quite finished gum. Further, in other embodiments, the system and method may perform some of the mixing of the ingredients at a first location while mixing of further ingredients is performed at a remote location.

### CROSS-REFERENCE TO RELATED PATENT APPLICATIONS

This patent application claims the benefit of U.S. Provisional Patent Application Nos. 61/016,016, filed Dec. 21, 2007; 61/036,626, filed Mar. 14, 2008; and 61/045,764 filed Apr. 17, 2008, the entire teachings and disclosure of which are incorporated herein by reference thereto.

### FIELD OF THE INVENTION

This invention generally relates to methods and systems for mixing and forming gum structures, and more particularly methods and systems that use continuous mixing, batch mixing, or combinations thereof to add subsequent gum ingredients to gum base ingredients prior to forming a gum base.

### BACKGROUND OF THE INVENTION

Traditional gum making has conventionally employed a two-step process including, a first step of mixing a gum base and then in a second subsequent step, mixing the gum base with subsequent gum ingredients. During the first mixing step, the gum base is made by mixing various gum base ingredients. The gum base is generally the water insoluble portion of the overall gum that is retained in the mouth throughout the chewing process. The insoluble gum base generally includes elastomers, elastomer plasticizers, resins, fats, oils, waxes, softeners, and filler components. Examples of several mixers arranged in a series for making gum bases are shown in U.S. Pat. No. 3,995,064 entitled METHOD AND SYSTEM FOR FORMING CHEWING GUM BASE AND PRODUCT to Ehrgott et al.; and U.S. Pat. No. 4,459,311 entitled PROCESS FOR PREPARING GUM BASE to DeTora et al. Such mixers may be employed in the present invention. As such, the Applicant hereby incorporates the teachings and disclosures of these patents by reference in their entireties to the extent not inconsistent with the present disclosure.

The next traditional step in the gum making process is using the finished gum base as an ingredient in a separate downstream mixer. The finished gum base forms one ingredient, which is mixed with water soluble subsequent gum ingredients. For example, such a system is disclosed in U.S. Pat. No. 5,045,325 entitled CONTINUOUS PRODUCTION OF CHEWING GUM USING COROTATING TWIN SCREW EXTRUDER to Lesko et al. The gum composition ingredients generally include the water soluble bulk portion of the gum, which dissolves and dissipates in the mouth over a given time period during chewing. Thus, the gum base is differentiated from finished gum composition ingredients, usually, based upon being the water insoluble portion of the finished gum rather than the water soluble. Typically, subsequent gum ingredients, which are added after the formation of a finished gum base, include for example, softeners, bulk sweeteners, high intensity sweeteners, flavoring agents, syrups, sensates, acids, potentiators, colorants and functional ingredients.

More recently, an attempt has been made for automatically and continuously producing a finished gum in a single continuous mixer, e.g. an extruder, which does not employ the separate manufacture of a gum base. Specifically, such an attempt is disclosed in U.S. Pat. No. 5,827,549 entitled PROCESS CONTROL SYSTEM FOR AUTOMATED CONTINUOUS PRODUCTION OF CHEWING GUM to Rancich et al. While certain efficiencies may theoretically be gained through the use of only one mixer to make a finished gum product, the present Inventors have identified several drawbacks of such a system to which the present invention is directed.

### BRIEF SUMMARY OF THE INVENTION

In accordance with the present invention, multiple mixers are employed as opposed to a single mixer in order to produce a gum structure. The gum structure is a broad term that is meant to include at a minimum compounded elastomer material up to and including a finished chewing gum product. Some of the problems with attempting to use a single mixer for making the gum base and the finished gum product identified by the inventors are that a single mixer is inherently limited by sizes constraints and in the case of an extruder a given rotational speed of the extruder screw for all different mixing steps. Further, such a proposal of a single mixer would appear to pose significant temperature management difficulties. Accordingly, by employing multiple mixers, several advantages can be achieved as well as several different unique systems as disclosed herein.

For example, one aspect of the present invention is directed toward a nontraditional method for making a chewing gum structure that comprises mixing gum structure mixtures with at least two separate gum mixers arranged in series and combining gum based ingredients with at least one gum composition ingredient in at least one of the mixers prior to making a gum base. Thus, the traditional two-step method of first making a gum base and then adding traditional gum composition ingredients may not be necessary. Preferably, different types of mixers can be employed including a high intensity shear mixer to masticate and/or compound the elastomer material and then a less intense mixer can be used to achieve different mixing characteristics. For example, a subsequent downstream mixer may employ less intensive shear to complete the gum base and at the same time add some or all of the water soluble subsequent gum ingredients. Such a gum structure effluent, may be a finished gum product or something less that can be suited for further additional mixing.

Another aspect of the present invention is directed toward a mixing system for making a gum structure, including a first mixer and a second mixer downstream of the first mixer and in series with the first mixer. A plurality of ingredient feeders are arranged to feed ingredients into the mixers with at least one of the ingredient feeders arranged to input a water soluble gum composition ingredient prior to generating a finished gum base.

Another aspect of the present invention relates to making either a more traditional or nontraditional gum structure, in which an incomplete gum structure is prepared in stored form for later mixing. The methodology according to this aspect includes compounding and masticating elastomer in combination of at least one compounding aid that may include an elastomer plasticizer or a filler to generate a first mixture. Then, further ingredients are feed into the first mixture to generate a gum structure. The gum structure can be generated into a storable gum structure (such as pellets, agglomerated pellets in a brittle like form and/or molded bricks, or liquid/viscous material) for temporary storage. Thereafter, the storable gum structure is then mixed with at least one additional gum base ingredient to provide at least a finished gum base characteristic. Water soluble gum composition ingredients may be fed into the first mixer prior to generating a storable gum structure.

Several advantages can be had according to this above aspect. For example, the gum structure in stored form can utilize the advantages of mixers employed at one manufacturing plant to prepare and kit a gum structure ingredient that can then be shipped to another manufacturing plant (also referred to as one form of “kitting”). This affords use of other mixers, which may be readily available at another plant for capacity, efficiency, or other practicality reasons. Additionally or in the alternative, such a system may allow for a more practical and efficient way to form gum. For example, certain gum base or ingredients may be more readily available, practical or efficient at one location as compared to another location. Alternately, a separate location may not need to be employed. Instead this aspect may be used solely within a single location to generate other efficiencies or practicalities. For example, different storable gum structures of different properties or characteristics could be combined into a mixer and thereby generate a unique combination for a gum. Otherwise, this aspect can be utilized to generate operating practicalities or efficiencies within the gum manufacturing plant.

Other embodiments of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified schematic of a first embodiment of a gum structure mixing system including three continuous mixers in series;

FIG. 2 is a simplified schematic of a second embodiment of a gum structure mixing system including a first continuous mixer, a second continuous mixer, and a batch mixer aligned generally in series;

FIG. 3 is a simplified schematic of a third embodiment of a gum structure mixing system including a first continuous mixer, a batch mixer, and a second continuous mixer aligned generally in series;

FIG. 4 is a simplified schematic of a fourth embodiment of a gum structure mixing system including a continuous mixer, a first batch mixer, and a second batch mixer aligned generally in series;

FIG. 5 is a simplified schematic of a fifth embodiment of a gum structure mixing system including a first continuous mixer and a second continuous mixer aligned generally in series;

FIG. 6 is a simplified schematic of a sixth embodiment of a gum structure mixing system including a continuous mixer and a batch mixer aligned generally in series;

FIG. 7 is a simplified schematic of a seventh embodiment of a gum structure mixing system including a first batch mixer, a second batch mixer, and a third batch mixer aligned generally in series;

FIG. 8 is a simplified schematic of an eight embodiment of a gum structure mixing system including a first batch mixer, a second batch mixer, and a continuous mixer aligned generally in series;

FIG. 9 is a simplified schematic of a ninth embodiment of a gum structure mixing system including a first batch mixer, continuous mixer and a second batch mixer aligned generally in series;

FIG. 10 is a simplified schematic of a tenth embodiment of a gum structure mixing system including a batch mixer, a first continuous mixer and a second continuous mixer aligned generally in series;

FIG. 11 is a simplified schematic of a third embodiment of a gum structure mixing system including a batch mixer and a continuous mixer aligned generally in series;

FIG. 12 is a simplified schematic of a third embodiment of a gum structure mixing system including a first batch mixer and a second batch mixer aligned generally in series; and

FIG. 13 is a simplified schematic illustration of a gum structure mixing system configured for kitting gum structures, where a portion of the system is located at a first location and a second portion of the system for finishing the gum structure is located at a second location, remote from the first.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

The following disclosure will detail particular embodiments according to the present invention, which provides methods and systems for efficiently mixing and processing ingredients to form a gum structure.

As used herein, “gum structure” includes, but is not limited to, compositions ranging from and inclusive of compounded elastomer to finished gum, which may include compounded elastomer in addition to some compounding aids, master batch gum base, compounded elastomer in addition to some subsequent gum ingredients, compounded elastomer in addition to some gum base ingredients and some subsequent gum ingredients, gum base, gum base in addition to some subsequent gum ingredients, master batch finished gum, and finished gum.

Before explaining the various systems and methods according to the present invention, it is helpful to discuss the general composition of several typical gum structures that are or may be included in forming the most complex gum structure, namely finished gum, that can be made using embodiments of the systems and methods of the present invention.

A “finished gum”, as used herein, will refer to a gum structure that is generally ready for preparation to distribute the product to the consumer. As such, a finished gum may still require temperature conditioning, forming, shaping, packaging and coating. However, the gum composition itself is generally finished. Not all finished gums have the same ingredients or the same amounts of individual ingredients. By varying the ingredients and amounts of ingredients, textures, flavor and sensations, among other things, can be varied to provide differing characteristics to meet the needs of users.

As is generally well known, a finished gum generally includes a water soluble bulk portion, a water insoluble gum base portion, and one or more flavoring agents. The water soluble portion dissipates over a period of time during chewing. The gum base portion is retained in the mouth throughout the chewing process. A finished gum is typically ready for user consumption.

A “finished gum base”, as used herein, will refer to a gum structure that includes a sufficient combination of gum base ingredients that need only be combined with subsequent gum ingredients to form a finished gum. A finished gum base is a chewable visco-elastic material that includes at least a viscous component, an elastic component, and a softener component. For example, a typical gum base may include elastomer, at least some of the filler, resin and/or plasticizer, polyvinyl acetate, and a softener (such as an oil, fat or wax). Merely compounded elastomer without the addition of any softener, for example, would not be a finished gum base because it would not be considered useable in a finished gum structure because of its difficulty, if not impossibility, to chew.

Ingredients

Gum structures may include a vast number of ingredients in various categories. Systems and methods of the present invention may be used to mix any and all known ingredients including, but not limited to, ingredients in the following ingredient categories: elastomers, bulking agents, elastomer plasticizers (which includes resins), elastomer solvents, plasticizers, fats, waxes, fillers, antioxidants, sweeteners (e.g. bulk sweeteners and high intensity sweeteners), syrups/fluids, flavors, sensates, potentiators, acids, emulsifiers, colors, and functional ingredients.

The insoluble gum base generally includes ingredients falling under the following categories: elastomers, elastomer plasticizers (resins or solevents), plasticizers, fats, oils, waxes, softeners and fillers. Further discussion of representative ingredients within each category will be provided later on. The gum base may constitute between 5-95% by weight of a finished gum, more typically 10-50% by weight of the finished gum, and most commonly 20-30% by weight of the finished gum.

The water soluble portion of finished gum may includes subsequent gum ingredients falling under the following categories: softeners, bulk sweeteners, high intensity sweeteners, flavoring agents, acids, additional fillers, functional ingredients and combinations thereof. Softeners are added to the gum in order to optimize the chewability and mouth feel of the gum. The softeners, which are also known as plasticizers, plasticizing agents or emulsifiers, generally constitute between about 0.5-15% by weight of the gum structure. Bulk sweeteners constitute between 5-95% by weight of the gum structure, more typically 20-80% by weight of the gum and most commonly 30-60% by weight of the gum. High intensity sweeteners may also be present and are commonly used with sugarless sweeteners. When used, high intensity sweeteners typically constitute between 0.001-5% by weight of the gum structure, preferably between 0.01-3% by weight of the chewing gum. Typically, high intensity sweeteners are at least 20 times sweeter than sucrose.

Flavor should generally be present in the gum in an amount within the range of about 0.1-15% by weight of the chewing gum, preferably between about 0.2-5% by weight of the gum, most preferably between about 0.5-3% by weight of the gum. Natural and artificial flavoring agents may be used and combined in any sensorially acceptable fashion.

When included, acids typically constitute between about 0.001-5% by weight of the gum structure.

Optional ingredients such as colors, functional ingredients and additional flavoring agents may also be included in gum structures.

Now that a more general overview has been provided as to general common ingredients, more details about individual categories of ingredients and examples of specific ingredients with in various categories will be provided below.

Elastomers

The elastomers (rubbers) employed in the gum structure will vary greatly depending upon various factors such as the type of gum structure desired, the consistency of gum structure desired and the other components used in the gum structure. The elastomer may be any water-insoluble polymer known in the art, and includes those polymers utilized for chewing gums and bubble gums. Illustrative examples of suitable polymers in gum structures, and particularly gum bases, include both natural and synthetic elastomers. For example, those polymers which are suitable in gum structures include, without limitation, natural substances (of vegetable origin) such as caspi, chicle, natural rubber, crown gum, nispero, rosidinha, jelutong, guayule, perillo, niger gutta, tunu, balata, guttapercha, lechi capsi, sorva, gutta kay, and the like, and combinations thereof. Examples of synthetic elastomers include, without limitation, styrene-butadiene copolymers (SBR), polyisobutylene, isobutylene-isoprene copolymers, polyethylene, polyvinyl acetate and the like, and combinations thereof. Elastomers constitute between about 10% to about 60% by weight and more commonly between about 35-40% by weight of the gum structure.

Additional useful polymers include: crosslinked polyvinyl pyrrolidone, polymethylmethacrylate; copolymers of lactic acid, polyhydroxyalkanoates, plasticized ethylcellulose, polyvinyl acetatephthalate and combinations thereof.

Elastomer Plasticizers

The gum structure may contain elastomer solvents, also referred to herein as elastomer plasticizers, to aid in softening the elastomeric materials. Such elastomer solvents may include those elastomer solvents known in the art, for example, terpinene resins such as polymers of alpha-pinene, beta-pinene or d-limonene, methyl, glycerol and pentaerythritol esters of rosins and modified rosins and gums such as hydrogenated, dimerized and polymerized rosins, and mixtures thereof. Examples of elastomer solvents suitable for use herein may include the pentaerythritol ester of partially hydrogenated wood and gum rosin, the pentaerythritol ester of wood and gum rosin, the glycerol ester of wood rosin, the glycerol ester of partially dimerized wood and gum rosin, the glycerol ester of polymerized wood and gum rosin, the glycerol ester of tall oil rosin, the glycerol ester of wood and gum rosin and the partially hydrogenated wood and gum rosin and the partially hydrogenated methyl ester of wood and rosin, and the like, and mixtures thereof. The elastomer solvent may be employed in the gum structure in amounts from about 2% to about 15%, and preferably from about 7% to about 11%, by weight of the gum structure.

Plasticizers

The gum structure may also include plasticizers or softeners, which also fall under the Wax category described below, to provide a variety of desirable textures and consistency properties. Because of the low molecular weight of these ingredients, the plasticizers and softeners are able to penetrate the fundamental structure of the gum structure making it plastic and less viscous. Useful plasticizers and softeners include triacetin, medium chain triglycerides of non-hydrogenated, partially hydrogenated cotton seed oil, soybean oil, palm oil, palm kernel oil, coconut oil, safflower oil, tallow oil, cocoa butter, terepene resins derived from alpha-pinene, lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerine, and the like, and mixtures thereof. Waxes, for example, natural and synthetic waxes, hydrogenated vegetable oils, petroleum waxes such as polyurethane waxes, polyethylene waxes, paraffin waxes, sorbitan monostearate, tallow, propylene glycol, mixtures thereof, and the like, may also be incorporated into the gum structure. The plasticizers and softeners are generally employed in the gum structure in amounts up to about 20% by weight of the gum structure, and more specifically in amounts from about 9% to about 17%, by weight of the gum structure.

Plasticizers may also include hydrogenated vegetable oils, soybean oil and cottonseed oil which may be employed alone or in combination. These plasticizers provide the gum structure with good texture and soft chew characteristics. These plasticizers and softeners are generally employed in amounts from about 5% to about 14%, and more specifically in amounts from about 5% to about 13.5%, by weight of the gum structure.

Fats

Suitable oils and fats include partially hydrogenated vegetable or animal fats, such as coconut oil, palm kernel oil, beef tallow, and lard, among others. These ingredients when used are generally present in amounts up to about 7%, and preferably up to about 3.5%, by weight of the gum structure.

Waxes

In some embodiments, the gum structure may include wax. Waxes that are used may include synthetic waxes such as waxes containing branched alkanes and copolymerized with monomers such as, but not limited to, polypropylene and polyethylene and Fischer-Tropsch type waxes, petroleum waxes such as paraffin, and microcrystalline wax, and natural waxes such as beeswax, candellia, carnauba, and polyethylene wax, rice bran and petroleum.

It softens the polymeric mixture and improves the elasticity of the gum structure. When present, the waxes employed will have a melting point below about 60° C., and preferably between about 45° C. and about 55° C. The low melting wax may be a paraffin wax. The wax may be present in the gum structure in an amount from about 6% to about 10%, and preferably from about 7% to about 9.5%, by weight of the gum structure.

In addition to the low melting point waxes, waxes having a higher melting point may be used in the gum structure in amounts up to about 5%, by weight of the gum structure. Such high melting waxes include beeswax, vegetable wax, candelilla wax, carnuba wax, most petroleum waxes, and the like, and mixtures thereof.

Fillers

In some embodiments, gum structures formed using the systems and methods according to the teachings of the invention may also include effective amounts of bulking agents such as mineral adjuvants which may serve as fillers and textural agents. Useful mineral adjuvants include calcium carbonate, magnesium carbonate, alumina, aluminum hydroxide, aluminum silicate, talc, clay, titanium oxide, ground limestone, monocalcium phosphate, tricalcium phosphate, dicalcium phosphate, calcium sulfate and the like, and mixtures thereof. These fillers or adjuvants may be used in the gum structure in various amounts. The amount of filler, may be present in an amount from about zero to about 40%, and more specifically from about zero to about 30%, by weight of the gum structure. In some embodiments, the amount of filler will be from about zero to about 15%, more specifically from about 3% to about 11%.

Antioxidants

Antioxidants can include materials that scavenge free radicals. In some embodiments, antioxidants can include but are not limited to ascorbic acid, citric acid (citric acid may be encapsulated), rosemary oil, vitamin A, vitamin E, vitamin E phosphate, butylated hydroxytoluene (BHT), butylated hydroxyanisole (BHA), propyl gallate, tocopherols, di-alpha-tocopheryl phosphate, tocotrienols, alpha lipoic acid, dihydrolipoic acid, xanthophylls, beta cryptoxanthin, lycopene, lutein, zeaxanthin, astaxanthin, beta-carotene, carotenes, mixed carotenoids, polyphenols, flavonoids, and combinations thereof.

Subsequent Ingredients

The gum structure may also include amounts of conventional additives selected from the group consisting of sweetening agents (bulk and high intensity sweeteners), softeners, emulsifiers, fillers, bulking agents (carriers, extenders, bulk sweeteners), flavoring agents (flavors, flavorings), coloring agents (colorants, colorings), functional ingredients, and the like, and mixtures thereof. Some of these additives may serve more than one purpose. For example, in sugarless gum structure, a sweetener, such as maltitol or other sugar alcohol, may also function as a bulking agent and particularly a water soluble bulking agent.

Bulk Sweeteners

Suitable Bulk Sweeteners include monosaccharides, disaccharides and polysaccharides such as xylose, ribulose, glucose (dextrose), lactose, mannose, galactose, fructose (levulose), sucrose (sugar), maltose, invert sugar, partially hydrolyzed starch and corn syrup solids, sugar alcohols, randomly bonded glucose polymers such as those polymers distributed under the tradename Litesse™ which is the brand name for polydextrose and is manufactured by Danisco Sweeteners, Ltd. of 41-51 Brighton Road, Redhill, Surryey, RH16YS, United Kingdom.; isomalt (a racemic mixture of alpha-D-glucopyranosyl-1,6-mannitol and alpha-D-glucopyranosyl-1,6-sorbitol manufactured under the tradename PALATINIT™ by Palatinit Sussungsmittel GmbH of Gotlieb-Daimler-Strause 12 a, 68165 Mannheim, Germany); maltodextrins; hydrogenated starch hydrolysates; hydrogenated hexoses; hydrogenated disaccharides; minerals, such as calcium carbonate, talc, titanium dioxide, dicalcium phosphate; celluloses; and mixtures thereof.

Suitable sugarless bulk sweeteners include sorbitol, xylitol, mannitol, galactitol, lactitol, maltitol, erythritol, isomalt and mixtures thereof. Suitable hydrogenated starch hydrolysates include those disclosed in U.S. Pat. No. 4,279,931 and various hydrogenated glucose syrups and/or powders which contain sorbitol, maltitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN®, a commercially available product manufactured by Roquette Freres of France, and HYSTAR®, a commercially available product manufactured by SPI Polyols, Inc. of New Castle, Del., are also useful.

In some embodiments, the gum structure may include a specific polyol composition including at least one polyol which is from about 30% to about 80% by weight of said gum structure, and specifically from 50% to about 60%. In some embodiments, such gum structures may have low hygroscopicity. The polyol composition may include any polyol known in the art including, but not limited to maltitol, sorbitol, erythritol, xylitol, mannitol, isomalt, lactitol and combinations thereof. Lycasin™ which is a hydrogenated starch hydrolysate including sorbitol and maltitol, may also be used.

The amount of the polyol composition or combination of polyols used in the gum structure will depend on many factors including the type of elastomers used in the gum structure and the particular polyols used. For example, wherein the total amount of the polyol composition is in the range of about 40% to about 65% based on the weight of the gum structure, the amount of isomalt may be from about 40% to about 60% in addition to an amount of sorbitol from about 0 up to about 10%, more specifically, an amount of isomalt may be from about 45% to about 55% in combination with sorbitol from about 5% to about 10% based on the weight of the gum structure.

The polyol composition which may include one or more different polyols which may be derived from a genetically modified organism (“GMO”) or GMO free source. For example, the maltitol may be GMO free maltitol or provided by a hydrogenated starch hydrolysate. For the purposes of this invention, the term “GMO-free” refers to a composition that has been derived from process in which genetically modified organisms are not utilized.

The sweetening agents which may be included in some gum structures formed using systems and methods according to the teachings of the present invention may be any of a variety of sweeteners known in the art and may be used in many distinct physical forms well-known in the art to provide an initial burst of sweetness and/or a prolonged sensation of sweetness. Without being limited thereto, such physical forms include free forms, such as spray dried, powdered, beaded forms, encapsulated forms, and mixtures thereof.

High Intensity Sweeteners

Desirably, the sweetener is a high intensity sweetener such as aspartame, neotame, sucralose, monatin, and acesulfame potassium (Ace-K). The high intensity sweetener can be in an encapsulated form, a free form, or both.

In general, an effective amount of sweetener may be utilized to provide the level of sweetness desired, and this amount may vary with the sweetener selected. In some embodiments the amount of sweetener may be present in amounts from about 0.001% to about 3%, by weight of the gum, depending upon the sweetener or combination of sweeteners used. The exact range of amounts for each type of sweetener may be selected by those skilled in the art.

The sweeteners involved may be selected from a wide range of materials including water-soluble sweeteners, water-soluble artificial sweeteners, water-soluble sweeteners derived from naturally occurring water-soluble sweeteners, dipeptide based sweeteners, and protein based sweeteners, including mixtures thereof. Without being limited to particular sweeteners, representative categories and examples include:

(a) water-soluble sweetening agents such as dihydrochalcones, monellin, steviosides, lo han quo, lo han quo derivatives, glycyrrhizin, dihydroflavenol, and sugar alcohols such as sorbitol, mannitol, maltitol, xylitol, erythritol, and L-aminodicarboxylic acid aminoalkenoic acid ester amides, such as those disclosed in U.S. Pat. No. 4,619,834, which disclosure is incorporated herein by reference, and mixtures thereof,

(b) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and mixtures thereof,

(c) dipeptide based sweeteners, such as L-aspartic acid derived sweeteners, such as L-aspartyl-L-phenylalanine methyl ester (Aspartame), N-[N-(3,3-dimethylbutyl)-L-α-aspartyl]-L-phenylalanine 1-methyl ester (Neotame), and materials described in U.S. Pat. No. 3,492,131, L-alphaaspartyl-N-(2,2,4,4-tetramethyl-3-thietanyl)-D-alaninamide hydrate (Alitame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, and mixtures thereof;

(d) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro 1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro4,6,1′,6′-tetradeoxygalacto-sucrose; and 4,6,1′,6′-tetradeoxy-sucrose, and mixtures thereof;

(e) protein based sweeteners such as thaumaoccous danielli (Thaumatin I and II) and talin; and

(f) the sweetener monatin (2-hydroxy-2-(indol-3-ylmethyl)-4-aminoglutaric acid) and its derivatives.

The intense sweetening agents may be used in many distinct physical forms well-known in the art to provide an initial burst of sweetness and/or a prolonged sensation of sweetness. Without being limited thereto, such physical forms include free forms, spray dried forms, powdered forms, beaded forms, encapsulated forms, and mixtures thereof. In one embodiment, the sweetener is a high intensity sweetener such as aspartame, sucralose, and acesulfame potassium (e.g., Ace-K or acesulfame-K). Several representative forms of encapsulated sweeteners and methods of encapsulating sweeteners are illustrated in U.S. Pat. Nos. 7,244,454; 7,022,352; 6,759,066; 5,217,735 ;5,192,561; 5,164,210; 4,997,659 and 4,981,698 as well as U.S. Patent Application Publication Nos. 2007/0231424; 2004/0096544; 2005/0112236; and 2005/0220867, the teachings and disclosure of which are hereby incorporated in their entireties by reference thereto.

The active component (e.g., sweetener), which is part of the delivery system, may be used in amounts necessary to impart the desired effect associated with use of the active component (e.g., sweetness). In general, an effective amount of intense sweetener may be utilized to provide the level of sweetness desired, and this amount may vary with the sweetener selected. The intense sweetener may be present in amounts from about 0.001% to about 3%, by weight of the composition, depending upon the sweetener or combination of sweeteners used. The exact range of amounts for each type of sweetener may be selected by those skilled in the art.

Syrups

Anhydrous glycerin may also be employed as a softening agent, such as the commercially available United States Pharmacopeia (USP) grade. Glycerin is a syrupy liquid with a sweet warm taste and has a sweetness of about 60% of that of cane sugar. Because glycerin is hygroscopic, the anhydrous glycerin may be maintained under anhydrous conditions throughout the preparation of the gum structure. Other syrups may include corn syrup and maltitol syrup.

Flavorants

In some embodiments, flavorants may include those flavors known to the skilled artisan, such as natural and artificial flavors. These flavorings may be chosen from synthetic flavor oils and flavoring aromatics and/or oils, oleoresins and extracts derived from plants, leaves, flowers, fruits, and so forth, and combinations thereof Nonlimiting representative flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Also useful flavorings are artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, apricot, banana, melon, apricot, ume, cherry, raspberry, blackberry, tropical fruit, mango, mangosteen, pomegranate, papaya and so forth. Other potential flavors whose release profiles can be managed include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors when used in combination with the cooling agents, described herein below. In some embodiments, flavorants may chose from geraniol, linalool, nerol, nerolidal, citronellol, heliotropine, methyl cyclopentelone, ethyl vanillin, maltol, ethyl maltol, furaneol, alliaceous compounds, rose type compounds such as phenethanol, phenylacetic acid, nerol, linalyl esters, jasmine, sandlewood, patchouli, and/or cedarwood.

In some embodiments, other flavorings include aldehydes and esters such as cinnamyl acetate, cinnamaldehyde, citral diethylacetal, dihydrocarvyl acetate, eugenyl formate, p-methylamisol, and so forth may be used. Generally any flavoring or food additive such as those described in Chemicals Used in Food Processing, publication 1274, pages 63-258, by the National Academy of Sciences, may be used. This publication is incorporated herein by reference. These may include natural as well as synthetic flavors.

Further examples of aldehyde flavorings include but are not limited to acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, .e., melonal (melon), 2,6-dimethyloctanal (green fruit), and 2-dodecenal (citrus, mandarin), cherry, grape, blueberry, blackberry, strawberry shortcake, and mixtures thereof.

In some embodiments, flavoring agents are used at levels that provide a perceptible sensory experience i.e. at or above their threshold levels. In other embodiments, flavoring agents are used at levels below their threshold levels such that they do not provide an independent perceptible sensory experience. At subthreshold levels, the flavoring agents may provide an ancillary benefit such as flavor enhancement or potentiation.

In some embodiments, a flavoring agent may be employed in either liquid form and/or dried form. When employed in the latter form, suitable drying means such as spray drying the liquid may be used. Alternatively, the flavoring agent may be absorbed onto water soluble materials, such as cellulose, starch, sugar, maltodextrin, gum arabic and so forth or may be encapsulated. In still other embodiments, the flavoring agent may be adsorbed onto silicas, zeolites, and the like.

In some embodiments, the flavoring agents may be used in many distinct physical forms. Without being limited thereto, such physical forms include free forms, such as spray dried, powdered, beaded forms, encapsulated forms, and mixtures thereof.

Illustrations of the encapsulation of flavors as well as other additional components can be found in the examples provided herein. Typically, encapsulation of a component will result in a delay in the release of the predominant amount of the component during consumption of a gum structure that includes the encapsulated component (e.g., as part of a delivery system added as an ingredient to the gum structure). In some embodiments, the release profile of the ingredient (e.g., the flavor, sweetener, etc.) can be managed by managing various characteristics of the ingredient, delivery system containing the ingredient, and/or the gum structure containing the delivery system and/or how the delivery system is made. For example, characteristics might include one or more of the following: tensile strength of the delivery system, water solubility of the ingredient, water solubility of the encapsulating material, water solubility of the delivery system, ratio of ingredient to encapsulating material in the delivery system, average or maximum particle size of ingredient, average or maximum particle size of ground delivery system, the amount of the ingredient or the delivery system in the gum structure, ratio of different polymers used to encapsulate one or more ingredients, hydrophobicity of one or more polymers used to encapsulate one or more ingredients, hydrophobicity of the delivery system, the type or amount of coating on the delivery system, the type or amount of coating on an ingredient prior to the ingredient being encapsulated, etc.

Sensate Ingredients

Sensate compounds can include cooling agents, warming agents, tingling agents, effervescent agents, and combinations thereof. A variety of well known cooling agents may be employed. For example, among the useful cooling agents are included xylitol, erythritol, dextrose, sorbitol, menthane, menthone, ketals, menthone ketals, menthone glycerol ketals, substituted p-menthanes, acyclic carboxamides, mono menthyl glutarate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropyl butanamide (WS-23), N-ethyl-p-menthane-3-carboxamide (WS-3), isopulegol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol (from Hisamitsu Pharmaceuticals, hereinafter “isopregol”); menthone glycerol ketals (FEMA 3807, tradename FRESCOLAT® type MGA); 3-1-menthoxypropane-1,2-diol (from Takasago, FEMA 3784); and menthyl lactate; (from Haarman & Reimer, FEMA 3748, tradename FRESCOLAT® type ML), WS-30, WS-14, Eucalyptus extract (p-Mehtha-3,8-Diol), Menthol (its natural or synthetic derivatives), Menthol PG carbonate, Menthol EG carbonate, Menthol glyceryl ether, N-tertbutyl-p-menthane-3-carboxamide, P-menthane-3-carboxylic acid glycerol ester, Methyl-2-isopryl-bicyclo (2.2.1), Heptane-2-carboxamide; and Menthol methyl ether, and menthyl pyrrolidone carboxylate among others. These and other suitable cooling agents are further described in the following U.S. patents, all of which are incorporated in their entirety by reference hereto: U.S. Pat. Nos. 4,230,688; 4,032,661; 4,459,425; 4,136,163; 5,266,592; 6,627,233.

In some embodiments, warming components may be selected from a wide variety of compounds known to provide the sensory signal of warming to the user. These compounds offer the perceived sensation of warmth, particularly in the oral cavity, and often enhance the perception of flavors, sweeteners and other organoleptic components. In some embodiments, useful warming compounds can include vanillyl alcohol n-butylether (TK-1000) supplied by Takasago Perfumary Company Limited, Tokyo, Japan, vanillyl alcohol n-propylether, vanillyl alcohol isopropylether, vanillyl alcohol isobutylether, vanillyl alcohol n-aminoether, vanillyl alcohol isoamyleather, vanillyl alcohol n-hexyleather, vanillyl alcohol methylether, vanillyl alcohol ethylether, gingerol, shogaol, paradol, zingerone, capsaicin, dihydrocapsaicin, nordihydrocapsaicin, homocapsaicin, homodihydrocapsaicin, ethanol, isopropyl alcohol, iso-amylalcohol, benzyl alcohol, glycerine, and combinations thereof.

In some embodiments, a tingling sensation can be provided. One such tingling sensation is provided by adding jambu, oleoresin, or spilanthol to some examples. In some embodiments, alkylamides extracted from materials such as jambu or sanshool can be included. Additionally, in some embodiments, a sensation is created due to effervescence. Such effervescence is created by combining an alkaline material with an acidic material. In some embodiments, an alkaline material can include alkali metal carbonates, alkali metal bicarbonates, alkaline earth metal carbonates, alkaline earth metal bicarbonates and mixtures thereof. In some embodiments, an acidic material can include acetic acid, adipic acid, ascorbic acid, butyric acid, citric acid, formic acid, fumaric acid, glyconic acid, lactic acid, phosphoric acid, malic acid, oxalic acid, succinic acid, tartaric acid and combinations thereof. Examples of “tingling” type sensates can be found in U.S. Pat. No. 6,780,443, the entire contents of which are incorporated herein by reference for all purposes.

Sensate components may also be referred to as “trigeminal stimulants” such as those disclosed in U.S. Patent Application No. 205/0202118, which is incorporated herein by reference. Trigeminal stimulants are defined as an orally consumed product or agent that stimulates the trigeminal nerve. Examples of cooling agents which are trigeminal stimulants include menthol, WS-3, N-substituted p-menthane carboxamide, acyclic carboxamides including WS-23, methyl succinate, menthone glycerol ketals, bulk sweeteners such as xylitol, erythritol, dextrose, and sorbitol, and combinations thereof. Trigeminal stimulants can also include flavors, tingling agents, Jambu extract, vanillyl alkyl ethers, such as vanillyl n-butyl ether, spilanthol, Echinacea extract, Northern Prickly Ash extract, capsaicin, capsicum oleoresin, red pepper oleoresin, black pepper oleoresin, piperine, ginger oleoresin, gingerol, shoagol, cinnamon oleoresin, cassia oleoresin, cinnamic aldehyde, eugenol, cyclic acetal of vanillin and menthol glycerin ether, unsaturated amides, and combinations thereof.

In some embodiments, sensate components are used at levels that provide a perceptible sensory experience i.e. at or above their threshold levels. In other embodiments, sensate components are used at levels below their threshold levels such that they do not provide an independent perceptible sensory experience. At subthreshold levels, the sensates may provide an ancillary benefit such as flavor or sweetness enhancement or potentiation.

Potentiator Ingredients

Potentiators can include of materials that may intensify, supplement, modify or enhance the taste and/or aroma perception of an original material without introducing a characteristic taste and/or aroma perception of their own. In some embodiments, potentiators designed to intensify, supplement, modify, or enhance the perception of flavor, sweetness, tartness, umami, kokumi, saltiness and combinations thereof can be included.

In some embodiments, examples of suitable potentiators, also known as taste potentiators include, but are not limited to, neohesperidin dihydrochalcone, chlorogenic acid, alapyridaine, cynarin, miraculin, glupyridaine, pyridinium-betain compounds, glutamates, such as monosodium glutamate and monopotassium glutamate, neotame, thaumatin, tagatose, trehalose, salts, such as sodium chloride, monoammonium glycyrrhizinate, vanilla extract (in ethyl alcohol), sugar acids, potassium chloride, sodium acid sulfate, hydrolyzed vegetable proteins, hydrolyzed animal proteins, yeast extracts, adenosine monophosphate (AMP), glutathione, nucleotides, such as inosine monophosphate, disodium inosinate, xanthosine monophosphate, guanylate monophosphate, alapyridaine (N-(1-carboxyethyl)-6-(hydroxymethyl)pyridinium-3-ol inner salt, sugar beet extract (alcoholic extract), sugarcane leaf essence (alcoholic extract), curculin, strogin, mabinlin, gymnemic acid, hydroxybenzoic acids, 3-hydrobenzoic acid, 2,4-dihydrobenzoic acid, citrus aurantium, vanilla oleoresin, sugarcane leaf essence, maltol, ethyl maltol, vanillin, licorice glycyrrhizinates, compounds that respond to G-protein coupled receptors (T2Rs and T1Rs) and taste potentiator compositions that impart kokumi, as disclosed in U.S. Pat. No. 5,679,397 to Kuroda et al., which is incorporated in its entirety herein by reference. “Kokumi” refers to materials that impart “mouthfulness” and “good body”.

Sweetener potentiators, which are a type of taste potentiator, enhance the taste of sweetness. In some embodiments, exemplary sweetener potentiators include, but are not limited to, monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, sugar beet extract, neotame, thaumatin, neohesperidin dihydrochalcone, hydroxybenzoic acids, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs) and combinations thereof.

Additional examples of potentiators for the enhancement of salt taste include acidic peptides, such as those disclosed in U.S. Pat. No. 6,974,597, herein incorporated by reference. Acidic peptides include peptides having a larger number of acidic amino acids, such as aspartic acid and glutamic acid, than basic amino acids, such as lysine, arginine and histidine. The acidic peptides are obtained by peptide synthesis or by subjecting proteins to hydrolysis using endopeptidase, and if necessary, to deamidation. Suitable proteins for use in the production of the acidic peptides or the peptides obtained by subjecting a protein to hydrolysis and deamidation include plant proteins, (e.g. wheat gluten, corn protein (e.g., zein and gluten meal), soybean protein isolate), animal proteins (e.g., milk proteins such as milk casein and milk whey protein, muscle proteins such as meat protein and fish meat protein, egg white protein and collagen), and microbial proteins (e.g., microbial cell protein and polypeptides produced by microorganisms).

The sensation of warming or cooling effects may also be prolonged with the use of a hydrophobic sweetener as described in U.S. Patent Application Publication 2003/0072842 A1 which is incorporated in its entirety herein by reference.

Food Acid Ingredients

Acids can include, but are not limited to acetic acid, adipic acid, ascorbic acid, butyric acid, citric acid, formic acid, fumaric acid, glyconic acid, lactic acid, phosphoric acid, malic acid, oxalic acid, succinic acid, tartaric acid, aspartic acid, benzoic acid, caffeotannic acid, iso-citric acid, citramalic acid, galacturonic acid, glucuronic acid, glyceric acid, glycolic acid, ketoglutaric acid, a-ketoglutaric acid, lactoisocitric acid, oxalacetic acid, pyruvic acid, quinic acid, shikimic acid, succinic acid, tannic acid, hydroxyacetic acid, suberic acid, sebacic acid, azelaic acid, pimelic acid, capric acid and combinations thereof.

Emulsifiers

The gum structure may also include emulsifiers which aid in dispersing the immiscible components into a single stable system. The emulsifiers useful in this invention include glyceryl monostearate, lecithin, fatty acid monoglycerides, diglycerides, propylene glycol monostearate, methyl cellulose, alginates, carrageenan, xanthan gum, gelatin, carob, tragacanth, locust bean gum, pectin, alginates, galactomannans such as guar gum, carob bean gum, glucomannan, gelatin, starch, starch derivatives, dextrins and cellulose derivatives such as carboxy methyl cellulose, acidulants such as malic acid, adipic acid, citric acid, tartaric acid, fumaric acid, and the like, used alone and mixtures thereof. The emulsifier may be employed in amounts from about 2% to about 15%, and more specifically, from about 7% to about 11%, by weight of the gum structure.

Colors

Coloring agents may be used in amounts effective to produce the desired color. The coloring agents may include pigments which may be incorporated in amounts up to about 6%, by weight of the gum. For example, titanium dioxide may be incorporated in amounts up to about 2%, and preferably less than about 1%, by weight of the gum structure. The colorants may also include natural food colors and dyes suitable for food, drug and cosmetic applications. These colorants are known as F.D.& C. dyes and lakes. The materials acceptable for the foregoing uses are preferably water-soluble. Illustrative nonlimiting examples include the indigoid dye known as F.D.& C. Blue No.2, which is the disodium salt of 5,5-indigotindisulfonic acid. Similarly, the dye known as F.D.& C. Green No. 1 comprises a triphenylmethane dye and is the monosodium salt of 4-[4-(N-ethyl-p-sulfoniumbenzylamino)diphenylmethylene]-[1-(N-ethyl -N-p-sulfoniumbenzyl)-delta-2,5-cyclohexadieneimine]. A full recitation of all F.D.& C. colorants and their corresponding chemical structures may be found in the Kirk-Othmer Encyclopedia of Chemical Technology, 3rd Edition, in volume 5 at pages 857-884, which text is incorporated herein by reference.

As classified by the United States Food, Drug, and Cosmetic Act (21 C.F.R. 73), colors can include exempt from certification colors (sometimes referred to as natural even though they can be synthetically manufactured) and certified colors (sometimes referred to as artificial), or combinations thereof. In some embodiments, exempt from certification or natural colors can include, but are not limited to annatto extract, (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120); carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), and combinations thereof.

In some embodiments, certified colors can include, but are not limited to, FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminium (E173), silver (E174), gold (E175), pigment rubine/lithol rubine BK (E180), calcium carbonate (E170), carbon black (E153), black PN/brilliant black BN (E151), green S/acid brilliant green BS (E142), and combinations thereof. In some embodiments, certified colors can include FD&C aluminum lakes. These include of the aluminum salts of FD&C dyes extended on an insoluble substrate of alumina hydrate. Additionally, in some embodiments, certified colors can be included as calcium salts.

Functional Ingredients

Additional additives including functional ingredients include physiological cooling agents, throat-soothing agents, spices, warming agents, tooth-whitening agents or other dental care ingredients, breath-freshening agents, vitamins, nutraceuticals, phytochemicals, polyphenols, antioxidants, active ingredients, minerals, caffeine, drugs and other actives may also be included in the gum composition. Such components may be used in amounts sufficient to achieve their intended effects and will be more fully discussed below.

Breath Freshening Ingredients

Breath fresheners can include essential oils as well as various aldehydes, alcohols, and similar materials. In some embodiments, essential oils can include oils of spearmint, peppermint, wintergreen, sassafras, chlorophyll, citral, geraniol, cardamom, clove, sage, carvacrol, eucalyptus, cardamom, magnolia bark extract, marjoram, cinnamon, lemon, lime, grapefruit, and orange. In some embodiments, aldehydes such as cinnamic aldehyde and salicylaldehyde can be used. Additionally, chemicals such as menthol, carvone, iso-garrigol, and anethole can function as breath fresheners. Of these, the most commonly employed are oils of peppermint, spearmint and chlorophyll.

In addition to essential oils and chemicals derived from them, in some embodiments breath fresheners can include but are not limited to zinc citrate, zinc acetate, zinc fluoride, zinc ammonium sulfate, zinc bromide, zinc iodide, zinc chloride, zinc nitrate, zinc flurosilicate, zinc gluconate, zinc tartarate, zinc succinate, zinc formate, zinc chromate, zinc phenol sulfonate, zinc dithionate, zinc sulfate, silver nitrate, zinc salicylate, zinc glycerophosphate, copper nitrate, chlorophyll, copper chlorophyll, chlorophyllin, hydrogenated cottonseed oil, chlorine dioxide, beta cyclodextrin, zeolite, silica-based materials, carbon-based materials, enzymes such as laccase, and combinations thereof.

In some embodiments, the release profiles of probiotics can be managed for a gum structure including, but not limited to lactic acid producing microorganisms such as Bacillus coagulans, Bacillus subtilis, Bacillus laterosporus, Bacillus laevolacticus, Sporolactobacillus inulinus, Lactobacillus acidophilus, Lactobacillus curvatus, Lactobacillus plantarum, Lactobacillus jenseni, Lactobacillus casei, Lactobacillus fermentum, Lactococcus lactis, Pedioccocus acidilacti, Pedioccocus pentosaceus, Pedioccocus urinae, Leuconostoc mesenteroides, Bacillus coagulans, Bacillus subtilis, Bacillus laterosporus, Bacillus laevolacticus, Sporolactobacillus inulinus and mixtures thereof. Breath fresheners are also known by the following trade names: Retsyn,™ Actizol,™ and Nutrazin.™ Examples of malodor-controlling compositions are also included in U.S. Pat. No. 5,300,305 to Stapler et al. and in U.S. Patent Application Publication Nos. 2003/0215417 and 2004/0081713 which are incorporated in their entirety herein by reference for all purposes.

Dental Care Ingredients

Dental care ingredients (also known as oral care ingredients) may include but are not limited to tooth whiteners, stain removers, oral cleaning, bleaching agents, desensitizing agents, dental remineralization agents, antibacterial agents, anticaries agents, plaque acid buffering agents, surfactants and anticalculus agents. Non-limiting examples of such ingredients can include, hydrolytic agents including proteolytic enzymes, abrasives such as hydrated silica, calcium carbonate, sodium bicarbonate and alumina, other active stain-removing components such as surface-active agents, including, but not limited to anionic surfactants such as sodium stearate, sodium palminate, sulfated butyl oleate, sodium oleate, salts of fumaric acid, glycerol, hydroxylated lecithin, sodium lauryl sulfate and chelators such as polyphosphates, which are typically employed as tartar control ingredients. In some embodiments, dental care ingredients can also include tetrasodium pyrophosphate and sodium tri-polyphosphate, sodium bicarbonate, sodium acid pyrophosphate, sodium tripolyphosphate, xylitol, sodium hexametaphosphate.

In some embodiments, peroxides such as carbamide peroxide, calcium peroxide, magnesium peroxide, sodium peroxide, hydrogen peroxide, and peroxydiphospate are included. In some embodiments, potassium nitrate and potassium citrate are included. Other examples can include casein glycomacropeptide, calcium casein peptone-calcium phosphate, casein phosphopeptides, casein phosphopeptide-amorphous calcium phosphate (CPP-ACP), and amorphous calcium phosphate. Still other examples can include papaine, krillase, pepsin, trypsin, lysozyme, dextranase, mutanase, glycoamylase, amylase, glucose oxidase, and combinations thereof.

Further examples can include surfactants such as sodium stearate, sodium ricinoleate, and sodium lauryl sulfate surfactants for use in some embodiments to achieve increased prophylactic action and to render the dental care ingredients more cosmetically acceptable. Surfactants can preferably be detersive materials which impart to the composition detersive and foaming properties. Suitable examples of surfactants are water-soluble salts of higher fatty acid monoglyceride monosulfates, such as the sodium salt of the monosulfated monoglyceride of hydgrogenated coconut oil fatty acids, higher alkyl sulfates such as sodium lauryl sulfate, alkyl aryl sulfonates such as sodium dodecyl benzene sulfonate, higher alkyl sulfoacetates, sodium lauryl sulfoacetate, higher fatty acid esters of 1,2-dihydroxy propane sulfonate, and the substantially saturated higher aliphatic acyl amides of lower aliphatic amino carboxylic acid compounds, such as those having 12 to 16 carbons in the fatty acid, alkyl or acyl radicals, and the like. Examples of the last mentioned amides are N-lauroyl sarcosine, and the sodium, potassium, and ethanolamine salts of N-lauroyl, N-myristoyl, or N-palmitoyl sarcosine.

In addition to surfactants, dental care ingredients can include antibacterial agents such as, but not limited to, triclosan, chlorhexidine, zinc citrate, silver nitrate, copper, limonene, and cetyl pyridinium chloride. In some embodiments, additional anticaries agents can include fluoride ions or fluorine-providing components such as inorganic fluoride salts. In some embodiments, soluble alkali metal salts, for example, sodium fluoride, potassium fluoride, sodium fluorosilicate, ammonium fluorosilicate, sodium monofluorophosphate, as well as tin fluorides, such as stannous fluoride and stannous chloride can be included. In some embodiments, a fluorine-containing compound having a beneficial effect on the care and hygiene of the oral cavity, e.g., diminution of enamel solubility in acid and protection of the teeth against decay may also be included as an ingredient. Examples thereof include sodium fluoride, stannous fluoride, potassium fluoride, potassium stannous fluoride (SnF.sub.2-KF), sodium hexafluorostannate, stannous chlorofluoride, sodium fluorozirconate, and sodium monofluorophosphate. In some embodiments, urea is included.

Further examples are included in the following U.S. patents and U.S. published patent applications, the contents of all of which are incorporated in their entirety herein by reference for all purposes: U.S. Pat. No. 5,227,154 to Reynolds, U.S. Pat. No. 5,378,131 to Greenberg, U.S. Pat. No. 6,846,500 to Luo et al., U.S. Pat. No. 6,733,818 to Luo et al., U.S. Pat. No. 6,696,044 to Luo et al., U.S. Pat. No. 6,685,916 to Holme et al., U.S. Pat. No. 6,485,739 to Luo et al., U.S. Pat. No. 6,479,071 to Holme et al., U.S. Pat. No. 6,471,945 to Luo et al., U.S. Patent Publication Nos. 20050025721 to Holme et al., 2005008732 to Gebreselassie et al., and 20040136928 to Holme et al.

Active Ingredients

Actives generally refer to those ingredients that are included in a delivery system and/or gum structure for the desired end benefit they provide to the user. In some embodiments, actives can include medicaments, nutrients, nutraceuticals, herbals, nutritional supplements, pharmaceuticals, drugs, and the like and combinations thereof.

Examples of useful drugs include ace-inhibitors, antianginal drugs, anti-arrhythmias, anti-asthmatics, anti-cholesterolemics, analgesics, anesthetics, anti-convulsants, anti-depressants, anti-diabetic agents, anti-diarrhea preparations, antidotes, anti-histamines, anti-hypertensive drugs, anti-inflammatory agents, anti-lipid agents, anti-manics, anti-nauseants, anti-stroke agents, anti-thyroid preparations, anti-tumor drugs, anti-viral agents, acne drugs, alkaloids, amino acid preparations, anti-tussives, anti-uricemic drugs, anti-viral drugs, anabolic preparations, systemic and non-systemic anti-infective agents, anti-neoplastics, anti-parkinsonian agents, anti-rheumatic agents, appetite stimulants, biological response modifiers, blood modifiers, bone metabolism regulators, cardiovascular agents, central nervous system stimulates, cholinesterase inhibitors, contraceptives, decongestants, dietary supplements, dopamine receptor agonists, endometriosis management agents, enzymes, erectile dysfunction therapies such as sildenafil citrate, which is currently marketed as Viagra™, fertility agents, gastrointestinal agents, homeopathic remedies, hormones, hypercalcemia and hypocalcemia management agents, immunomodulators, immunosuppressives, migraine preparations, motion sickness treatments, muscle relaxants, obesity management agents, osteoporosis preparations, oxytocics, parasympatholytics, parasympathomimetics, prostaglandins, psychotherapeutic agents, respiratory agents, sedatives, smoking cessation aids such as bromocryptine or nicotine, sympatholytics, tremor preparations, urinary tract agents, vasodilators, laxatives, antacids, ion exchange resins, anti-pyretics, appetite suppressants, expectorants, anti-anxiety agents, anti-ulcer agents, anti-inflammatory substances, coronary dilators, cerebral dilators, peripheral vasodilators, psycho-tropics, stimulants, anti-hypertensive drugs, vasoconstrictors, migraine treatments, antibiotics, tranquilizers, anti-psychotics, anti-tumor drugs, anti-coagulants, anti-thrombotic drugs, hypnotics, anti-emetics, anti-nauseants, anti-convulsants, neuromuscular drugs, hyper- and hypo-glycemic agents, thyroid and anti-thyroid preparations, diuretics, anti-spasmodics, terine relaxants, anti-obesity drugs, erythropoietic drugs, anti-asthmatics, cough suppressants, mucolytics, DNA and genetic modifying drugs, and combinations thereof.

Examples of active ingredients contemplated for use in some embodiments can include antacids, H2-antagonists, and analgesics. For example, antacid dosages can be prepared using the ingredients calcium carbonate alone or in combination with magnesium hydroxide, and/or aluminum hydroxide. Moreover, antacids can be used in combination with H2-antagonists.

Analgesics include opiates and opiate derivatives, such as Oxycontin™, ibuprofen, aspirin, acetaminophen, and combinations thereof that may optionally include caffeine.

Other drug active ingredients for use in embodiments can include anti-diarrheals such as Immodium™ AD, anti-histamines, anti-tussives, decongestants, vitamins, and breath fresheners. Also contemplated for use herein are anxiolytics such as Xanax™; anti-psychotics such as Clozaril™ and Haldol™; non-steroidal anti-inflammatories (NSAID's) such as ibuprofen, naproxen sodium, Voltaren™ and Lodine™, anti-histamines such as Claritin™, Hismanal™, Relafen™, and Tavist™; anti-emetics such as Kytril™ and Cesamet™; bronchodilators such as Bentolin™, Proventil™; anti-depressants such as Prozac™, Zolof™, and Paxil™; anti-migraines such as Imigra™, ACE-inhibitors such as Vasotec™, Capoten™ and Zestril™: anti-Alzheimer's agents, such as Nicergoline™: and CaH-antagonists such as Procardia™, Adalat™, and Calan™.

The popular H2-antagonists which are contemplated for use in the present invention include cimetidine, ranitidine hydrochloride, famotidine, nizatidien, ebrotidine, mifentidine, roxatidine, pisatidine and aceroxatidine.

Active antacid ingredients can include, but are not limited to, the following: aluminum hydroxide, dihydroxyaluminum aminoacetate, aminoacetic acid, aluminum phosphate, dihydroxyaluminum sodium carbonate, bicarbonate, bismuth aluminate, bismuth carbonate, bismuth subcarbonate, bismuth subgallate, bismuth subnitrate, bismuth subsilysilate, calcium carbonate, calcium phosphate, citrate ion (acid or salt), amino acetic acid, hydrate magnesium aluminate sulfate, magaldrate, magnesium aluminosilicate, magnesium carbonate, magnesium glycinate, magnesium hydroxide, magnesium oxide, magnesium trisilicate, milk solids, aluminum mono-ordibasic calcium phosphate, tricalcium phosphate, potassium bicarbonate, sodium tartrate, sodium bicarbonate, magnesium aluminosilicates, tartaric acids and salts.

A variety of nutritional supplements may also be used as active ingredients including virtually any vitamin or mineral. For example, vitamin A, vitamin C, vitamin D, vitamin E, vitamin K, vitamin B6, vitamin B12, thiamine, riboflavin, biotin, folic acid, niacin, pantothenic acid, sodium, potassium, calcium, magnesium, phosphorus, sulfur, chlorine, iron, copper, iodine, zinc, selenium, manganese, choline, chromium, molybdenum, fluorine, cobalt and combinations thereof, may be used.

Examples of nutritional supplements that can be used as active ingredients are set forth in U.S. Patent Application Publication Nos. 2003/0157213 A1, 2003/0206993 and 2003/0099741 A1 which are incorporated in their entirety herein by reference for all purposes.

Various herbals may also be used as active ingredients such as those with various medicinal or dietary supplement properties. Herbals are generally aromatic plants or plant parts and or extracts thereof that can be used medicinally or for flavoring. Suitable herbals can be used singly or in various mixtures. Commonly used herbs include Echinacea, Goldenseal, Calendula, Rosemary, Thyme, Kava Kava, Aloe, Blood Root, Grapefruit Seed Extract, Black Cohosh, Ginseng, Guarana, Cranberry, Gingko Biloba, St. John's Wort, Evening Primrose Oil, Yohimbe Bark, Green Tea, Ma Huang, Maca, Bilberry, Lutein, and combinations thereof.

Effervescing System Ingredients

An effervescent system may include one or more edible acids and one or more edible alkaline materials. The edible acid(s) and the edible alkaline material(s) may react together to generate effervescence.

In some embodiments, the alkaline material(s) may be selected from, but is not limited to, alkali metal carbonates, alkali metal bicarbonates, alkaline earth metal carbonates, alkaline earth metal bicarbonates, and combinations thereof. The edible acid(s) may be selected from, but is not limited to, citric acid, phosphoric acid, tartaric acid, malic acid, ascorbic acid, and combinations thereof. In some embodiments, an effervescing system may include one or more other ingredients such as, for example, carbon dioxide, oral care ingredients, flavorants, etc.

For examples of use of an effervescing system in a gum, refer to U.S. Provisional Patent No. 60/618,222 filed Oct. 13, 2004, and entitled “Effervescent Pressed Confectionery Tablet Compositions,” the contents of which are incorporated herein by reference for all purposes. Other examples can be found in U.S. Pat. No. 6,235,318, the contents of which are incorporated herein by reference for all purposes.

Appetite Suppressor Ingredients

Appetite suppressors can be ingredients such as fiber and protein that function to depress the desire to consume food. Appetite suppressors can also include benzphetamine, diethylpropion, mazindol, phendimetrazine, phentermine, hoodia (P57), Olibra,™ ephedra, caffeine and combinations thereof. Appetite suppressors are also known by the following trade names: Adipex,™ Adipost,™ Bontril™ PDM, Bontril™ Slow Release, Didrex,™ Fastin,™ Ionamin,™ Mazanor,™ Melfiat,™ Obenix,™ Phendiet,™ Phendiet-105,™ Phentercot,™ Phentride,™ Plegine,™ Prelu-2,TM Pro-Fast,™ PT 105,™ Sanorex,™ Tenuate,™ Sanorex,™ Tenuate,™ Tenuate Dospan,™ Tepanil Ten-Tab,™ Teramine,™ and Zantryl.™ These and other suitable appetite suppressors are further described in the following U.S. patents, all of which are incorporated in their entirety by reference hereto: U.S. Pat. No. 6,838,431 to Portman, U.S. Pat. No. 6,716,815 to Portman, U.S. Pat. No. 6,558,690 to Portman, U.S. Pat. No. 6,468,962 to Portman, U.S. Pat. No. 6,436,899 to Portman.

Micronutrient Ingredients

Micronutrients can include materials that have an impact on the nutritional well being of an organism even though the quantity required by the organism to have the desired effect is small relative to macronutrients such as protein, carbohydrate, and fat. Micronutrients can include, but are not limited to vitamins, minerals, enzymes, phytochemicals, antioxidants, and combinations thereof.

In some embodiments, vitamins can include fat soluble vitamins such as vitamin A, vitamin D, vitamin E, and vitamin K and combinations thereof. In some embodiments, vitamins can include water soluble vitamins such as vitamin C (ascorbic acid), the B vitamins (thiamine or B1, riboflavoin or B2, niacin or B3, pyridoxine or B6, folic acid or B9, cyanocobalimin or B12, pantothenic acid, biotin), and combinations thereof.

In some embodiments minerals can include but are not limited to sodium, magnesium, chromium, iodine, iron, manganese, calcium, copper, fluoride, potassium, phosphorous, molybdenum, selenium, zinc, and combinations thereof.

In some embodiments micronutrients can include but are not limited to L-carnitine, choline, coenzyme Q10, alpha-lipoic acid, omega-3-fatty acids, pepsin, phytase, trypsin, lipases, proteases, cellulases, and combinations thereof.

In some embodiments phytochemicals can include but are not limited to cartotenoids, chlorophyll, chlorophyllin, fiber, flavanoids, anthocyanins, cyaniding, delphinidin, malvidin, pelargonidin, peonidin, petunidin, flavanols, catechin, epicatechin, epigallocatechin, epigallocatechingallate (EGCG), theaflavins, thearubigins, proanthocyanins, flavonols, quercetin, kaempferol, myricetin, isorhamnetin, flavononeshesperetin, naringenin, eriodictyol, tangeretin, flavones, apigenin, luteolin, lignans, phytoestrogens, resveratrol, isoflavones, daidzein, genistein, glycitein, soy isoflavones, and combinations thereof

Mouth Moistening Ingredients

Mouth moisteners can include, but are not limited to, saliva stimulators such as acids and salts and combinations thereof In some embodiments, acids can include acetic acid, adipic acid, ascorbic acid, butyric acid, citric acid, formic acid, fumaric acid, glyconic acid, lactic acid, phosphoric acid, malic acid, oxalic acid, succinic acid, tartaric acid and combinations thereof. In some embodiments, salts can include sodium chloride, calcium chloride, potassium chloride, magnesium chloride, sea salt, sodium citrate, and combinations thereof

Mouth moisteners can also include hydrocolloid materials that hydrate and may adhere to oral surface to provide a sensation of mouth moistening. Hydrocolloid materials can include naturally occurring materials such as plant exudates, seed confectionerys, and seaweed extracts or they can be chemically modified materials such as cellulose, starch, or natural confectionery derivatives. In some embodiments, hydrocolloid materials can include pectin, gum arabic, acacia gum, alginates, agar, carageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, bacterial gums, and combinations thereof. Additionally, in some embodiments, modified natural gums such as propylene glycol alginate, carboxymethyl locust bean gum, low methoxyl pectin, and their combinations can be included. In some embodiments, modified celluloses can be included such as microcrystalline cellulose, carboxymethlcellulose (CMC), methylcellulose (MC), hydroxypropylmethylcellulose (HPCM), and hydroxypropylcellulose (MPC), and combinations thereof.

Similarly, humectants which can provide a perception of mouth hydration can be included. Such humectants can include, but are not limited to glycerol, sorbitol, polyethylene glycol, erythritol, and xylitol. Additionally, in some embodiments, fats can provide a perception of mouth moistening. Such fats can include medium chain triglycerides, vegetable oils, fish oils, mineral oils, and combinations thereof.

Throat Care Ingredients

Throat soothing ingredients can include analgesics, anesthetics, demulcents, antiseptic, and combinations thereof. In some embodiments, analgesics/anesthetics can include menthol, phenol, hexylresorcinol, benzocaine, dyclonine hydrochloride, benzyl alcohol, salicyl alcohol, and combinations thereof. In some embodiments, demulcents can include but are not limited to slippery elm bark, pectin, gelatin, and combinations thereof In some embodiments, antiseptic ingredients can include cetylpyridinium chloride, domiphen bromide, dequalinium chloride, and combinations thereof

In some embodiments, antitussive ingredients such as chlophedianol hydrochloride, codeine, codeine phosphate, codeine sulfate, dextromethorphan, dextromethorphan hydrobromide, diphenhydramine citrate, and diphenhydramine hydrochloride, and combinations thereof can be included.

In some embodiments, throat soothing agents such as honey, propolis, aloe vera, glycerine, menthol and combinations thereof can be included. In still other embodiments, cough suppressants can be included. Such cough suppressants can fall into two groups: those that alter the consistency or production of phlegm such as mucolytics and expectorants; and those that suppress the coughing reflex such as codeine (narcotic cough suppressants), antihistamines, dextromethorphan and isoproterenol (non-narcotic cough suppressants). In some embodiments, ingredients from either or both groups can be included.

In still other embodiments, antitussives can include, but are not limited to, the group consisting of codeine, dextromethorphan, dextrorphan, diphenhydramine, hydrocodone, noscapine, oxycodone, pentoxyverine and combinations thereof. In some embodiments, antihistamines can include, but are not limited to, acrivastine, azatadine, brompheniramine, chlorpheniramine, clemastine, cyproheptadine, dexbrompheniramine, dimenhydrinate, diphenhydramine, doxylamine, hydroxyzine, meclizine, phenindamine, phenyltoloxamine, promethazine, pyrilamine, tripelennamine, triprolidine and combinations thereof. In some embodiments, non-sedating antihistamines can include, but are not limited to, astemizole, cetirizine, ebastine, fexofenadine, loratidine, terfenadine, and combinations thereof.

In some embodiments, expectorants can include, but are not limited to, ammonium chloride, guaifenesin, ipecac fluid extract, potassium iodide and combinations thereof. In some embodiments, mucolytics can include, but are not limited to, acetylcycsteine, ambroxol, bromhexine and combinations thereof. In some embodiments, analgesic, antipyretic and anti-inflammatory agents can include, but are not limited to, acetaminophen, aspirin, diclofenac, diflunisal, etodolac, fenoprofen, flurbiprofen, ibuprofen, ketoprofen, ketorolac, nabumetone, naproxen, piroxicam, caffeine and mixtures thereof. In some embodiments, local anesthetics can include, but are not limited to, lidocaine, benzocaine, phenol, dyclonine, benzonotate and mixtures thereof.

In some embodiments nasal decongestants and ingredients that provide the perception of nasal clearing can be included. In some embodiments, nasal decongestants can include but are not limited to phenylpropanolamine, pseudoephedrine, ephedrine, phenylephrine, oxymetazoline, and combinations thereof. In some embodiments ingredients that provide a perception of nasal clearing can include but are not limited to menthol, camphor, borneol, ephedrine, eucalyptus oil, peppermint oil, methyl salicylate, bornyl acetate, lavender oil, wasabi extracts, horseradish extracts, and combinations thereof. In some embodiments, a perception of nasal clearing can be provided by odoriferous essential oils, extracts from woods, confectionerys, flowers and other botanicals, resins, animal secretions, and synthetic aromatic materials.

In some embodiments, optional or functional ingredients can include breath fresheners, dental care components, actives, herbals, effervescing systems, appetite suppressors, vitamins, micronutrients, mouth moistening components, throat care components, energy boosting agents, concentration boosting agents, and combinations thereof.

In some embodiments, the modified release component includes at least one ingredient selected from the group comprising flavors, sweeteners, sensates, breath fresheners, dental care components, actives, herbals, effervescing systems, appetite suppressors, potentiators, food acids, micronutrients, mouth moistening components, throat care components, and combinations thereof. These ingredients can be in encapsulated form, in free form, or both.

Mixing Systems & Methods

Now that a review of representative ingredients has been provided, further detail will be had as to mixing systems and methods according to embodiments of the present invention.

Depending on the formulation of the gum structure and the system for mixing and processing the ingredients forming the gum structure, ingredients may be added at various locations within the mixing process, be added at various times within the mixing process, be added at multiple locations within the mixing process, have various residence times within the mixing system, be exposed to various residence temperatures, be added at various weight percentages of the finished gum structure, be blended with other ingredients prior to being added to the mixing systems, and be added for various reasons. Some embodiments of gum structures and methods may include multiple ingredients from a single ingredient category, e.g. one gum structure may have several different elastomer ingredients. In addition, some methods and systems may add ingredients in varying orders. For example, in one implementation, the filler may be added prior to an elastomer, while in another method the elastomer may be added prior to the filler.

Some of the steps of forming gum structures may be performed at various physical locations or at various times. For example, it may be highly efficient to mass produce a first generic gum structure, also referred to as a “master batch”, that may be less than a finished gum or finished gum base, at a central location or in mass quantity during a single production run (i.e. all at one time). Then, at a later time, the master batch is combined with the rest of the ingredients required to form a finished gum. The addition of the rest of the ingredients may occur at the same location or the master batch may be shipped to a remote processing plant where the finished gum is formed. Remote processing may occur, for example, when the final ingredients, which may form a substantial amount of the finished gum by weight percent, can be acquired and processed locally more easily, practically and inexpensively than shipping a completed finished gum or importing the finished composition due to various reasons. Large quantity production may occur, for example, when it is desired to form several finished gum compositions that are substantially similar gum structures except for a few ingredients, such as, for example, finished gums having slightly differing flavors or colors.

Two typical forms of master batch include “gum base master batch” and “finished gum master batch.”

A “gum base master batch”, as used herein is a gum composition that is not yet a finished gum base composition, but it includes some or most of the gum base ingredients for forming a finished gum base. For example, a gum base master batch may be a set of gum base ingredients sufficient to form a finished gum based except for the desired amount of filler or emulsifier. For a more specific example, this set of gum base ingredients may include the elastomers, the plasticizers, and the fats, oils, and waxes required to form the desired finished gum base composition but is devoid of some or all of the necessary filler. For another more specific example, this set of gum base ingredients may include the elastomers, the plasticizers, and the fillers required to form the desired finished gum base composition but is devoid of some or all of the necessary fats, oils, and waxes.

A “finished gum master batch”, as used herein, is a gum composition that is not yet a finished gum composition, but it includes most of the gum base and subsequent gum ingredients necessary to from a finished gum. For example, a finished gum master batch may be a set of gum base ingredients sufficient to form the desired gum base in combination with a set of subsequent gum ingredients that provides the desired sweeteners and potentiators but is devoid of the desired colorants and flavors. The production of a finished gum master batch can be desired in the same situation as discussed above, but for potential reasons such as that desired flavors, and corresponding colors, are very regional specific or much cheaper to obtain in a given region.

Kitting can occur with gum base master batch as well. For example, in a central location a gum base master batch may be formed that includes the elastomers, the plasticizers, and the fats, oils, and waxes required to form the desired finished gum base composition but is devoid of some or all of the necessary filler. This gum base master batch is then distributed to other locations where the requisite necessary filler is subsequently added to complete a finished gum base. This can be highly beneficial when the filler can be acquired at a cheaper rate at the remote location or it is cheaper to acquire the filler at the remote location rather than pay for the increased shipping costs, as filler can provide a large portion of the weight and volume of a finished gum base.

Alternatively, it may be highly efficient to provide a mass production of a very common finished gum master batch, which only requires subsequent processing to add the desired flavoring and color to produce the desired finished gum.

This production of a portion of a finished gum structure, i.e. a master batch, at one location and then finishing the finished gum at a local processing facility is one form of a process that can be referred to as kitting. Another form of kitting is when a large mass production of a master batch is formed and then only a few differing ingredients are added to the master batch to form finished gum compositions, such as explained previously with regard to the finished gum master batch. Kitting occurs, where a large batch of a gum structure, e.g. a master batch, is mixed and then that master batch is then used as an ingredient in producing other gum structures, typically finished gums. Some forms of kitting include the formation of several master batches and then blending these master batches with or without additional ingredients at various ratios to form desired gum bases or finished gums. As such master batch itself can be considered an ingredient.

Processing the ingredients to form gum structures can be performed by mixing the ingredients of the gum structures using many existing mixers known in the art. For example, mixers including, but not limited to, static mixers, kettle mixers, sigma blade mixers, planetary mixers, Hobart mixers, Z-blade gum mixers, kneaders, single screw extruders, twin screw extruders, co-rotating twin-screw extruders, counter-rotating twin-screw extruders, reciprocating extruders, blade-and-pin mixers, etc. can be used to blend and processes gum structures. Other known mixers in the art that may suitably be used in practicing the systems and methods of the present invention are disclosed in previously cited patents that are incorporated in their entirety by reference.

In some embodiments, a mixer can be temperature controlled to maintain the residence temperature at a minimum, maximum or other desired level such as by being steam, cold fluid, or hot fluid jacketed, or otherwise heated or cooled. The term “residence temperature” as used herein will refer to the temperature of a composition while it is in a mixer or processing system at a given location or time. As such, a residence temperature may vary as the mixing process progresses either at different times/stages or at different locations of the mixer.

Mixers may provide different types of mixing depending on the ingredients being mixed or the condition of the ingredients being mixed. Two primary types of mixing include distributive and dispersive mixing. Dispersive mixing is typically high shear mixing that breaks up individual ingredients and aggregations of ingredients within a composition into smaller pieces. Distributive mixing is typically lower shear mixing than distributive mixing and is used to distribute the individual ingredients throughout the composition to provide a more uniform composition. Dispersive and distributive mixing are more thoroughly described and discussed in U.S. Pat. No. 5,562,936, the teachings and disclosure of which are hereby incorporated in their entireties by reference thereto.

As used herein, “a continuous mixer”, which may also be referred to herein as a “continuous processor”, is processing equipment in which the various ingredients used to prepare an effluent are fed substantially continuously into the device while those ingredients are being mixed and removed or ejected from the mixing system. For example, in a continuous mixing extruder, ingredients are substantially continuously introduced through various upstream and downstream feed ports, all the while, the screws, blades, pins, paddles or other mixing elements continue to convey the mixture through the system, all the while mixing the same. At a downstream portion of the extruder, the wholly or partly combined downstream portion of the mass is ejected from the extruder by the force of the mass substantially continually or continually being conveyed. The ejection of the mass from the extruder may be facilitated by inclusion of an external or supplemental pump.

A continuous mixer may provide dispersive mixing, distributive mixing or a combination of both dispersive mixing and distributive mixing. For example, a continuous mixer in the form of an extruder can have all dispersive mixing elements, all distributive mixing elements, or a combination of dispersive mixing elements and distributive mixing elements. Due to the characteristics and requirements of mixing gum compositions, the dispersive mixing elements are typically upstream of the distributive mixing elements, however, continuous mixers according to the present invention are not limited to that arrangement.

Representative continuous mixers and methods of continuously mix gum ingredients are exemplified by the following U.S. Pat. Nos. 7,087,254; 6,858,237; 6,811,797; 6,030,647; 6,017,565; 5,976,581; 5,908,645; 5,827,549; 5,800,847; 5,614,234; 5,612,071; 5,543,160; 6,238,710; 6,086,925; 6,017,566; 6,010,723; 6,004,589; 5,773,053; 5,571,543; 5,567,450; 5,562,936; 5,545,416; 5,523,097; 5,486,366; 5,419,919; 5,397,580; 5,085,872; and 5,045,325, the teachings and disclosure of which are hereby incorporated in their entireties by reference thereto.

As used herein, “a batch mixer”, which may also be referred to herein as a “batch processor”, is processing equipment used to prepare a composition that once the composition is prepared the composition is ejected from the equipment all at once or at least discrete non-continuous portions of the composition will be ejected at intermittent intervals, but the composition is not continuously ejected during mixing. Typically, individual ingredients or portions of the individual ingredients used to prepare the composition are fed into the device substantially all at one time or in a predetermined temporal sequence in discrete amounts. Individual ingredients added to a batch mixer may be added at different times throughout the mixing cycle such that some ingredients have a residence time substantially equal to the entire length of the mixing cycle while other ingredients have a residence time for only a fraction of the entire length of the mixing cycle. Further, individual ingredients that are used for different purposes through out the mixing cycle may have different discrete portions of the ingredient added at different times throughout the mixing process. For example, one ingredient may be used to facilitate compounding elastomer as well as may be used as a bulking agent. Such an ingredient may have a first portion added at the beginning of the mixing cycle such that it has a residence time equal to the entire mixing time while a second portion of the same ingredient may be added later in the mixing cycle such that the second portion has a residence time less than the entire mixing time.

A batch mixer will typically provide either dispersive mixing or distributive mixing, but usually not both dispersive and distributive mixing. A batch mixer used in practicing the present invention could be configured to provide both dispersive and distributive mixing. For example, it is contemplated that a kettle mixer that includes internal blades could be configured to shift between dispersive and distributive mixing by modifying the pitch or orientation of the blades. Alternatively, the kettle mixer could include multiple sets of blades, such that one set is configured for dispersive mixing while another set is configured for distributive mixing. It is contemplated the mixer would most likely only use on set of the blades at a time to provide one type of mixing at a time.

Various systems for and methods of mixing various ingredients to form gum structures will follow.

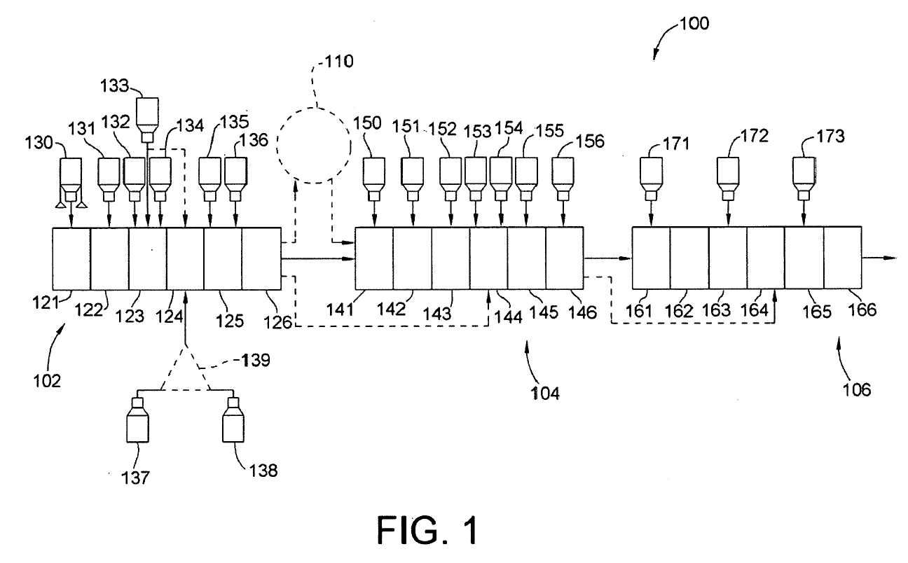

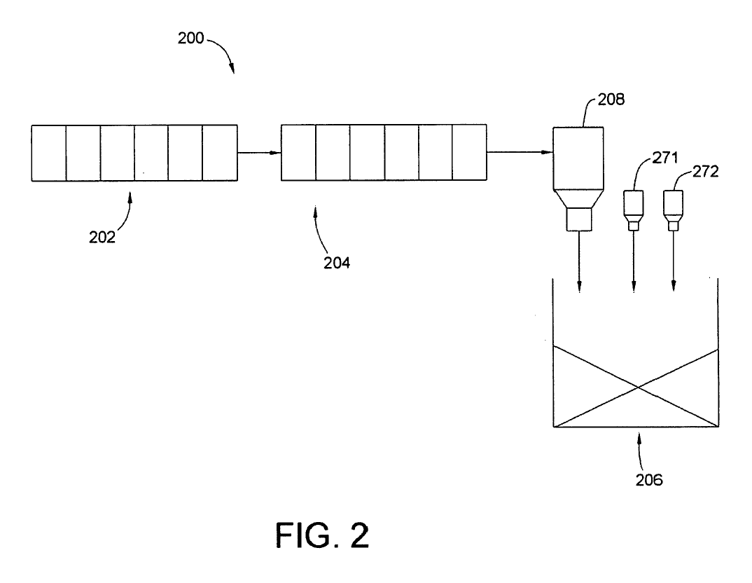

Referring to FIG. 1, a first representative embodiment of a system 100 for use in mixing and processing gum structures is illustrated. This first system 100 will be explained in significant detail, while other embodiments illustrated in FIGS. 2-12, which are similar in many respects to system 100, will be discussed and described in more limited detail highlighting differences and similarities relative to system 100.

System 100 includes three continuous mixers 102, 104, 106 arranged in series, which may comprise any of the aforementioned types of continuous mixers. The three continuous mixers 102, 104, 106 may provide varying levels or types of mixing ranging from high shear dispersive mixing to intermediate or low shear highly distributive mixing, and may even include mixing that is substantially free of shear. Preferably, the first continuous mixer 102 is high shear or includes a high shear section. High shear may alternatively be employed in the second mixer, continuous mixer 104. High sear refers generally to the amount of shear force needed to masticate and compound elastomers.

The continuous mixers 102, 104, 106 include a plurality of feed ports 121-126, 141-146, 161-166, respectively, at which various ingredients may be added to the mixers 102, 104, 106. Continuous mixers 102, 104, 106 are illustrated as each having six feed ports. However, continuous mixers used in practicing embodiments and methods of the present invention are not limited to or require any specific number of feed ports.

The continuous mixers 102, 104, 106 may incorporate any known mixing elements such as high shear elements, low shear elements, kneading elements, neutral elements, high speed elements, low speed elements, etc.

Ingredients may be stored, preferably in a readily available condition, prior to being added to a mixer in ingredient supplies, illustrated schematically in FIG. 1 and identified by reference numerals 131-138, 150-156, 171-173. Representative, ingredient supplies may include storage devices such as gravity flow bins or hoppers, liquid holding tanks or canisters, ingredient impermeable sacks, carts, trays, or other known applicable ingredient storage devices.

The ingredients may be delivered from the ingredient supplies 131-138, 150-156, 171-173 by appropriate ingredient handling systems (individual handling systems are shown schematically as a connecting arrow) such as augers, conveyor belts, side feeders, gravity flow, vacuum conveying systems, liquid pumping, etc. Ingredient handling systems may also incorporate optional blending devices, illustrated schematically and identified by reference numeral 139, such as blenders or low shear mixers. The blending device 139 mixes, also known as pre-blends, ingredients as the ingredients are being delivered from ingredient supplies. For example, ingredient supplies 137, 138 supply ingredients to continuous mixers 102, but prior to being added to the continuous mixer 102. The ingredients from ingredient supplies 137, 138 may be mixed using mixer 139. As a blending device is an optional device to provide some pre-blending and mixing of ingredients, the blending device is illustrated using dashed lines.

Further, the material handling systems will typically include metering devices such as load cells for monitoring the weight loss of a specific ingredient from a given ingredient supply. Alternatively, flow metering devices that measure volume per unit of time may also be used.

As illustrated in FIG. 1, the continuous mixers 102, 104, 106 are aligned generally in series. As such, continuous mixer 102 is upstream from continuous mixer 104 and the effluent of continuous mixer 102 is considered an ingredient added to continuous mixer 104, such as at feed port 141. Similarly, continuous mixer 104 is upstream of continuous mixer 106 and the effluent of continuous mixer 104 is considered an ingredient added to continuous mixer 106, such as at feed port 161.

As used herein, “series” will refer to both (a) the systems described above where the effluent of an upstream mixer is added as the first ingredient in a downstream mixer and (b) the system where the effluent of an upstream mixer is added to a downstream mixer in a downstream feed port. For example, the effluent of continuous mixer 102 may be added to feed port 144 of continuous mixer 104 (illustrated by a dashed line arrow), rather than the first feed port 141 (illustrated as a solid line arrow), whilst other ingredients are being added to continuous mixer 104 upstream of feed port 144 such as to feed ports 141, 142 or 143. Further, an individual mixer, such as any one of continuous mixer 102, 104, 106, may comprise multiple mixers arranged in parallel (but nevertheless in series with the upstream or downstream mixers).

The effluent of continuous mixer 106 will be a gum structure that will typically, but not always, be at least a gum base, something between a gum base and a finished gum, e.g. a gum base plus additional subsequent gum ingredients, or a finished gum, however other gum structure effluents are contemplated. When the effluent is a finished gum, the effluent will be sent on to other gum finishing processes (not shown) including, but not limited to, forming, cooling/conditioning, coating, packaging, shipping, etc.

In some implementations of system 100, the gum structure effluent of the first continuous mixer 102 is not a gum base, but may be something more or may be something less. For example, in a basic implementation, continuous mixer 102 may be used for generally compounding elastomer ingredients such that the effluent of continuous mixer 102 is substantially a compounded elastomer, which may or may not include additional compounding aids. Compounding aids include, by way of example only, fillers, elastomer plasticizers, fats, waxes, resins or combinations thereof. Continuous mixer 102 compounds the elastomer to open up the elastomer matrix such that other ingredients, e.g. the water soluble flavoring or functional ingredients, of a finished gum can be carried by and then released over time as the finished gum is chewed.

Each of the elastomer, filler and elastomer plasticizer can include a single ingredient from each category or can include a combination or combinations of several ingredients from each category of ingredients.

The elastomer, filler and elastomer plasticizer may be fed into the continuous mixer 102 at separate feed ports 121-126 and in varying upstream and downstream arrangements. For example, in some implementations an elastomer ingredient may be fed from ingredient supply 130 to feed port 121 upstream from a filler that is fed from ingredient supply 131 to feed port 122. In other implementations, the filler may be fed from ingredient supply 130 to upstream feed port 130 while the elastomer is fed from ingredient supply 131 to downstream feed port 122 such that the filler is added upstream from the elastomer. This varied arrangement can be applied, where appropriate, to all ingredients added to any of the continuous mixers 102, 104, 106.

In some embodiments and implementations, multiple ingredients such as a filler and an elastomer plasticizer are fed into continuous mixer 102 substantially at the same location or feed port such as a filler may be fed from ingredient supply 132 to feed port 123 while an elastomer plasticizer may be fed from ingredient supply 134 also to feed port 123. Feed port 123 may be provided by one opening that allows multiple ingredients to be fed into the mixer or may include several openings that allow individual or multiple ingredients to be fed into the mixer at substantially equal locations.

In other embodiments and implementations, combinations of the elastomer, filler and/or plasticizer ingredients may be fed into the continuous mixer 102 as a pre-blended mix. For example, one of the elastomer, filler and/or plasticizer may be fed from ingredient supply 137 while another one of the elastomer, filler and/or plasticizer may be fed from supply 138. As these ingredients are fed to feed port 124, the ingredients may be blended such as by an optional blender 139 or merely added together by the ingredient handling system such as an auger, side feeder, fluid flow pipe, a vacuum transporter, conveyor, etc. represented schematically by the connecting arrows.

The addition of ingredients in the continuous mixer can occur at different feed ports so as to partially or wholly mix the ingredients added at a certain point prior to the addition of further ingredients. Also, by varying the location at which various ingredients are added, residence time, residence temperature and types of mixing of a relevant ingredients may be varied, which can be used to vary the characteristics of the gum structure produced by continuous mixer 102. By way of example only, modifying these feed and residence characteristics of individual ingredients can be used to vary the viscosity, texture and consistency of the material to alter the flowability of the composition through the continuous mixer.

Further, an individual ingredient supply, for example feed supply 133 is not limited to storing ingredients for use in a single feed port. For example, feed supply 133 can supply ingredient to both feed port 123 as well as feed port 124. Similarly, a single feed supply may be used for feeding ingredients to multiple mixers.

Additionally, a single ingredient supply may include a plurality of individual temporary storage devices that may serve as a surge device and/or accumulator. For example, a single feed supply could be provided by a plurality of bulk bins connected to a ingredient handling system. In this situation, when one of the storage devices runs empty, the other storage device can be used while filling the empty storage device.

To facilitate compounding and stretching the elastomer, in one embodiment, continuous mixer 102 will be configured for high-shear dispersive mixing. In most implementations, the high-shear dispersive mixing generates high temperatures within the mixer exposing the ingredients within the high-shear portions of the mixer 102 to high residence temperatures. Consequently, the ingredients typically fed to continuous mixer 102 will be ingredients that are generally tolerant of high residence temperatures. The compounding of the elastomer may occur between a range of 125° F. and an excess of 400° F. More typically, compounding residence temperatures will range between about of 225° F. and 375° F.

Cooling can be employed along mixer 102 if desired to facilitate attaining temperatures conducive to other ingredients to afford input of ingredients including water soluble ingredients. Portions of the mixer 102 can be independently cooled as compared to other portions.

Because these ingredients will be exposed to further processing and mixing, e.g. via continuous mixers 104 and 106, these ingredients will also typically be tolerant of longer residence times within the mixing system. The ingredients added to continuous mixers, and particularly continuous mixer 102, may have typical residence times (i.e. average residence times) within continuous mixer 102 of between about 15 seconds and 5 minutes and more typically between about 30 seconds and 2 minutes. However, longer residence times within a continuous mixer are contemplated and may be up to or in excess of 15 minutes depending upon the mixer or gum structure.

To facilitate delivery and/or mixing, some ingredients, such as elastomer, may be first pulverized or ground into chunks prior to being fed into any one of the feed ports 121-126 of continuous mixer 102.

The elastomer ingredients can be fed to the continuous mixer 102 at ambient temperature in a flake, powder or chunk form and the shearing action of the continuous mixer 102 will stretch and heat the elastomer. In other embodiments, the elastomer may be fed into the continuous mixer as a liquid, and in some embodiments a pre-heated liquid at a temperature of between about 160° F. and 275° F. In even further embodiments, both liquid, powder and solid elastomers may be added to continuous processor 102.

In some embodiments, the entire weight percent of an ingredient is added at continuous mixer 102. In other embodiments, only a portion of the total weight percent of an ingredient in the finished gum structure is added in continuous mixer 102, while another portion is added to either or both of continuous mixers 104 and 106. For example, between about 10 to 90% by weight of the total filler added to a finished gum structure may be added at continuous mixer 102, more typically between about 25 to 75% by weight of the total filler added to a finished gum structure or even more typically about 35% to about 50% by weight of the total filler added to a finished gum structure while the remaining portion of the filler is added at other downstream mixers, e.g. continuous mixers 104, 106.

This can be advantageous when a given ingredient can have different effects on the composition at different times with in the mixing process or at different residence temperatures. Further an ingredient may be used to carry another ingredient as it is being added to a continuous mixer.

Adding different weight percentages of a given ingredient at different portions of the ultimate mixing process can be particularly beneficial when kitting, as a lower weight and volume product can be produced and shipped. As such, the final portion of the total amount of the ingredient can be added later at other locations, such as filler. This can be advantageous when shipping product between facilities by lowering shipping costs and/or allowing for more practical, efficient or cheaper materials to be used at the local facility.

In some embodiments, the elastomer plasticizer is added downstream of the elastomer, such that the elastomer plasticizer is added to a feed port 122-126 that is downstream from another one of the feed ports 121-125 of continuous mixer 102. Alternatively, the elastomer plasticizer could be added to the same feed port such as feed port 123 as an elastomer, but be fed into the feed port downstream from the elastomer. For example, the elastomer plasticizer could be fed into feed port 122 while the elastomer is fed into feed port 124. Alternatively, the elastomer plasticizer could be fed from supply 134 while the elastomer is fed from supply 132. In this latter example, both ingredients are fed to feed port 123. In other embodiments, the elastomer plasticizer is added downstream of a first portion of elastomer, but upstream from another portion of the elastomer or a completely different elastomer. For example, a first portion of the elastomer could be fed into feed port 121 from supply 130, an elastomer plasticizer could be fed to feed port 122 from supply 131 and yet another portion or another elastomer could be fed from supply 136 into feed port 125. In yet further embodiments, the elastomer plasticizer is added upstream of the elastomer to the same or another feed port.

These previous examples utilizing specific ingredients also apply to other ingredients added to continuous mixer 102 as well as the ingredients being added to the other continuous mixers 104 and 106 of system 100. These examples of ingredient arrangement and delivery are also, generally applicable to the other systems in FIGS. 2-13.

In some embodiments, the elastomer plasticizer are exposed to a maximum residence temperature of approximately 210° F. within continuous mixer 102 and more preferably a maximum residence temperature of about 200° F.

Other ingredients that may be added to continuous mixer 102 include emulsifiers, preservatives or stabilizing ingredients such as antioxidants.

As illustrated in FIG. 1, the effluent of continuous mixer 102, e.g. compounded elastomer and some compounding aids, may be directly fed and added to continuous mixer 104. Thus, the effluent of continuous mixer 102 is as an ingredient added to continuous mixer 104. The product of continuous mixer 102 may be the first ingredient added to continuous mixer 104 at feed port 141 (illustrated by a solid connecting arrow). Alternatively, it may be added downstream relative to other ingredients that are added to upstream feed ports. For example, the effluent of continuous mixer 102 could be added at feed port 144 (illustrated by the dashed connecting arrow), while other ingredients are added upstream at feed ports 140-143 of continuous mixer 104.

In some embodiments, the effluent of continuous mixer 102 could be diverted to an optional storage system 110, which may be in the form of a holding/surge tank, a recirculating circuit, a chiller/cooler, a forming processor such as to form a storable gum structure, such as in the form of pellets, bricks, agglomerated pellets (pellets in a brittle like form that have not completely separated from one another), or semi-viscous material so that the effluent can be stored until needed or shipped. A similar storage system could also be interposed additionally or alternatively between second mixer 104 and third mixer 106.

In some embodiments, antioxidants or other preservative ingredients are added to the gum structure formed in continuous processor 102. Addition of antioxidants or other preservatives may be particularly useful if the effluent is a master batch or used in kitting such that the effluent is stored for extended periods of time or shipped to other locations for further processing.

Continuous mixer 104 is typically used for mixing the effluent of continuous mixer 102, e.g. generally compounded elastomer, with other ingredients to form a gum structure that will typically be a gum base, a gum base plus additional subsequent gum ingredients, or something short of a gum base that also includes subsequent gum ingredients, such as by adding, for example, additional plasticizers, fats, waxes and additional fillers. At this point, some flavors or sweeteners or other ingredients that effect the taste or intensity of the taste of the finished gum may be introduced.

As the elastomer is typically compounded prior to being added to continuous mixer 104, continuous mixer 104 is typically configured for lower shear mixing that is more distributive than continuous mixer 102. By performing low shear, distributive mixing, the residence temperatures of the composition as it progresses through continuous mixer 104 are typically lower than continuous mixer 102. Maximum residence temperatures (i.e. typical average residence temperatures) of continuous mixer 104 may reach 325° F., but are more typically below 250° F. and even more preferably the residence temperatures vary between about 150° F. and 225° F. Thus, more temperature sensitive ingredients may be fed to continuous mixer 104 with a lower risk of temperature induced degradation or ingredient loss resulting from flash-off. Further, as degradation of an ingredient due to temperature is typically time sensitive, an otherwise temperature sensitive ingredient may be subjected to high temperatures beyond normal temperatures, if the length of exposure is very short.

The lower temperature facilitates the addition of ingredients such as fats, waxes, fillers, sweeteners, plasticizers or syrups/fluids. However, other ingredients that are not as temperature sensitive and that were previously added to the composition in continuous mixer 102 such as additional elastomers, elastomer plasticizers or fillers may also be added to continuous mixer 104.

The ingredients added to continuous mixer 104 will have similar residence times as those ingredients added to continuous mixer 102. The short residence time within a continuous mixer can permit temperature sensitive ingredients that would otherwise not be added to a composition to be added to these mixers, because an ingredient may only be exposed to the high temperature for a very brief period of time, the high temperature has little to no degrading effects on the ingredient.

Further, ingredients such as colors, flavors, sensates and potentiators may also be added to the composition using continuous mixer 104. However, if the product of continuous mixer 104 is going to be used as a master batch, typically colors and flavors will not be added or will be provided in only limited amounts to prevent adding limitations on the uses of the master batch in forming various different finished gum structures.

The order of the addition of these additional ingredients can be varied to alter the flavor and texture of the product of continuous mixer 104. Further, as the residence temperatures within a continuous mixer fluctuate up and downstream, the temperature sensitive ingredients may be added at various locations so that the ingredients are not exposed to the high residence temperatures. In the event that the ingredients must be exposed to the high residence temperatures, the ingredients may be added at a location such that the ingredients are only exposed to the high residence temperature for a short period of time.

Additionally, when adding temperature sensitive ingredients that require or are preferably subjected to lower residence temperatures, continuous mixer 104 may include a cooler/chiller for cooling the composition prior to or while the temperature sensitive ingredient is being mixed and added. Further, a cooler/chiller may also be used to maintain the composition at a lower temperature after the ingredient has been added and mixed.

The ingredients fed to continuous mixer 104, are generally fed using similar ingredient supplies and ingredient handling systems identified previously. The ingredient orientation may also be altered to provide a desired effluent.

The effluent of continuous mixer 104 may be fed to continuous mixer 106 in a similar fashion as the effluent of continuous mixer 102 was fed to continuous mixer 104. For example, the effluent may be fed directly into continuous mixer 106 such as the first ingredient at feed port 161 or as a downstream ingredient at feed port 164. However, in alternative embodiments, the product could be diverted to a chiller/cooler, a holding tank, a recirculating circuit, or a finishing processor as discussed previously.

Continuous mixer 106 can be used to finish the gum structure. The effluent of continuous mixer 106 may be at least a gum base, a gum base plus subsequent gum ingredients, or a finished gum. The ingredients mixed in continuous mixer may be fed from ingredient supplies 170-176 to feed ports 161-166 as discussed previously.

An ingredient fed to continuous mixer 106 may be added to the composition in continuous mixer 106, rather than the earlier continuous mixers 102, 104 for such reasons the individual ingredient may be any one or any combination of highly sensitive to high temperatures, an expensive ingredient, required to be provided and distributed throughout the composition precisely or provided in very limited quantity. The ingredients added to continuous mixer 106 may includes, by way of example only, colors, flavors, sweeteners, sensates and functional ingredients.

Continuous mixer 106 typically includes mixing elements that provide any and all of the following characteristics, low shear, low temperature and highly distributive mixing. The low temperature mixing of continuous mixer 106 is very suitable for the addition of highly temperature sensitive ingredients such as the flavors and sweeteners including both bulk sweeteners and high intensity sweeteners. The temperature of the composition as it flows through continuous mixer 106 is typically limited to below 150° F. and more preferably below 130° F. Other ingredients such as, syrups/fluids, sensates, potentiators, acids, emulsifiers, color, functional ingredients would also typically be added in continuous mixer 106.

The highly distributive mixing of continuous mixer 106 facilitates distribution of ingredients that provide a very limited weight percentage of the finished gum structure such that a substantially homogenous composition is formed. This can be very advantageous, particularly with active ingredients, where the ingredient needs to be distributed at an accurate concentration relative to the rest of the gum structure, such as where an individual stick of gum can and/or must have a very precise amount of ingredient. For example, such as gum that is used for medical reasons.

The product of continuous mixer 106 will typically be a finished gum structure that is ready for finishing processes, such as forming, shaping, conditioning, coating, packaging, etc.

With general reference to system 100, in some embodiments, the liquid ingredients added to individual continuous mixers 102, 104, 106 are added upstream of the dry ingredients. In other embodiments, the dry ingredients may be added to the continuous mixers 102, 104, 106 upstream from the liquid ingredients. In yet further embodiments, the dry and liquid ingredients may be interspersed relative to one another such that dry ingredients are added between upstream and downstream liquid ingredients and/or liquid ingredients are added between upstream and downstream dry ingredients.

Several significant aspects are provided by a system that uses a plurality of mixers to form gum structures.

First, individual mixers can be highly configured for performing desired functions and are not limited to a single volume or movement speed input. As identified previously, a first mixer can be used for compounding the elastomer ingredients. Thus, the mixer can be configured for high shear and highly dispersive mixing. However, a second mixer can be more easily configured for low-shear and low temperature, highly distributive mixing for adding more temperature sensitive ingredients.

Second, by having the mixers separated, the individual drive speeds and throughput of an individual mixer can be tailored to the mixing that it requires. This can reduce energy consumption and power required to drive the mixers.

Third, if one of the mixers breaks down, it can, potentially, be repaired or replaced without requiring complete disassembly of all the other mixers.

A continuous mixer that starts with raw materials and produces finished gum cannot be used when kitting gum structures to form finished gum. Further, when using multiple mixers for all gum production, consistency between different finished gum may be maintained because all gum may formed using similar systems, both, locally and remotely.

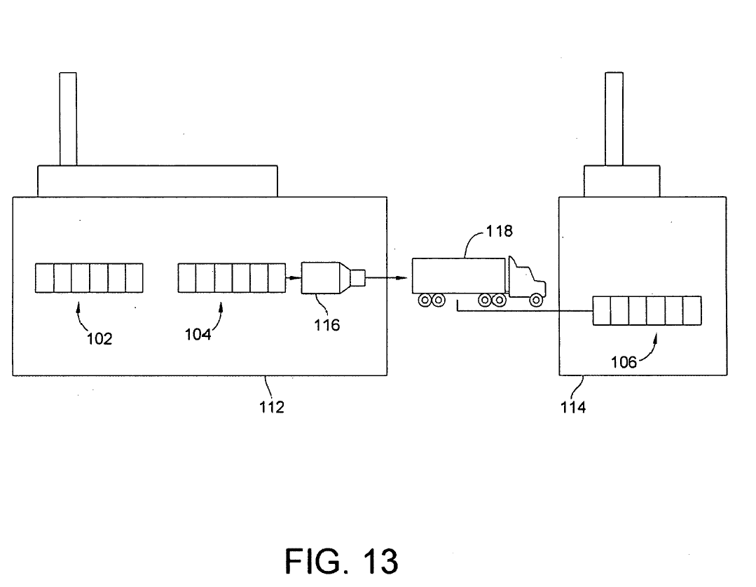

As indicated previously, kitting of the effluents of the various continuous mixers may occur. FIG. 13 illustrates one example of a kitting system generally utilizing the system of FIG. 1. In this system, the first two continuous mixers 102, 104 are located at a first plant 112 while the third continuous mixer 106 is located at a second remote plant 114. In this system, the effluent of continuous mixer 104 may be formed and then packaged or otherwise prepared to be shipped by packaging system 116 which may include devices for pelletizing or forming bricks of the effluent of continuous mixer 104. The effluent is then shipped using shipping system 118 to the second plant 114 where it is used as an ingredient by continuous mixer 106.

When the effluent is shipped to various locations for production of various different flavors or colors, the effluent of continuous mixer 104 will typically be relatively standard in flavor profile and color.

Other ingredients beyond flavoring and coloring may be added to the composition at plant 114 using mixer 106. For example, additional fillers or bulking agents may be added to the gum structure. This is advantageous, as indicated previously, in reducing the volume and weight of product that is shipped to the remote second plant 114. Particularly, where the fillers, bulking agents, or other ingredients can be acquired cheaply at the location of the continuous mixer 106.

While FIG. 13 illustrates continuous mixers 102 and 104 at the first plant 112 and continuous mixer 106 at the second plant 114, other configurations are clearly contemplated. For example, only continuous mixer 102 may be provided at the first plant 112 and the second two continuous mixers 104 and 106 may be provided at the second plant 114. Additionally, continuous mixer 102 may be provided at a first plant, continuous mixer 104 may be provided at a second plant and continuous mixer 106 may be provided at a third plant.

One of ordinary skill in the art will recognize that the kitting system may be applied to the other embodiments disclosed in FIGS. 2-12.

FIG. 2 illustrates an alternative system 200 for processing and mixing various combinations of ingredients to form gum structures. This system includes two continuous mixers 202 and 204 and a batch mixer 206. In this system, continuous mixer 202 is upstream of continuous mixer 204, which is upstream of batch mixer 206. In this system, upstream continuous mixers 202, 204 function and operate much like continuous mixers 102, 104 discussed previously. Mixers 202, 204, 206 will typically receive similar ingredients as identified with respect to mixers 102, 104, 106, discussed previously.

In this embodiment, batch mixer 206 is used for producing the finished gum structure. In one embodiment, continuous mixer 204 supplies its effluent to batch mixer 206 as an ingredient for only a portion of the mixing process. After the requisite quantity of effluent is supplied to the batch mixer 206 for a mixing cycle, continuous mixers 202, 204 are either stopped or, preferably, the effluent of continuous mixer 204 is diverted to another location such as to an accumulator or a surge tank to temporarily hold the effluent of continuous mixer 204 while batch mixer 206 cycles through a batch. In some embodiments, the mixer, accumulator or surge tank maintains the effluent of continuous mixer 204 at an elevated temperature, and preferably substantially as a fluid elevated above ambient such that the effluent can be pumped to batch mixer 206.

Alternatively, the effluent of continuous mixer 204 can be diverted to a storage device 208 that uses a forming device such as a pelletizer or a brick molding system that forms storable effluent in pellets or bricks, respectively. In some embodiments, particularly where the temporary storage device 208 pelletizes or molds bricks of effluent, the temperature of the effluent may significantly drop. As such the storage device 208 may be in the form of a system that further includes a heating or melting system for melting, or at least pre-heating, the pellets or bricks before they are added to batch mixer 206. Such a heating device may include bulk melting tanks, a continuous processor such as an extruder, or other well known devices for heating and melting the effluent.

Pelletizing or molding bricks of the effluent of continuous mixer 204 is very advantageous when kitting, such as when the effluent must be shipped to another location.

In some embodiments, the effluent of continuous mixer 204 is added to batch mixer 206 for substantially the entire length of the mixing process. In other embodiments, the effluent of continuous mixer 204 is added to batch mixer 206 for only a short period of the mixing process. The effluent of continuous mixer 204 may be added to batch mixer 206 prior to any other ingredients, after other ingredients have been added or simultaneously as other ingredients are being added.

In some implementations, the effluent of continuous mixer 204 may pass through a chiller/cooler prior to being added to batch mixer 206, such as when the effluent is fed directly to batch mixer 206. This is particularly beneficial when the effluent of continuous mixer 204 is significantly high that other ingredients added to batch mixer 204 would experience degradation.

Ingredient supplies, such as ingredient supplies 271, 272 for supplying ingredients to batch mixer 206 and corresponding ingredient handling systems are substantially similar to those identified previously and may be used to store and automatically supply ingredients to batch mixer 206. However, unlike continuous mixers, ingredients may be more easily manually added to batch mixer 206. Rather than the point of location being important, usually the timing and sequence of ingredient addition is more important in batch mixing.

In some implementations, dry ingredients may be added to the batch mixer 206 prior to addition of any liquid or moist ingredients. This can be beneficial when one of the dry ingredients, such as a filler, being added to batch mixer 206 can be used to clean residue from a previous batch from the internal components of the batch mixer to prepare the batch mixer 206 for mixing a new batch of ingredients.

Batch cycle times from the start and finish of mixing with batch mixer 206 may range between 2 minutes and 40 minutes and more preferably between about 10 minutes and 30 minutes. However, in some embodiments, individual ingredients have residence times less than the batch cycle time while other ingredients have residence times equal to the batch cycle time.

The time of the mixing cycle at which ingredients are added to batch mixer 206 correlates in many respects as to the location at which an ingredient is added to a continuous mixer. For example, a new ingredient being added later in the mixing cycle of batch mixer 206 may be added at a later time to ensure that the previously added ingredients are adequately mixed prior to adding the new ingredient. Similarly, a new ingredient to be added to a composition using a continuous mixer may be added downstream from a plurality of ingredients so that the upstream ingredients are adequately processed and/or mixed prior to presenting the new ingredient.

Similar to continuous mixers discussed previously, the batch mixer 206 may be heated or cooled to maintain the residence temperature of the ingredients during mixing. The heating or cooling may be varied depending on the particular period of the mixing cycle and the ingredients that are being mixed.

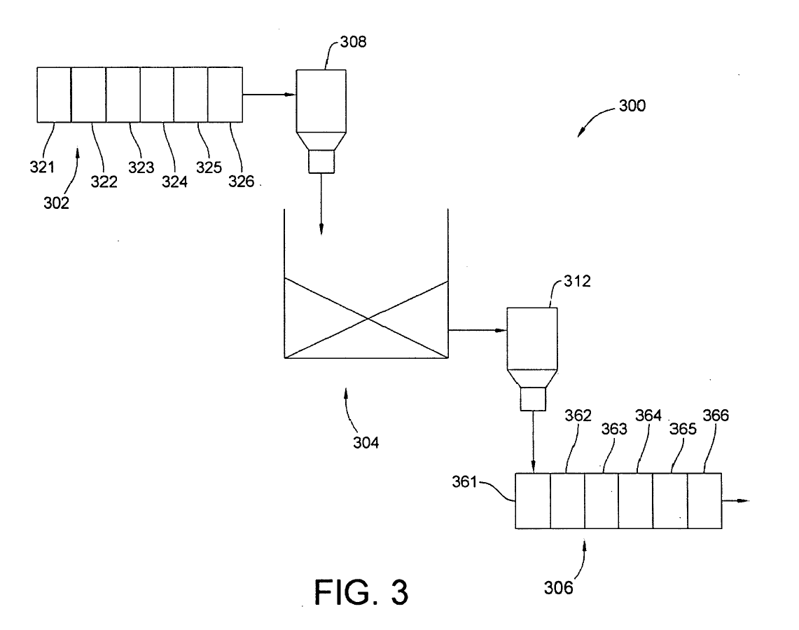

FIG. 3 illustrates a further embodiment of a system 300 for processing and mixing ingredients to produce gum structures. This embodiment utilizes three mixers including a continuous mixer 302, a batch mixer 304 and a continuous mixer 306, with the continuous mixers 302, 306 upstream and downstream, respectively, of batch mixer 304. Continuous mixers 302 and 306 function substantially similar to continuous mixers 102 and 106 discussed previously.

In one embodiment after continuous mixer 302 supplies batch mixer 304 with sufficient effluent for the gum structure formed during one mixing cycle in batch mixer 304, continuous mixer 302 is shut down while it awaits batch mixer 304 to be emptied after each mixing cycle.

In alternative embodiments, the mixing system 300 includes a temporary storage device 308 to hold the effluent of continuous mixer 302 while 304 cycles through a batch. Similarly to storage device 208 discussed previously, temporary storage device 308 may include a recirculating system, a surge tank or accumulator such that the effluent of continuous mixer 302 remains fluid and may include heaters to maintain the effluent at a temperature elevated above ambient. Alternatively, the temporary storage device 308 may pelletize or mold bricks of the effluent of continuous mixer 302 such that the effluent can be stored until needed by batch mixer 304.

In some embodiments, particularly, where the temporary storage device 308 substantially solidifies the effluent to form pellets or bricks, storage device 308 may further include a heating or melting device for raising the temperature of the effluent prior to adding it to the batch mixer 304. In alternative embodiments, mixer 304 may be heated to melt the effluent prior to addition of other ingredients. In even further embodiments, batch mixer 304 may provide sufficient shear to generate enough heat to melt the bricks or pellets.

Because batch mixer 304 generates periodic batches of gum structure effluent that are complete at the end of the mixing cycle, the entire batch is generally simultaneously expelled from batch mixer 304. By expelling all of the effluent of batch mixer 304, typically, more effluent is available for use by the downstream continuous mixer 306 than can be simultaneously fed into the continuous mixer 306. Particularly, because continuous mixer 306 is configured to be continuously fed ingredients, rather than fed a bulk quantity of ingredient that is greater than can be added directly to the continuous mixer 306. Thus, the effluent of batch mixer 304 typically must be pumped or otherwise transported to another storage device 312, which may take the form of a surge tank, storage bin, storage tank or forming device to form bricks or pellets to hold the excess effluent until it can be processed through continuous mixer 306.

Thus, in embodiments of systems that incorporate batch mixers as well as continuous mixers, a storage device of some type will typically be required between the batch mixer and the continuous mixer either to store the effluent of an upstream continuous mixer while the batch mixer is full and performing a mixing cycle or to hold the effluent of the batch mixer as it is progressively fed through a downstream continuous mixer.

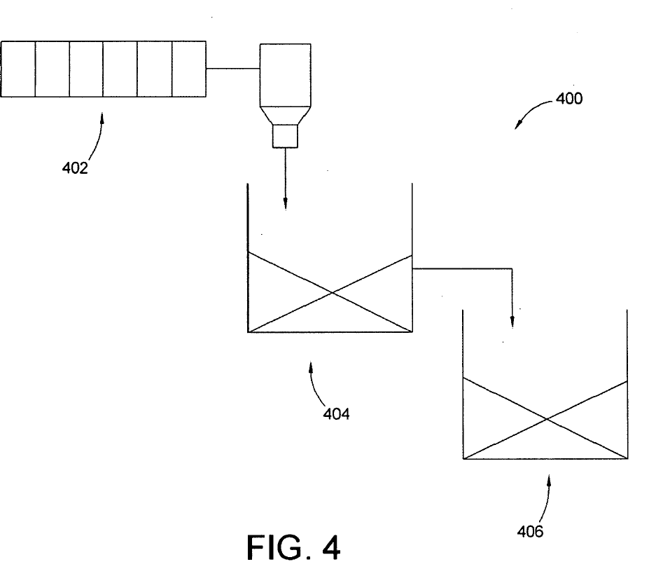

However, with reference to system 400 of FIG. 4, a batch mixer to batch mixer system such as between batch mixer 404 to batch mixer 406 in FIG. 4 does not typically require intermediate storage devices interposed between the batch mixers 404, 406. More particularly, effluent of batch mixer 404 may be expelled from batch mixer 404 and directly fed, manually or automatically, to batch mixer 406. However, in the circumstance where an upstream batch mixer, e.g. batch mixer 404, has a shorter batch cycle than a downstream batch mixer, e.g. batch mixer 406, a temporary storage device (not shown) may be utilized in between the two batch mixers 404, 406.

Generally, system 400 operates and utilizes its continuous mixer 402 and batch mixers 404, 406 in a substantially similar manner as previously discussed continuous mixers and batch mixers.

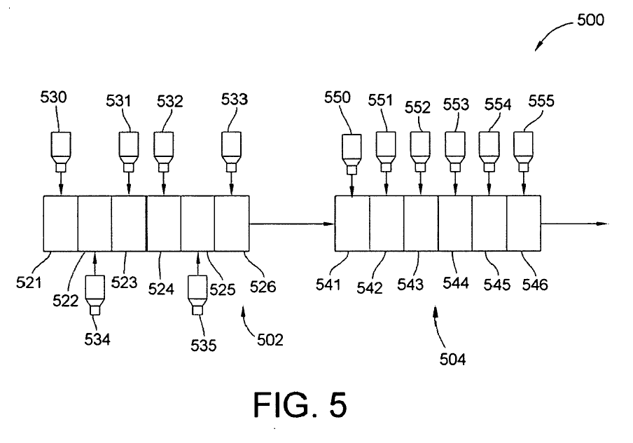

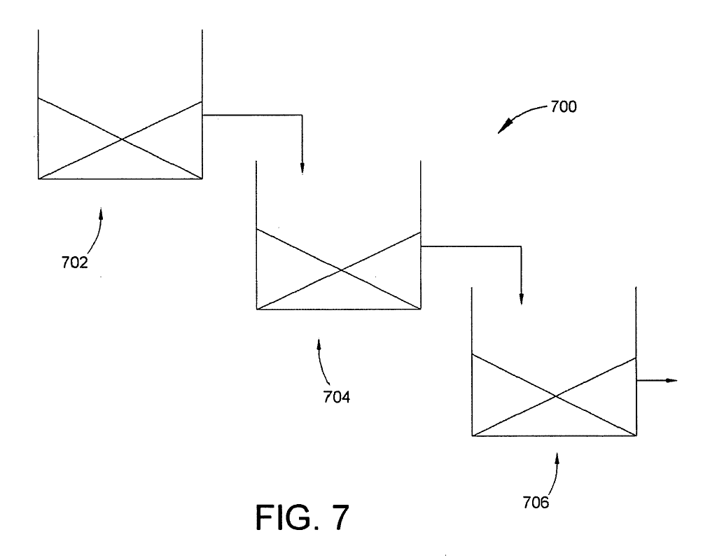

FIGS. 5-12 illustrate additional embodiments of systems for processing subsequent gum ingredients to produce finished gum. These systems may include two mixers such as the systems 500, 600, 1100 and 1200 illustrated in FIGS. 5, 6, 11 and 12, respectively, or three mixers such as systems 700-1000 illustrated in FIGS. 7-10, respectively.

In the two mixer systems 500, 600, 1100 and 1200, the functions of portions of two of the three mixers of the three mixer systems 100-400 and 700-1000 are performed by at least one of the mixers of the two mixer systems 500, 600, 1100 and 1200.

For example, with reference to FIG. 5, system 500 may be configured such that continuous mixer 502 functions substantially similar to mixer 102 discussed previously and continuous mixer 504 combines the mixing elements of continuous mixers 104 and 106 of system 100 to perform the similar functions.

For example, in one embodiment, continuous mixer 502 includes primarily high shear, high temperature mixing and the effluent of mixer 502. The ingredients added to continuous mixer 502 at feed ports 521-526 from ingredient supplies 530-533 may be elastomers, and potentially some compounding aids such as fillers and elastomer plasticizers. As such the effluent from continuous mixer 502 may be substantially only a compounded elastomer, with or without some compounding aids. Continuous mixer 504 will be configured for lower shear and lower temperature mixing. As such, continuous mixer 504 will be fed the rest of the ingredients to form the desired gum structure from ingredient supplies 550-555 at various feed ports 541-546. Ingredients such as flavors, sweeteners, colors, emulsifiers, fats, waxes will typically be added to the composition in continuous mixer 504. Additional portions of fillers and ingredients used to compound the elastomer may also added to the composition in continuous mixer 504.

In some embodiments, the gum structure effluent of continuous mixer 502 may be substantially more than a compounded elastomer. In this implementation, continuous mixer 502 will be fed elastomers, fillers, preservatives, resins, emulsifiers, elastomer plasticizers, plasticizers, fats, waxes, and/or some initial colors or flavors. In such an implementation, continuous mixer 502 will typically include both high shear and low shear mixing elements. For example, the mixing elements of continuous mixer 502 proximate feed ports 521-523 may be similar to the mixing elements of continuous mixer 102, while downstream mixing elements proximate feed ports 524-526 may be intermediate or low shear similar to the mixing elements of continuous mixer 104.

In some embodiments a portion of continuous mixer 502 will preferably be, at least partially, cold fluid jacketed or include an intermediate cooling section so as to attempt to reduce the temperature of the composition as it passes through continuous mixer 502. Typically the cold fluid jacket or cooling sections are positioned prior to the location where the more temperature sensitive ingredients, e.g. sweeteners or flavors, are added. For example, the portion of continuous mixer proximate feed ports 524-526 may be cold fluid jacketed or a cooling section may be provided between feed ports 523 and 524. Further, the portion of continuous mixer 502 proximate feed ports 521-523 may be warm fluid or steam jacketed to maintain the proper temperature for compounding the elastomer.

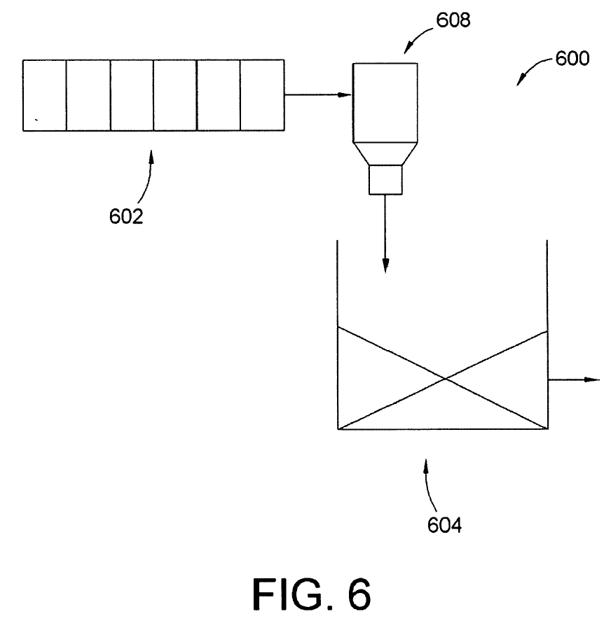

FIG. 6 illustrates a system 600 that includes a continuous mixer 602 upstream of a batch mixer 604. This system 600 is similar to system 500 because it includes two mixers. In some embodiments, continuous mixer 602 functions much like continuous mixer 502 and may be used for the limited purpose of compounding the elastomer or in other embodiments continuous mixer 502 may be used for producing much more than a compounded elastomer. The rest of the ingredients required to finish the desired gum structure are then added to the composition at batch mixer 604. Because system 600 has continuous mixer 602 upstream and feeding batch mixer 604, some embodiments may include a storage device 608, which may be implemented or include such devices as discussed previously.

FIG. 7 illustrates a further embodiment of a system 700 for mixing and processing ingredients to form gum structures. This embodiment includes three batch mixers 702, 704, 706 aligned in series. The effluent of batch mixer 702 is added to batch mixer 704 as an ingredient and the effluent of batch mixer 704 is added to batch mixer 706 as an ingredient.

Preferably, batch mixers 702, 704, 706 have similar shear characteristics as continuous mixers 102, 104, 106, respectively.

The order in which ingredients are mixed using batch mixers 702, 704, 706 is dependent upon the time at which an individual ingredient is added to the batch mixers 702, 704, 706 during the mixing cycle. In some embodiments, a portion of dry filler may be added to the batch mixers 702, 704, 706 to assist in cleaning or preparing the internal components of the batch mixers 702, 704, 706 for a new batch prior to adding other ingredients, particularly liquid ingredients.

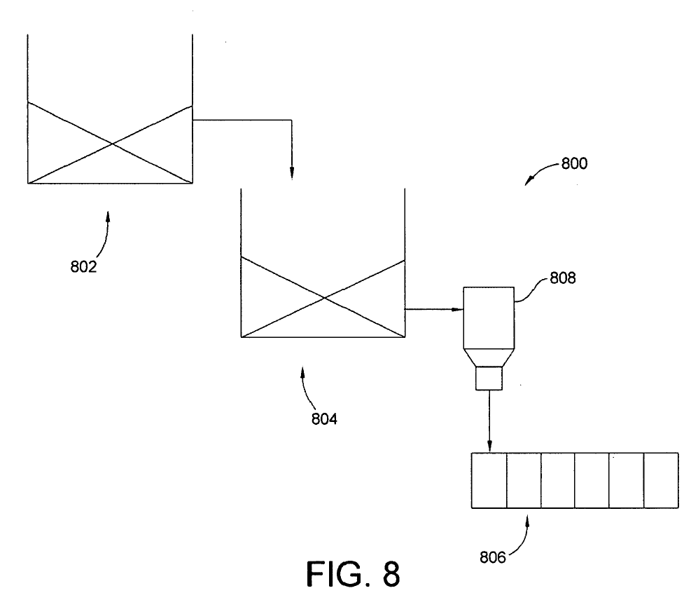

FIGS. 8-12 illustrate additional representative systems for mixing and processing ingredients to form gum structures. The understanding and operation of these additional systems can be understood from the description of the previous embodiments of systems 100-700.

FIG. 8 illustrates an alternative system 800 for processing and mixing various combinations of ingredients to form gum structures. This system includes two batch mixers 802 and 804 and a continuous mixer 806 in series, respectively. In this system, batch mixer 802 is upstream of batch mixer 804, which is upstream of continuous mixer 806. System will typically include a temporary storage device 808 to hold the excess effluent from batch mixer 804 while the effluent is waiting to be processed through continuous mixer 806. The individual mixers will function in a similar manner as discussed previously. Further, the system may incorporate similar features such as cooling devices and ingredient supply and handling systems as discussed previously.

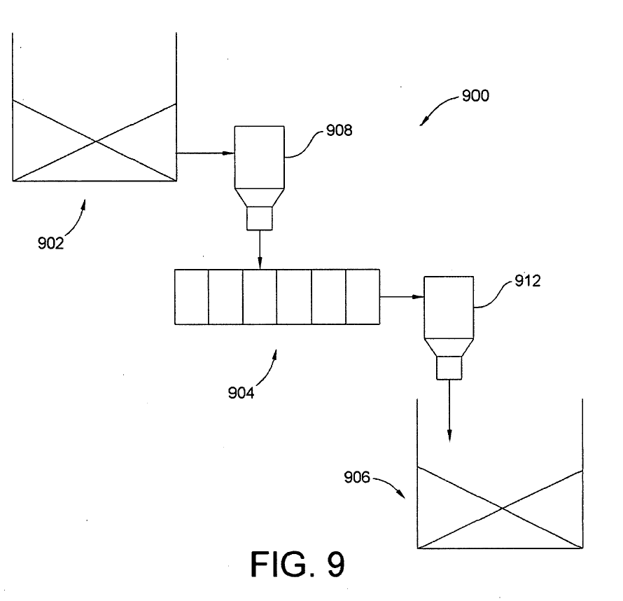

FIG. 9 illustrates an alternative system 900 for processing and mixing various combinations of ingredients to form gum structures. This system includes a first batch mixer 902, a continuous mixer 904 and a second batch mixer 906 arranged in series, respectively. In this system, batch mixer 902 is upstream of continuous mixer 904, which is upstream of batch mixer 906. The system 900 will include a first temporary storage device 908 for storing the batch of effluent from batch mixer 902 while it is being fed into continuous mixer 904. Also, system 900 will incorporate a temporary storage device 912 between the continuous mixer 904 and the batch mixer to store the effluent from continuous mixer 904 while batch mixer 906 processes a batch. The individual mixers will function in a similar manner as discussed previously. Further, the system may incorporate similar features such as cooling devices and ingredient supply and handling systems as discussed previously.

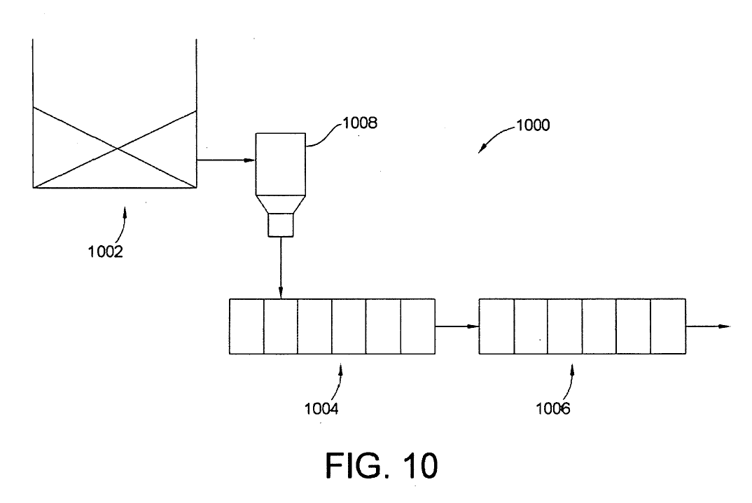

FIG. 10 illustrates an alternative system 1000 for processing and mixing various combinations of ingredients to form gum structures. This system includes a batch mixer and two continuous mixers 1004, 1006 arranged in series, respectively. In this system, batch mixer 1002 is upstream of continuous mixer 1004, which is upstream of continuous mixer 1006. As batch mixer 1002 supplies effluent to a continuous mixer 1004, the system 1000 will typically incorporate a temporary storage device 1008, as described previously. The individual mixers will function in a similar manner as discussed previously. Further, the system may incorporate similar features such as cooling devices and ingredient supply and handling systems as discussed previously.

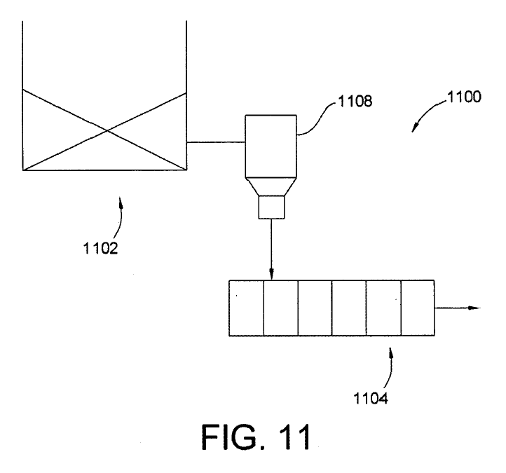

FIG. 11 illustrates an alternative system 1100 for processing and mixing various combinations of ingredients to form gum structures. This system includes a batch mixer 1102 and a continuous mixer 1104 arranged in series, respectively. In this system, batch mixer 1102 is upstream of batch mixer 1104. The individual mixers will function in a similar manner as discussed previously. As batch mixer 1102 supplies effluent to a continuous mixer 1104, the system 1100 will typically incorporate a temporary storage device 1108, as described previously. The individual mixers will function in a similar manner as discussed previously. Further, the system may incorporate similar features such as cooling devices and ingredient supply and handling systems as discussed previously.

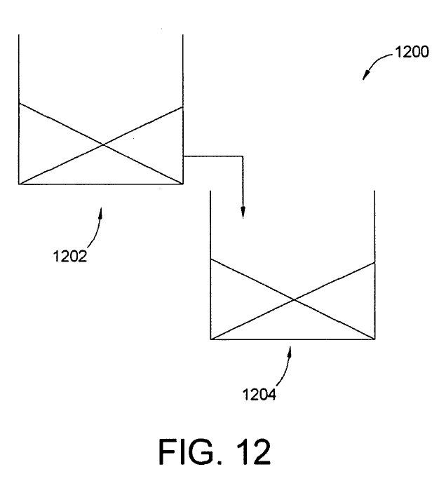

FIG. 12 illustrates an alternative system 1200 for processing and mixing various combinations of ingredients to form gum structures. This system includes two batch mixers 1202 and 1204 arranged in series, respectively. In this system, batch mixer 802 is upstream of batch mixer 804. The individual mixers will function in a similar manner as discussed previously. Further, the system may incorporate similar features such as cooling, temporary storage devices and ingredient supply and handling system as discussed previously.

### EXAMPLES

Now that individual ingredients and representative mixing systems for combining the ingredients have been discussed, the following examples will provide representative finished gum compositions and potential ingredients in those finished gum compositions by weight percent. Further examples will illustrate potential intermediate gum structure effluents discharged from individual mixers used in the mixing processes performed by the mixing systems 100-1200. Even further examples will illustrate gum structures that are less than finished gum structures can be generated.

Table 1 begins by illustrating a general break down of representative weight percentages of various ingredients, by broad category, that are typically, but not always, employed in finished gum structures.

TABLE 1

| Ingredient | % by Weight Percent |
|---|---|
| Elastomers | 1-30% |
| Elastomer Plasticizer or Resins | 0-50% |
| Plasticizers | 0-20% |
| Fats | 0-40% |
| Waxes | 0-20% |
| Fillers | 0-50% |
| Antioxidants | 0-5% |
| Bulk Sweeteners | 5-75% |
| High Intensity Sweeteners | 0-5% |
| Syrups/fluids | 0-15% |
| Flavors | 0.1-15% |
| Sensates | 0-5% |
| Potentiators | 0-5% |
| Acids | 0-5% |
| Emulsifiers | 0-10% |
| Colors | 0-5% |
| Functional Ingredients | 0-5% |

Table 2 illustrates a few examples of representative finished gum bases that can be used in finished gum compositions. More particularly, Table 2 illustrates representative gum base ingredients illustrated by weight percents of a contemplated finished gum base. These, and other, gum bases can be formed using the mixing systems 100-1200 discussed previously.

TABLE 2
Examples 1-5; Representative Gum Bases

| Ingredient | 1 | 2 | 3 | 4 | 5 |
|---|---|---|---|---|---|
| Elastomers (High Molecular | | | | | |
| Weight) | | | | | |
| Butyl Rubber | 8-12 | 4-8 | 0 | 4-8 | 6-10 |
| Styrene-butadiene Rubber | | | 5-11 | | |
| Additional Elastomers | | | | | |
| Polyvinyl Acetate (PVA) | 5-15 | 10-30 | 15-25 | 10-20 | 20-30 |
| Elastomers (Low Molecular | | | | | |
| Weight) | | | | | |
| Polyisobutylene | 10-20 | 8-10 | 0 | 5-10 | 10-20 |
| Softeners/Plasticizers/Oils/Waxes | | | | | |
| Rosin esters | 5-30 | 5-10 | 15-20 | 20-35 | 5-10 |
| Waxes | 4-10 | 8-12 | 5-15 | 5-10 | 5-10 |
| Vegetable oils (hydrogenated) | 10-30 | 15-25 | 5-15 | 2-5 | 20-30 |
| Emulsifiers | 3-8 | 5-10 | 3-8 | 0-2 | 2-5 |
| Triacetin | | | | | |
| Glycerol Monostearate | | | | | |
| Lecithin | | | | | |
| Fillers | | | | | |
| Calcium Carbonate | 30-40 | 0-10 | 10-20 | | |
| Talc | | | | 10-20 | 10-20 |
| Totals: | 100 | 100 | 100 | 100 | 100 |

Table 3 illustrates a few examples of representative finished gums. More particularly, Table 3 illustrates representative finished gum structures that incorporate at least one of the finished gum base structures of Table 2. These finished gum structures additionally incorporate subsequent gum ingredients to form finished gum structures. The ingredients are listed by way of weight percent of the finished gum composition. These, and other, finished gum structures can be formed using the mixing systems 100-1200 discussed previously.

Other gum structures based on the finished gum structures of Examples 6-10 that are not finished gums because the gum structure lacks one or more of the listed ingredients are contemplated as being potential outputs of the mixing systems 100-1200.

TABLE 3
Examples 6-10; Finished Gum Compositions

| Ingredient | 6 | 7 | 8 | 9 | 10 |
|---|---|---|---|---|---|
| Finished Gum | | | | | |
| Base | | | | | |
| Gum Base from | 20%-60% | | | | |
| Example 1 | | | | | |
| Gum Base from | | 10%-30% | | | |
| Example 2 | | | | | |
| Gum Base from | | | 20%-50% | | |
| Example 3 | | | | | |
| Gum Base from | | | | 30%-60% | |
| Example 4 | | | | | |
| Gum Base from | | | | | 10%-30% |
| Example 5 | | | | | |
| Subsequent Gum | | | | | |
| Ingredients | | | | | |
| Bulk Sweeteners | | | | | |
| Sucrose | 30%-70% | 0 | 25%-50% | 30%-70% | 0 |
| Corn Syrup | 5%-30% | 0 | 10-30% | 10%-30% | 0 |
| Hydrogenated | 0 | 0.1-10% | 0.1-10% | 0 | 0.1-10% |
| Starch Hydrolysates | | | | | |
| Sorbitol | 0 | 30%-70% | 10%-30% | 0 | 30%-70% |
| Erythritol | 0 | 0-20% | 1%-10% | 0 | 0-20% |
| Xylitol | 0 | 0-20% | 0-10% | 0 | 0-20% |
| Maltitol | 0 | 0-60% | 0-30% | 0 | 0-60% |
| Isomalt | 0 | 0-20% | 0-10% | 0 | 0-20% |
| Mannitol | 0 | 0-60% | 0-50% | 0 | 0-60% |
| High Intensity | | | | | |
| Sweeteners | | | | | |
| Neotame | 0-1% | 0-1% | 0-1% | 0-1% | 0-1% |
| Sucralose | 0-1% | 0-1% | 0-1% | 0-1% | 0-1% |
| Ace-K | 0-1% | 0-1% | 0-1% | 0-1% | 0-1% |
| Aspartame | 0-3% | 0-3% | 0-3% | 0-3% | 0-3% |
| Encapsulated | | | | | |
| Sweetener | | | | | |
| Sucralose | 0-7% | 0-7% | 0-2% | 0-7% | 0-2% |
| Encapsulated in | | | | | |
| PVA | | | | | |
| Aspartame | 0-7% | 0-7% | 0-2% | 0-7% | 0-2% |
| Encapsulated in | | | | | |
| PVA | | | | | |
| Fluids | | | | | |
| Glycerin | 0.1-1% | 0.1-15% | 0.1-5% | 0.1-1% | 0.1-1% |
| Emulsifiers | | | | | |
| Lecithin | 0.1-10% | 0.1-10% | 0.1%-10% | 0.1-10% | 0.1-10% |
| Flavor | 2-5% | 0.1-3% | 0.1-3% | 0.1-3% | 2-5% |
| Acid(s) | 0.1-10% | 0.1-10% | | 0.1-10% | |
| Color(s) | 0.001-0.2% | .001-0.2% | 0.001-0.2% | 0.001-0.2% | 0.001-0.2% |

Table 4 expands on Tables 1, 2 and 3 by illustrating contemplated processes and individual steps for generally mixing and adding the ingredients identified in Tables 1, 2 and 3 using mixing systems and methods according to the present invention. In doing so, Table 4 provides an overarching map of potential types of effluents, i.e. intermediate and final gum structures, from the various mixers in the mixing systems 100-1200 discussed previously.

Mixer 1 generally corresponds to the first mixer in the series of mixers of the previously discussed mixing systems 100-1200 (i.e. the mixer in a given system having a reference numeral ending in “02”). Similarly, mixer 2 corresponds to the second mixer in the series of mixers of the previously discussed mixing systems 100-1200 (i.e. the mixer in a given system having the reference numeral ending in “04”). Downstream mixing, where applicable, is contemplated to be performed by the third mixer (i.e. the mixer in a given system having a reference numeral ending in “06”) in the previously discussed mixing systems that include three mixers.

It will be understood, in view of the previous discussion of the mixing systems 100-1200, that various intermediate structures such as holding tanks, temporary storage devices, cooling devices, etc. may be interposed between or included in mixers 1, 2 and downstream mixing such that the effluent of one mixer does not necessarily need to flow directly from one mixer to the next. Further, individual mixers may include various means to maintain or reduce temperature of the internal mixtures as the ingredients in individual mixers are being processed.

One of ordinary skill in the art can correlate the effluent of each mixer to the types of ingredients, namely gum base ingredients or subsequent gum ingredients, that are contemplated to be added to each mixer. The immediately following discussion will provide a key to the symbols used in the Table 4.

FG is a finished/complete gum product including a finished gum base (FGB) and a finished set of subsequent gum ingredients (FSGI), but that has not yet been rolled, scored, formed, conditioned, coated or exposed to other post mixing processes. Tables 1 and 3, provided above, illustrate compositional examples of several contemplated FGs.

FGB is set of gum base ingredients (GBI^{x}) forming a finished gum base. FGBs may vary such that not all FGBs are the same. Table 2, provided above, illustrates compositional examples of several contemplated FGBs. As illustrated by the FGBs of Examples 1 and 3 of Table 2, it is clear that an FGB can have different ingredients within an ingredient category, e.g. Example 1 uses Butyl Rubber while Example 3 does not use any Butyl Rubber but instead uses Styrene-butadiene Rubber. Further, Examples 1 and 3 illustrate that a specific ingredient can be used in different rations. For example, the FGB of Example 1 uses between 5-15 by weight percent PVA, while Example 3 uses between 15-25 by weight percent PVA.

FSGI is a set of subsequent gum ingredients (SGI^{x}), not including gum base or coating ingredients, in a finished gum product, also referred to herein as a “finished set of subsequent gum ingredients”. FSGIs may vary such that not all FSGIs are the same. Generally, these ingredients form the water soluble portion of a gum structure. The set of subsequent gum ingredients identified in Examples 6-10 of Table 3 illustrate several contemplated representative FSGIs. For Example, the FSGI of Example 6 identified above includes a desired combination of bulk sweeteners, high intensity sweeteners, encapsulated sweeteners, fluids, emulsifiers, flavor, acids and colors. However, Example 7 is an FSGI that is different than Example 6 and fails to include any encapsulated sweeteners.

GBI^{x} is a set of gum base ingredients that does not include subsequent gum ingredients. GBI^{x}s may vary such that not all GBI^{x}s are the same. When used in Table 4, a GBI^{x} is less than a finished gum base. However, a GBI^{x} in one gum structure may be a FGB of another gum structure. For example, a first GBI^{x} for a first gum structure or process may merely be elastomer, while a second GBI^{x} for a second gum structure or process may include elastomer, plasticizer, fats, waxes, oils, filler and softeners. In this second example, the set of ingredients is not sufficient to form a FGB for the desired gum structure, but may be sufficient to form an FGB for a different gum structure.

As used herein, a “set” may include one or more ingredients. As such, a “set”, as used herein and above, need not include multiple ingredients.

GBI^{xy} is a GBI^{x} effluent or portion of an effluent from an upstream mixer plus at least one additional gum base ingredient GBI^{y}. When used in Table 4, a GBI^{xy} is less than a finished gum base. GBI^{xy}s may vary such that not all GBI^{xy}s are the same. However, a GBI^{xy} in one gum structure may be a GBI^{x} of another gum structure. Further, a GBI^{xy} may be the combination of the same ingredient added in two different mixers. For example, a GBI^{xy} may be generated by adding a first portion of filler (GBI^{x}) in a first mixer and then adding a second portion of the same exact type of filler (GBI^{y}) in a second mixer to form a GBI^{xy} in the second mixer that is formed entirely of a single ingredient Alternatively, a GBI^{xy} of a first gum structure or process may be the combination of an elastomer (GBI^{x}) added in an upstream mixer and a plasticizer (GBI^{y}) added in a downstream mixer.

GBI^{xyz} is a GBI^{xy} effluent or portion of an effluent from an upstream mixer plus at least one additional gum base ingredient GBI^{z}. When used in Table 4, a GBI^{xyz} is less than a finished gum base. GBI^{xyz}s may vary such that not all GBI^{xyz}s are the same.

SGI^{x} is a set of subsequent gum ingredients that not including gum base or coating ingredients. SGI^{x}s may vary such that not all SGI^{x}s are the same. When used in Table 4, a SGI^{x} is less than a finished set of gum ingredients. Further, a SGI^{x} in one gum structure may be a FSGI of another gum structure. For example, a first SGI^{x} for a first gum structure or process may merely be bulk sweeteners, while a second SGI^{x} for a second gum structure or process may include bulk sweeteners, encapsulated sweeteners, high intensity sweeteners as well as flavors.

SGI^{xy} is a SGI^{x} effluent or portion of an effluent from an upstream mixer plus at least one additional gum ingredient SGI^{y} (but is not yet a FSGI). SGI^{xy}s may vary such that not all SGI^{xy}s are the same. When used in Table 4, a SGI^{xy} is less than a finished set of gum ingredients. Further, a SGI^{xy} may be the combination of the same ingredient added in two different mixers. For example, a SGI^{xy} may be generated by adding a first portion of the bulk sweetener (SGI^{x}) in an upstream mixer and then adding a second portion of the same exact bulk sweetener (SGI^{y}) n a second mixer to form a SGI^{xy} in the second mixer formed entirely of a single ingredient. Alternatively, a SGI^{xy} of a first gum structure or process may be the combination of a bulk sweetener (SGI^{x}) in an upstream mixer and the addition of an encapsulated sweetener (SGI^{y}) in a downstream mixer.

SGI^{xyz} is a SGI^{xy} effluent or portion of an effluent from an upstream mixer plus at least one additional gum ingredient SGI^{z} (but is not yet a FSGI). SGI^{xyz}s may vary such that not all SGI^{xyz}s are the same. When used in Table 4, a SGI^{xyz} is less than a finished set of gum ingredients.

It should be noted that all of the ingredients of a GBI^{xy} or a GBI^{xyz} could include the ingredients of a GBI^{x} of another mixing process. Further, in an individual given process example that includes mixing a GBI^{x}, GBI^{y} and/or GBI^{z}, a portion of each of the sets of gum base ingredients could include some if not all of the same category of ingredients as the previously added set of gum base ingredients. For example, if elastomer is added in GBI^{x} more of the same elastomer and/or an additional elastomer could be added in GBI^{y} or GBI^{z}. Additionally, in a given process a GBI^{x}, GBI^{y} and/or GBI^{z} could be finished gum bases such that the process mixes individual finished gum bases together to form a new desired gum base such as in kitting as discussed previously.

Similarly, all of the ingredients of a SGI^{xy} or SGI^{xyz} could include the ingredients of a SGI^{x} of another mixing process. Further, in an individual given process example that includes mixing a SGI^{x}, SGI^{y} and/or SGI^{z}, a portion of each of the sets of subsequent gum ingredients could include some if not all of the same category of ingredients as the previously added set of subsequent gum ingredients. For example, if a bulk sweetener is added in SGI^{x} more of the same bulk sweetener and/or an additional bulk sweetener could be added in SGI^{y} or SGI^{z}.

TABLE 4

| | Effluent of | Effluent of | Options For Output of Downstream |
|---|---|---|---|
| Example | Mixer 1 | Mixer 2 | Mixing |
| 1 | GBI^{x} | GBI^{xy} | GBI^{xyz}, FGB, GBI^{xy} + SGI^{x}, GBI^{xyz} + |
| | | | SGI^{x}, FGB + SGI^{x}, GBI^{xy} + FSGI, |
| | | | GBI^{xyz} + FSGI; FG |
| 2 | GBI^{x} | FGB | FGB + SGI^{x}, FG |
| 3 | GBI^{x} | GBI^{x} + SGI^{x} | GBI^{x} + SGI^{xy}, GBI^{xy} + SGI^{x}, GBI^{xy} + |
| | | | SGI^{xy}, GBI^{x} + FSGI, FGB + SGI^{x}, |
| | | | GBI^{xy} + FSGI, FGB + SGI^{xy}, FG |
| 4 | GBI^{x} | GBI^{xy} + SGI^{x} | GBI^{xyz} + SGI^{x}, GBI^{xy} + SGI^{xy}, GBI^{xyz} + |
| | | | SGI^{xy}, FGB + SGI^{x}, GBI^{xy} + FSGI, |
| | | | GBI^{xyz} + FSGI, FGB + SGI^{xy}, FG |
| 5 | GBI^{x} | GBI^{x} + FSGI | GBI^{xy} + FSGI, FG |
| 6 | GBI^{x} | GBI^{xy} + FSGI | GBI^{xyz} + FSGI, FG |
| 7 | GBI^{x} | FG | — |
| 8 | SGI^{x} | SGI^{xy} | SGI^{xyz}, FSGI, GBI^{x} + SGI^{xy}, GBI^{x} + |
| | | | SGI^{xyz}, GBI^{x} + FSGI, FGB + SGI^{xy}, |
| | | | FGB + SGI^{xyz}, FG |
| 9 | SGI^{x} | FSGI | GBI^{x} + FSGI, FG |
| 10 | SGI^{x} | GBI^{x} + SGI^{x} | GBI^{x} + SGI^{xy}, GBI^{xy} + SGI^{x}, GBI^{xy} + |
| | | | SGI^{xy}, GBI^{x} + FSGI, FGB + SGI^{x}, |
| | | | GBI^{xy} + FSGI, FGB + SGI^{xy}, FG |
| 11 | SGI^{x} | GBI^{x} + SGI^{xy} | GBI^{xy} + SGI^{xy}, GBI^{xy} + SGI^{xyz}, GBI^{x} + |
| | | | SGI^{xyz}, GBI^{x} + FSGI, GBI^{xy} + FSGI, |
| | | | FGB + SGI^{xy}, FGB + SGI^{xyz}, FG |
| 12 | SGI^{x} | FGB + SGI^{x} | FGB + SGI^{xy}, FG |
| 13 | SGI^{x} | FGB + SGI^{xy} | FGB + SGI^{xyz}, FG |
| 14 | SGI^{x} | FG | — |
| 15 | GBI^{x} + SGI^{x} | GBI^{xy} + SGI^{x} | GBI^{xyz} + SGI^{x}, GBI^{xy} + SGI^{xy}, GBI^{xyz} + |
| | | | SGI^{xy}, FGB + SGI^{x}, GBI^{xy} + FSGI, |
| | | | GBI^{xyz} + FSGI, FGB + SGI^{xy}, FG |
| 16 | GBI^{x} + SGI^{x} | FGB + SGI^{x} | FGB + SGI^{xy}, FG |
| 17 | GBI^{x} + SGI^{x} | GBI^{x} + SGI^{xy} | GBI^{xy} + SGI^{xy}, GBI^{x} + SGI^{xyz}, GBI^{xy} + |
| | | | SGI^{xyz}, GBI^{x} + FSGI, GBI^{xy} + FSGI, |
| | | | FGB + SGI^{xy}, FGB + SGI^{xyz}, FG |
| 18 | GBI^{x} + SGI^{x} | GBI^{x} + FSGI | GBI^{xy} + FSGI, FG |
| 19 | GBI^{x} + SGI^{x} | GBI^{xy} + SGI^{xy} | GBI^{xy} + FSGI, GBI^{xyz} + FSGI, FGB + |
| | | | SGI^{xy}, FGB + SGI^{xyz}, GBI^{xy} + SGI^{xyz}, |
| | | | GBI^{xyz} + SGI^{xy}, GBI^{xyz} + SGI^{xyz}, FG |
| 20 | GBI^{x} + SGI^{x} | FGB + SGI^{xy} | FGB + SGI^{xyz}, FG |
| 21 | GBI^{x} + SGI^{x} | GBI^{xy} + FSGI | GBI^{xyz} + FSGI, FG |
| 22 | GBI^{x} + SGI^{x} | FG | — |
| 23 | FGB | FGB + SGI^{x} | FGB + SGI^{xy}, FG |
| 24 | FGB | FG | — |
| 25 | FGB + SGI^{x} | FGB + SGI^{xy} | FGB + SGI^{xyz}, FG |
| 26 | FGB + SGI^{x} | FG | — |
| 27 | FSGI | GBI^{x} + FSGI | GBI^{xy} + FSGI, FG |
| 28 | FSGI | FG | — |
| 29 | GBI^{x} + FSGI | GBI^{xy} + FSGI | GBI^{xyz} + FSGI, FG |
| 30 | GBI^{x} + FSGI | FG | — |

The individual processes of Table 4 will now be discussed in relation to the potential outputs of individual mixers and the types of ingredients that are added to individual mixers during the process.

Processes 1-7 represent mixing processes where the effluent of mixer 1 is a set of gum base ingredients (GBI^{x}s) that does not yet form a gum base. For example, GBI^{x} of mixer 1 could be an elastomer in combination with one or more compounding aids such as a filler and/or an elastomer plasticizer.

In Process 1, the effluent of mixer 1 is added to mixer 2 as an ingredient and added to another set of gum base ingredients, namely GBI^{y}, to form a set of gum base ingredients GBI^{xy}, which is not yet a finished gum base. For example, GBI^{y} could be an additional elastomer, more filler, or other GBI identified in Table 3. Numerous options exist for downstream mixing of effluent GBI^{xy} of mixer 2. Another set of gum base ingredients GBI^{z}, only, could be added to effluent GBI^{xy} to form a gum structure that is either a finished gum base (FGB) or a set of gum base ingredients that does not yet form a FGB (GBI^{xyz}). A first set of subsequent gum ingredients, SGI^{x}, could be added to the effluent of mixer 2 to form a gum structure that is a combination of gum base ingredients plus subsequent gum ingredients that does not yet form a finished gum base (GBI^{xy}+SGI^{x}) or a finished set of subsequent gum ingredients (GBI^{xy}+FSGI). Alternatively, another set of gum base ingredients GBI^{z} and a set of subsequent gum ingredients (SGI^{x}) could be added to effluent GBI^{xy} to form a gum structure that is either a finished gum base plus some subsequent gum ingredients that do not form a finished set of subsequent gum ingredients (FGB+SGI^{x}); a set of gum base ingredients and subsequent gum ingredients that is both less than a finished gum base and a finished set of subsequent gum ingredients (GBI^{xyz}+SGI^{x}); a set of gum base ingredients that is less than a finished gum base but includes a finished set of subsequent gum ingredients (GBI^{xyz}+FSGI); or forms a finished gum product (FG) that includes both a finished gum base and a finished set of subsequent gum ingredients.

Process 2 is similar to Example 1 in that only gum base ingredients are added to effluent GBI^{x} of mixer 1. However, in this embodiment, the additional gum base ingredients add to effluent GBI^{x} in mixer 2 are sufficient to form a finished gum base (FGB). As the effluent FGB of mixer 2 includes all of the gum base ingredients necessary for the contemplated gum structure, no more gum base ingredients will typically be added in downstream mixing. Thus, potential options for downstream mixing are limited to adding a set of subsequent gum ingredients SGI^{x}. The set of subsequent gum ingredients SGI^{x} may be a finished set of subsequent gum ingredients FSGI such that the effluent of continuous mixer is a finished gum composition (FG). Alternatively, the set of subsequent gum ingredients SGI^{x} may be less than a finished set of subsequent gum ingredients such that the effluent of the down stream mixing is a finished gum base in combination with some subsequent gum ingredients that is not yet a finished gum composition (FGB+SGI^{x}). This second option would be subjected to further processing by a secondary system. This could occur such as when kitting occurs and the final ingredient set that may be added may be some bulking agents such as bulk sweeteners at a local plant.

Process 3 adds a set of subsequent gum ingredients SGI^{x} that is not yet a finished set of subsequent gum ingredients (FSGI) to the effluent GBI^{x} of mixer 1 to form effluent GBI^{x}+SGI^{x} of mixer 2. Numerous downstream mixing options occur for effluent GBI^{x}+SGI^{x} of mixer 2. An additional set of gum base ingredients GBI^{y}, only, may be added to form a combination of gum base ingredients plus subsequent gum ingredients that does not yet form a finished gum base, but is closer to a FGB, or a finished set of subsequent gum ingredients (GBI^{xy}+SGI^{x}) or a finished gum base plus a set a subsequent gum ingredients that does not yet form a finished set of subsequent gum ingredients (FGB+SGI^{x}). Alternatively, an additional set of subsequent gum ingredients SGI^{y}, only, may be added to form a combination of gum base ingredients plus subsequent gum ingredients that does not yet form a finished gum base or a finished set of subsequent gum ingredients, but is closer to a FSGI, (GBI^{x}+SGI^{xy}) or a finished set of subsequent gum ingredients plus a set a gum base ingredients that does not yet form a finished gum base (GBI^{x}+FSGI). Alternatively, another set of gum base ingredients GBI^{y} and another set of subsequent gum ingredients SGI^{y} could be added to effluent GBI^{x}+SGI^{x} to form either a gum structure that is of a set of gum base ingredients and subsequent gum ingredients that is less than either a FGB or FSGI, but is closer to a FGB and FSGI, (GBI^{xy}+SGI^{xy}); a gum structure that includes a finished gum base plus a set of subsequent gum ingredients that is less than a FSGI (FGB+SGI^{xy}); a gum structure that is less than a gum base plus a finished set of subsequent gum ingredients (GBI^{xy}+FSGI); or a finished gum composition (FG).

Process 4 adds an additional set of gum base ingredients GBI^{y} and a set of subsequent gum ingredients SGI^{x} to effluent GBI^{x} of mixer 1. However, the gum structure effluent GBI^{xy}+SGI^{x} of mixer 2 is less than a FGB or a FSGI. Numerous downstream mixing options occur for effluent GBI^{xy}+SGI^{x} of mixer 2. An additional set of gum base ingredients GBI^{z}, only, may be added to form a combination of gum base ingredients plus subsequent gum ingredients that does not yet form a finished gum base (GBI^{xyz}+SGI^{x}); or a finished gum base plus a set a subsequent gum ingredients that does not yet form a finished set of subsequent gum ingredients (FGB+SGI^{x}). Alternatively, an additional set of subsequent gum ingredients SGI^{y}, only, may be added to form a combination of gum base ingredients plus subsequent gum ingredients that does not yet form a finished gum base or a finished set of subsequent gum ingredients (GBI^{xy}+SGI^{xy}); or a finished set of subsequent gum ingredients plus a set a gum base ingredients that does not yet form a finished gum base (GBI^{xy}+FSGI). Alternatively, another set of gum base ingredients GBI^{z} and another set of subsequent gum ingredients SGI^{y} could be added to effluent GBI^{xy}+SGI^{x} to form either a gum structure that is of a set of gum base ingredients and subsequent gum ingredients that is less than either a FGB or FSGI (GBI^{xyz}+SGI^{xy}); a gum structure that includes a finished gum base plus a set of subsequent gum ingredients that is less than a FSGI (FGB+SGI^{xy}); a gum structure that is less than a gum base plus a finished set of subsequent gum ingredients (GBI^{xyz}+FSGI); or a finished gum composition (FG).

Process 5 adds a set of subsequent gum ingredients SGI^{x} to mixer 2 that is a finished set of subsequent gum ingredients to effluent GBI^{x} of mixer 1. The subsequent gum ingredients added to effluent GBI^{x} in mixer 2 are sufficient to form a finished set of subsequent gum ingredients. As effluent GBI^{x}+FSGI of mixer 2 includes all of the subsequent gum ingredients necessary for a contemplated gum structure, no more subsequent gum ingredients will typically be added in downstream mixing. Thus, potential options for downstream mixing are limited to adding a set of gum base ingredients GBI^{y}. The set of gum base ingredients GBI^{y} may finish the set of gum base ingredients such that the effluent of continuous mixer is a finished gum composition (FG). Alternatively, the set of gum base ingredients GBI^{y} may be less than a finished gum base such that the effluent of downstream mixing is a finished set of subsequent gum ingredients in combination with some gum base ingredients that are not yet a finished gum base (GBI^{xy}+FSGI).

Process 6 adds an additional set of gum base ingredients GBI^{y} and a set of subsequent gum ingredients SGI^{x} to mixer 2 that is a finished set of subsequent gum ingredients to effluent GBI^{x} of mixer 1. The set of gum base ingredients GBI^{y} add to effluent GBI^{x} in mixer 2 is not sufficient to form a finished gum base. However, as effluent GBI^{xy}+FSGI of mixer 2 includes all of the subsequent gum ingredients necessary for a contemplated gum structure, no more subsequent gum ingredients will typically be added in downstream mixing. Thus, potential options for downstream mixing are limited to adding a set of gum base ingredients GBI^{z}. The set of gum base ingredients GBI^{z} may finish the set of gum base ingredients such that the effluent of continuous mixer is a finished gum composition (FG). Alternatively, the set of gum base ingredients GBI^{z} in combination with the previously added gum base ingredients GBI^{xy} may be less than a finished gum base such that the effluent of downstream mixing is a finished set of subsequent gum ingredients in combination with some gum base ingredients that are not yet a finished gum base (GBI^{xyz}+FSGI).

Process 7 adds an additional set of gum base ingredients GBI^{y} and a set of subsequent gum ingredients SGI^{x} to effluent GBI^{x} of continuous mixer 502. The additional set of gum base ingredients GBI^{y} is sufficient to form finished gum base and the set of subsequent gum ingredients SGI^{x} is sufficient to form a finished set of subsequent gum ingredients. As such, the effluent of continuous mixer 504 is a finished gum composition (FG). No further gum base or subsequent gum ingredients are typically added to the effluent of continuous mixer 504 and thus only two mixers are required for this embodiment.

Process 8-14 represent mixing processes where the effluent of mixer 1, such as mixer 102, 502 of mixing system 100, 500, is a set of subsequent gum ingredients (SGI^{x}s) that does not yet form a finished set of subsequent gum ingredients (FSGI).

In Process 8, the effluent of mixer 1 is added to mixer 2 as an ingredient and added to another set of subsequent gum ingredients, namely SGI^{y}, to form a set of subsequent gum ingredients SGI^{xy}, which is not yet a finished set of subsequent gum ingredients. Numerous options exist for downstream mixing of effluent SGI^{xy} of mixer 2. Another set of subsequent gum ingredients SGI^{z}, only, could be added to effluent SGI^{xy} to form a gum structure that is either a finished set of subsequent gum ingredients (FSGI) or a set of subsequent gum ingredients that does not yet form a finished set of subsequent gum ingredients (SGI^{xyz}). A set of gum base ingredients GBI^{x} could be added to the effluent of mixer 2 to form a gum structure that is a combination of gum base ingredients plus subsequent gum ingredients that does not yet form a FGB or FSGI (GBI^{x}+SGI^{xy}) or a finished gum base plus a set of subsequent gum ingredients that does not yet form a FSGI (FGB+SGI^{xy}). Alternatively, another set of subsequent gum ingredients SGI^{z} and a set of gum base ingredients GBI^{x} could be added to effluent SGI^{xy} to form a gum structure that is either a finished gum base plus some subsequent gum ingredients that do not form a finished set of subsequent gum ingredients (FGB+SGI^{xyz}); a set of gum base ingredients and subsequent gum ingredients that is both less than a finished gum base and a finished set of subsequent gum ingredients (GBI^{x}+SGI^{xyz}); a set of gum base ingredients that is less than a finished gum base but includes a finished set of subsequent gum ingredients (GBI^{xyz}+FSGI); or a finished gum product (FG) that includes both a finished gum base and a finished set of subsequent gum ingredients.

In processes where subsequent gum ingredients are added upstream of gum base ingredients that require compounding, it may be beneficial to add the subsequent gum ingredient effluent of an upstream mixer downstream of some of the compounded gum base ingredients. For example and with reference to FIG. 1 and example 8 above, the effluent of continuous mixer 104 is an SGI^{xy} and therefore is complete subsequent gum ingredients. In downstream mixing where a gum base ingredient GBI^{x} is added to continuous mixer 106, this SGI^{xy} may be added to continuous mixer 106 at feed port 164 and the gum base ingredients GBI^{x} may be added at an upstream feed port such as feed port 162. The gum base ingredients can be compounded and then exposed to a cooling device or process prior to being mixed with the SGI^{xy}. This may allow the subsequent gum ingredients SGI^{xy} to be shielded from the high heat and shear that occurs during compounding an elastomer.

Process 9 is similar to Example 8 in that only subsequent gum ingredients are added to effluent SGI^{x} of mixer 1. However, in this embodiment, the additional set of subsequent gum ingredients add to effluent SGI^{x} in mixer 2 is sufficient to form a finished set of subsequent gum ingredients (FSGI). As the effluent FSGI of mixer 2 includes all of the subsequent gum ingredients necessary for the contemplated gum structure, no more subsequent gum ingredients will typically be added in downstream mixing. Thus, potential options for downstream mixing are limited to adding a set of gum base ingredients GBI^{x}. The set of gum base ingredients GBI^{x} may be a finished gum base FGB such that the effluent of continuous mixer is a finished gum composition (FG). Alternatively, the set of gum base ingredients GBI^{x} may be less than a finished gum base such that the effluent of downstream mixing is a finished set of subsequent gum ingredients in combination with at least one gum base ingredient that is not yet a FGB (GBI^{x}+FSGI). This second option would be subjected to further processing by a secondary system. This could occur such as when kitting occurs and the final ingredient set that may be added may be some bulking agents such as additional filler or if additional plasticizers are needed.

Process 10 adds a set of gum base ingredients GBI^{x} that is not yet a finished gum base (FGB) to the effluent SGI^{x} of mixer 1 to form effluent GBI^{x}+SGI^{x} of mixer 2. The downstream mixing options for this example are identical as the downstream mixing options for Process 3.

Process 11 adds an additional set of subsequent gum ingredients SGI^{y} and a set of gum base ingredients GBI^{x} to effluent SGI^{x} of mixer 1. However, the gum structure effluent GBI^{x}+SGI^{xy} of mixer 2 is less than a FGB or a FSGI. Numerous downstream mixing options occur for effluent GBI^{x}+SGI^{xy} of mixer 2. An additional set of gum base ingredients GBI^{y}, only, may be added to form a combination of gum base ingredients plus subsequent gum ingredients that does not yet form a finished gum base (GBI^{xy}+SGI^{xy}); or a finished gum base plus a set a subsequent gum ingredients that does not yet form a finished set of subsequent gum ingredients (FGB+SGI^{xy}). Alternatively, an additional set of subsequent gum ingredients SGI^{z}, only, may be added to form a combination of gum base ingredients plus subsequent gum ingredients that does not yet form a finished gum base or a finished set of subsequent gum ingredients (GBI^{x}+SGI^{xyz}); or a finished set of subsequent gum ingredients plus a set a gum base ingredients that does not yet form a finished gum base (GBI^{zy}+FSGI). Alternatively, another set of gum base ingredients GBI^{y} and another set of subsequent gum ingredients SGI^{z} could be added to effluent GBI^{x}+SGI^{xy} to form either a gum structure that is a set of gum base ingredients and subsequent gum ingredients that is less than either a FGB or FSGI (GBI^{xy}+SGI^{xyz}); a gum structure that includes a finished gum base plus a set of subsequent gum ingredients that is less than a FSGI (FGB+SGI^{xyz}); a gum structure that is less than a gum base plus a finished set of subsequent gum ingredients (GBI^{xy}+FSGI); or a finished gum composition (FG).

Process 12 adds a set of gum base ingredients GBI^{x} to mixer 2 that is a finished gum base to effluent SGI^{x} of mixer 1. As effluent FGB+SGI^{x} of mixer 2 includes a finished gum base, no more gum base ingredients will typically be added in downstream mixing. Thus, potential options for downstream mixing are limited to adding a set of subsequent gum ingredients SGI^{y}. The set of subsequent gum ingredients SGI^{y} may finish the set of subsequent gum ingredients such that the effluent of continuous mixer is a finished gum composition (FG). Alternatively, the set of subsequent gum ingredients SGI^{y} in combination with the previously added subsequent gum ingredients may not form a finished set of subsequent gum ingredients such that the effluent of downstream mixing is a finished gum base in combination with less than a finished set of subsequent gum ingredients (FGB+SGI^{xy}).

Process 13 adds an additional set of subsequent gum ingredients SGI^{y} and a set of gum base ingredients GBI^{x} to mixer 2 that is a finished gum base to effluent SGI^{x} of mixer 1. As effluent FGB+SGI^{xy} of mixer 2 includes a finished gum base, no more gum base ingredients will typically be added in downstream mixing. Thus, potential options for downstream mixing are limited to adding a set of subsequent gum ingredients SGI^{z}. The set of subsequent gum ingredients SGI^{z} in combination with subsequent gum ingredients SGI^{xy} may finish the set of subsequent gum ingredients such that the effluent of continuous mixer is a finished gum composition (FG). Alternatively, the set of subsequent gum ingredients SGI^{z} in combination with the previously added subsequent gum ingredients SGI^{xy} may not form a finished set of subsequent gum ingredients such that the effluent of downstream mixing is a finished gum base in combination with less than a finished set of subsequent gum ingredients (FGB+SGI^{xyz}).

Process 14 adds a set of gum base ingredients GBI^{x} and an additional set of subsequent gum ingredients SGI^{y} to effluent SGI^{x} of continuous mixer 502. The set of gum base ingredients GBI^{x} is sufficient to form a finished gum base and the additional set of subsequent gum ingredients SGI^{y} is sufficient to form a finished set of subsequent gum ingredients. As such, the effluent of continuous mixer 504 is a finished gum composition (FG). No further gum base or subsequent gum ingredients are typically added to the effluent of continuous mixer 504 and thus only two mixers are required for this embodiment.

Process 15-22 represent mixing processes where the effluent of mixer 1, such as mixer 102, 502 of mixing system 100, 500, respectively, is a set of gum base ingredients (GBI^{x}) that is less than a finished gum base in combination with set of subsequent gum ingredients (SGI^{x}) that does not yet form a finished set of subsequent gum ingredients (GBI^{x}+SGI^{x}). If the gum base ingredients are not yet compounded elastomer when added to mixer 1, the gum base ingredients will typically be added prior to the subsequent gum ingredients such that the gum base ingredients can be subjected to some cooling prior to adding any subsequent gum ingredients. However, if the subsequent gum ingredients that are being added are not subject to degradation when exposed to high temperatures, such an order of addition to mixer 1 would not be necessary.

In Process 15, effluent GBI^{x}+SGI^{x} of mixer 1 is added to mixer 2 as an ingredient and added to another set of gum base ingredients, namely GBI^{y}, to form a set of gum base ingredients GBI^{xy}+SGI^{x}, which is not yet a finished gum base or a finished set of subsequent gum ingredients. Numerous options exist for downstream mixing of effluent GBI^{xy}+SGI^{x} of mixer 2. Another set of gum base ingredients GBI^{z}, only, could be added to form a gum structure that is either a finished gum base plus a set of subsequent gum ingredients that is less than a finished set of subsequent gum ingredients (FGB+SGI^{x}) or a set of gum base ingredients that does not yet form a FGB in combination with a set of subsequent gum ingredients that is less than a finished set of subsequent gum ingredients (GBI^{xyz}+SGI^{x}). Another set of subsequent gum ingredients SGI^{y}, only, could be added to the effluent of mixer 2 to form a gum structure that is a combination of gum base ingredients plus subsequent gum ingredients that does not yet form a finished gum base (GBI^{xy}+SGI^{xy}) or a finished set of subsequent gum ingredients (GBI^{xy}+FSGI). Alternatively, another set of gum base ingredients GBI^{z} and a set of subsequent gum ingredients (SGI^{y}) could be added to effluent GBI^{xy}+SGI^{x} to form a gum structure that is either a finished gum base plus some subsequent gum ingredients that do not form a finished set of subsequent gum ingredients (FGB+SGI^{xy}); a set of gum base ingredients and subsequent gum ingredients that is both less than a finished gum base and a finished set of subsequent gum ingredients (GBI^{xyz}+SGI^{xy}); a set of gum base ingredients that is less than a finished gum base but includes a finished set of subsequent gum ingredients (GBI^{xyz}+FSGI); or forms a finished gum product (FG) that includes both a finished gum base and a finished set of subsequent gum ingredients.

Process 16 adds an additional set of gum base ingredients GBI^{y} to effluent GBI^{x}+SGI^{x} of mixer 1. In this embodiment, the additional set of gum base ingredients added to effluent GBI^{x}+SGI^{x} in mixer 2 is sufficient to form a finished gum base. As the effluent of mixer 2 includes all of the gum base ingredients necessary for the contemplated gum structure, no more gum base ingredients will typically be added in downstream mixing. Thus, potential options for downstream mixing are limited to adding an additional set of subsequent gum ingredients SGI^{y}. The set of subsequent gum ingredients SGI^{y} may be sufficient to form a finished set of subsequent gum ingredients FSGI such that the effluent of downstream mixing is a finished gum composition (FG). Alternatively, the set of subsequent gum ingredients SGI^{y} in combination with the previously added set of subsequent gum ingredients may be insufficient to form a finished set of subsequent gum ingredients such that the effluent of downstream mixing is a finished gum base in combination with some subsequent gum ingredients that is not yet a finished gum composition (FGB+SGI^{xy}).

In Process 17, effluent GBI^{x}+SGI^{x} of mixer 1 is added to mixer 2 as an ingredient and added to another set of subsequent gum ingredients, namely SGI^{y}, to form a set of gum base ingredients GBI^{x}+SGI^{xy}, which is not yet a finished gum base or a finished set of subsequent gum ingredients. Numerous options exist for downstream mixing of effluent GBI^{x}+SGI^{xy} of mixer 2. Another set of gum base ingredients GBI^{y}, only, could be added to form a gum structure that is either a finished gum base plus a set of subsequent gum ingredients that is less than a finished set of subsequent gum ingredients (FGB+SGI^{xy}) or a set of gum base ingredients that does not yet form a FGB in combination with a set of subsequent gum ingredients that is less than a finished set of subsequent gum ingredients (GBI^{xy}+SGI^{xy}). Another set of subsequent gum ingredients SGI^{z}, only, could be added to the effluent of mixer 2 to form a gum structure that is a combination of gum base ingredients plus subsequent gum ingredients that does not yet form a finished gum base (GBI^{x}+SGI^{xyz}) or a finished set of subsequent gum ingredients (GBI^{x}+FSGI). Alternatively, another set of gum base ingredients GBI^{y} and a set of subsequent gum ingredients (SGI^{z}) could be added to effluent GBI^{x}+SGI^{xy} to form a gum structure that is either a finished gum base plus some subsequent gum ingredients that do not form a finished set of subsequent gum ingredients (FGB+SGI^{xyz}); a set of gum base ingredients and subsequent gum ingredients that is both less than a finished gum base and a finished set of subsequent gum ingredients (GBI^{xy}+SGI^{xyz}); a set of gum base ingredients that is less than a finished gum base but includes a finished set of subsequent gum ingredients (GBI^{xy}+FSGI); or forms a finished gum product (FG) that includes both a finished gum base and a finished set of subsequent gum ingredients.

Process 18 adds an additional set of subsequent gum ingredients SGI^{y} to effluent GBI^{x}+SGI^{x} of mixer 1. In this embodiment, the additional set of subsequent gum ingredients SGI^{y} added to effluent GBI^{x}+SGI^{x} in mixer 2 is sufficient to form a finished set of subsequent gum ingredients. As the effluent of mixer 2 includes all of the subsequent gum ingredients necessary for the contemplated gum structure, no more subsequent gum ingredients will typically be added in downstream mixing. Thus, potential options for downstream mixing in are limited to adding an additional set of gum base ingredients GBI^{y}. The set of gum base ingredients GBI^{y} may be sufficient to form a finished gum base such that the effluent of downstream mixing is a finished gum composition (FG). Alternatively, the set of gum base ingredients GBI^{y} in combination with the previously added set of subsequent gum ingredients may be insufficient to form a finished gum base such that the effluent of downstream mixing is a finished set of subsequent gum ingredients in combination with some gum base ingredients that do not yet form a finished gum base (GBI^{xy}+FSGI).

Process 19 adds an additional set of gum base ingredients GBI^{y} and an additional set of subsequent gum ingredients SGI^{y} to effluent GBI^{x}+SGI^{x} of mixer 1 during mixing in mixer 2. However, the gum structure effluent GBI^{xy}+SGI^{xy} of mixer 2 is less than a FGB or a FSGI. Numerous downstream mixing options occur for effluent GBI^{xy}+SGI^{xy} of mixer 2. An additional set of gum base ingredients GBI^{z}, only, may be added to form a combination of gum base ingredients plus subsequent gum ingredients that does not yet form a finished gum base (GBI^{xyz}+SGI^{xy}); or a finished gum base plus a set a subsequent gum ingredients that does not yet form a finished set of subsequent gum ingredients (FGB+SGI^{xy}). Alternatively, an additional set of subsequent gum ingredients SGI^{z}, only, may be added to form a combination of gum base ingredients plus subsequent gum ingredients that does not yet form a finished gum base or a finished set of subsequent gum ingredients (GBI^{xy}+SGI^{xyz}); or a finished set of subsequent gum ingredients plus a set a gum base ingredients that does not yet form a finished gum base (GBI^{xy}+FSGI). Alternatively, another set of gum base ingredients GBI^{z} and another set of subsequent gum ingredients SGI^{z} could be added to effluent GBI^{xy}+SGI^{xy} to form either a gum structure that is of a set of gum base ingredients and subsequent gum ingredients that is less than either a FGB or FSGI (GBI^{xyz}+SGI^{xyz}); a gum structure that includes a finished gum base plus a set of subsequent gum ingredients that is less than a FSGI (FGB+SGI^{xyz}); a gum structure that is less than a gum base plus a finished set of subsequent gum ingredients (GBI^{xyz}+FSGI); or a finished gum composition (FG).

Process 20 adds an additional set of gum base ingredients GBI^{y} and an additional set of subsequent gum ingredients SGI^{y} to effluent GBI^{x}+SGI^{x} of mixer 1 during mixing in mixer 2. However, in this example, the additional set of gum base ingredients GBI^{y} is sufficient to form a finished gum base. As such, the effluent of mixer 2 is a finished gum base in combination with a set of subsequent gum ingredients that does not form a finished set of subsequent gum ingredients (FGB+SGI^{xy}). The downstream mixing options for this example are the same as for Example 13.

Process 21 adds an additional set of gum base ingredients GBI^{y} and an additional set of subsequent gum ingredients SGI^{y} to effluent GBI^{x}+SGI^{x} of mixer 1 during mixing in mixer 2. However, in this example, the additional set of subsequent gum ingredients SGI^{y} is sufficient to form a finished set of subsequent gum ingredients. As such, the effluent of mixer 2 is a set gum base ingredients that does not form a finished gum base in combination with a finished set of subsequent gum ingredients (GBI^{xy}+FSGI). The downstream mixing options for this example are the same as for Process 6.

Process 22 adds an additional set of gum base ingredients GBI^{y} and an additional set of subsequent gum ingredients SGI^{y} to effluent GBI^{x}+SGI^{x} of continuous mixer 502 during mixing in continuous mixer 504. It will be seen that only two mixers are needed for this example. In this example, the additional set of gum base ingredients GBI^{y} and additional set of subsequent gum ingredients SGI^{y} are sufficient to form, respectively, a finished gum base and a finished set of subsequent gum ingredients. As such, the effluent of continuous mixer 504 is a finished gum composition (FG). No further gum base or subsequent gum ingredients are typically added to the effluent of continuous mixer 504 and thus only two mixers are required for this embodiment.

In Process 23, the effluent of mixer 1 is a finished gum base. As the effluent FGB of mixer 1 includes all of the gum base ingredients necessary for the contemplated gum structure, no more gum base ingredients will typically be added in subsequent downstream mixing. Thus, in this example a first set of subsequent gum ingredients SGI^{x} is added to effluent FGB of mixer 102 such that the effluent of mixer 104 is a finished gum base in combination with a set of subsequent gum ingredients that is not a finished set of subsequent gum ingredients (FGB+SGI^{x}). The downstream mixing options are limited, again, to adding an additional set of subsequent gum ingredients SGI^{y}. This additional set of subsequent gum ingredients may be sufficient to form a finished set of subsequent gum ingredients such that the effluent of mixer 2 is a finished gum composition (FG). Alternatively, the additional set of subsequent gum ingredients may not be sufficient to form a finished set of subsequent gum ingredients such that the effluent of downstream mixing is a finished gum base in combination with a set of subsequent gum ingredients that is less than a finished set of subsequent gum ingredients (FGB+SGI^{xy}).

In Process 24, the effluent of continuous mixer 502 is a finished gum base. As the effluent FGB of continuous mixer 502 includes all of the gum base ingredients necessary for the contemplated finished gum base, no more gum base ingredients will typically be added in subsequent downstream mixing. In this example, a set of subsequent gum ingredients is added to the effluent of continuous mixer 502 that is a finished set of subsequent gum ingredients such that the effluent of continuous mixer 504 is a finished gum composition (FG).

In Process 25, the effluent of mixer 1 is a finished gum base plus a set of subsequent gum ingredients SGI^{x} that is less than a finished set of subsequent gum ingredients. As the effluent of mixer 1 includes all of the gum base ingredients necessary for the contemplated gum structure, no more gum base ingredients will typically be added in subsequent downstream mixing. Thus, in this example a second set of subsequent gum ingredients SGI^{y} is added to effluent of mixer 102 such that the effluent of mixer 104 is a finished gum base in combination with a set of subsequent gum ingredients that is not a finished set of subsequent gum ingredients (FGB+SGI^{xy}). The downstream mixing options are limited, again, to adding an additional set of subsequent gum ingredients SGI^{z}. This additional set of subsequent gum ingredients may be sufficient to form a finished set of subsequent gum ingredients such that the effluent of downstream mixing is a finished gum composition (FG). Alternatively, the additional set of subsequent gum ingredients may not be sufficient to form a finished set of subsequent gum ingredients such that the effluent of downstream mixing is a finished gum base in combination with a set of subsequent gum ingredients that is less than a finished set of subsequent gum ingredients (FGB+SGI^{xyz}).

In Process 26, the effluent of continuous mixer 502 is a finished gum base plus a set of subsequent gum ingredients SGI^{x} that is less than a finished set of subsequent gum ingredients (FGB+SGI^{x}). As the effluent FGB+SGI^{x} of continuous mixer 502 includes all of the gum base ingredients necessary for the contemplated finished gum base, no more gum base ingredients will typically be added in subsequent downstream mixing. In this example, a set of subsequent gum ingredients is added to the effluent of continuous mixer 502 that forms a finished set of subsequent gum ingredients with the previously added set of subsequent gum ingredients such that the effluent of continuous mixer 504 is a finished gum composition (FG) that does not require any additional downstream mixing.

In Process 27, the effluent of mixer 1 is a finished set of subsequent gum ingredients. As the effluent FSGI of mixer 1 includes all of the subsequent gum ingredients necessary for the contemplated gum structure, no more subsequent gum ingredients will typically be added in subsequent downstream mixing. Thus, in this example a first set of gum base ingredients GBI^{x} is added to effluent FSGI of mixer 102 such that the effluent of mixer 104 is a finished set of subsequent gum ingredients in combination with a set of gum base ingredients that does not form a finished gum base (GBI^{x}+FSGI). The downstream mixing options are limited, again, to adding an additional set of gum base ingredients GBI^{y}. This additional set of gum base ingredients GBI^{y} may be sufficient to form a finished gum base such that the effluent of mixer 2 is a finished gum composition (FG). Alternatively, the additional set of gum base ingredients GBI^{y} may not be sufficient to form a finished gum base such that the effluent of downstream mixing is a finished set of subsequent gum ingredients base in combination with a set of gum base ingredients that is less than a finished gum base (GBI^{xy}+FSGI).

In Process 28, the effluent of continuous mixer 502 is a finished set of subsequent gum ingredients. As the effluent FSGI of continuous mixer 502 includes all of the subsequent gum ingredients necessary for the contemplated finished gum composition, no more subsequent gum ingredients will typically be added in subsequent downstream mixing. In this example, a set of gum base ingredients GBI^{x} is added to the effluent of continuous mixer 502 that is a finished gum base such that the effluent of continuous mixer 504 is a finished gum composition (FG).

In Process 29, the effluent of mixer 1 is a finished set of subsequent gum ingredients plus a set of gum base ingredients GBI^{x} that is less than a finished gum base (GBI^{x}+FSGI). As the effluent of mixer 1 includes all of the subsequent gum ingredients necessary for the contemplated gum structure, no more subsequent gum ingredients will typically be added in subsequent downstream mixing. Thus, in this example a second set of gum base ingredients GBI^{y} is added to the effluent of mixer 102 such that the effluent of mixer 104 is a finished set of subsequent gum ingredients but still does not include a finished gum base (GBI^{xy}+FSGI). The downstream mixing options are limited, again, to adding an additional set of gum base ingredients GBI^{z}. This additional set of gum base ingredients may be sufficient to form a finished gum base such that the effluent of downstream mixing is a finished gum composition (FG). Alternatively, the additional set of gum base ingredients GBI^{z} may not be sufficient to form a finished gum base such that the effluent of downstream mixing is a finished set of subsequent gum ingredients in combination with a set of gum base ingredients that is less than a finished set of subsequent gum ingredients (GBI^{xyz}+FSGI).

In Process 30, the effluent of continuous mixer 502 is a finished set of subsequent gum ingredients plus a set of gum base ingredients GBI^{x} that is less than a finished gum base (GBI^{x}+FSGI). As the effluent GBI^{x}+FSGI of continuous mixer 502 includes all of the subsequent gum ingredients necessary for the contemplated finished gum structure, no more subsequent gum ingredients will typically be added in subsequent downstream mixing. In this example, an additional set of gum base ingredients GBI^{y} is added to the effluent of continuous mixer 502 that forms a finished gum base in combination with the previously added set of gum base ingredients such that the effluent of continuous mixer 504 is a finished gum composition (FG) that does not require any additional downstream mixing.

### Specific Examples Based on Gum Structures of Table 3 and Processes of Table 4

Now that a general conceptual map of mixing processes that can be used with the mixing systems 100-1200 of the present invention, several more specific examples will be described. These examples will use the mixing process examples of Table 4 and the finished gum structures of Table 3. These more specific examples will focus on individual ones of the mixing systems. However, while individual examples described below are discussed with reference to an individual mixing system, one of ordinary skill in the art will recognize that the examples can be extended to other appropriate ones of the various mixing systems, particularly as described previously.

### Specific Example 1

A first contemplated example that will be described will focus on the formation of the finished gum structure of Example 7 of Table 3 using mixing system 300 of FIG. 3 and Process 16 of Table 4.

In this example, mixer 1 takes the form of a continuous mixer 302 in the form of an extruder having a high shear section with high shear extruder elements suitable for dispersive mixing followed by a low shear section with lower shear elements suitable for distributive mixing. The high shear elements may be generally provided between feed ports 321 and 323 while the lower shear mixing elements may be provided between feed ports 324 and 326. While not illustrated, in this example, the high shear section and low shear section can be separated by a chiller portion, such as between feed port 323 and feed port 324.

In mixer 1 (continuous mixer 302), a first set of gum base ingredients GBI^{x} are added. The finished gum base (FGB) of the desired finished gum (FG) is approximately 25% by weight of the FG.

This set of gum base ingredients GBI^{x} includes the following gum base ingredients. A high molecular weight elastomer in the form of butyl rubber is added at a rate of 5% by weight of the desired FGB along with a low molecular weight elastomer in the form of polyisobutylene at a rate of 10% by weight of the desired FGB to mixer 302 at feed port 321. A filler in the form of calcium carbonate is added at a rate of 10% by weight of the desired FGB at feed port 321. In addition, elastomer plasticizers in the form of rosin esters at the rate of 10% by weight of the desired FGB are added at feed port 323. These gum base ingredients of GBI^{x} are used to form an effluent of mixer 1 that includes a compounded elastomer gum structure and are thus subjected to the high shear mixing at a temperature of approximately 325° F. However, as evident from the terminology at this point and gum base Example 2 of Table 2, GBI^{x} is not yet a finished gum base (FGB) for the contemplated finished gum composition of Example 7.

Thereafter, the mixture is to undergo a temperature drop in mixer 1 via a chiller proximate feed ports 323 and 324 to cool the mixture to a temperature of between about 160° F. to 210° F. With the temperature reduced, a set of subsequent gum ingredients SGI^{x} is added. The set of subsequent gum ingredients includes bulk sweeteners in the form of maltitol at a rate of 10% by weight of the C; xylitol at a rate of 10% by weight of the of the desired FG, and sorbitol at a rate of 30% by weight of the FG. The combination of gum base ingredients (GBI^{x}) and subsequent gum ingredients (SGI^{x}) is then expelled from continuous mixer 302.

It can be seen from the terminology and the listing of ingredients in Tables 2-4 that the effluent of mixer 1 is only a partial gum base in combination with a set of subsequent gum ingredients that is not yet a finished set of gum ingredients (i.e. a GBI^{x}+SGI^{x}).

Effluent GBI^{x}+SGI^{x} of continuous mixer 302 is then added to one or more mixer 2s in the form of a lower shear batch mixer(s) 304 in the form of a kettle mixer. Effluent GBI^{x}+SGI^{x} is preferably added to batch mixer in a substantially liquid form with the kettle preheated to approximately 180-190° F.

In the mixer 2, more gum base ingredients GBI^{y} are added. More particularly, the additional gum base ingredients of GBI^{y} include the following ingredients. An additional elastomer in the form of polyvinyl acetate at the rate of 25% by weight of the desired FGB is added. Also, plasticizers/emulsifiers in the form of lecithin, triacetin, and glycerol monosterate are added at a rate of 8% by weight of the desired FGB. Further, waxes at a rate of 12% by weight and oils in the form of vegetable oils at the rate of 20% by weight of the desired FGB are added to mixer 2. Mixing of the ingredients in mixer 2 occurs for approximately 30 minutes. The final temperature should range from 160° F. to 210° F. As evidenced by Example 2 of Table 2, the gum structure effluent of batch mixer 304 (i.e. mixer 2) is a finished gum base (FGB) in combination with some subsequent gum ingredients (SGI^{x}) but is not yet a finished gum composition as the effluent does not include all of the subsequent gum ingredients necessary for the contemplated finished gum composition of Example 7 of Table 3. Thus, with reference to Process 16 of Table 4, the effluent of batch mixer 304 is a FGB+SGI^{x}.

To complete the gum structure, an additional set of subsequent gum ingredients SGI^{y} sufficient to form a finished set of gum ingredients are added in a third mixer to the effluent of batch mixer 304 to form a finished gum composition. The third mixer, which performs downstream mixing in Table 4, is in the form of continuous mixer 306. Continuous mixer 306 is a low shear extruder. The set of subsequent gum ingredients SGI^{y} includes the following ingredients. Sweeteners in the form of erythritol added at a rate of 10% by weight of the desired FG, hydrogenated starch hydrolysates at a rate of 5% by weightof the desired FG are added. Fluids in the form of glycerin are added at a rate of 3% by weight of the desired FG. The desired flavor is added at a rate of 1% by weight of the desired FG. Additional emulsifier such as in the form of lecithin is added at a rate of 1% by weight of the FG. Also, high intensity flavors in the form of sucralose is added at a rate of 2% by weight of the FG. An amount of acid that complements the flavor is addedat a rate of 2.8% by weight of the FG. Finally, the desired color is added at a rate of 0.2% by weight of the FG. The subsequent gum ingredients of SGI^{y} are added at low temperatures such as approximately 90° F. to prevent degradation to the ingredients.

As can be seen from Example 7 of Table 3, all of the gum structure ingredients have now been added. Thus, the effluent of continuous mixer 306 (the downstream mixing mixer) is a finished gum structure (FG).

### Specific Example 2

A second contemplated example that will be described will focus on the formation of the finished gum structure of Example 10 of Table 3 using the mixing system of FIG. 5 and Process 26 of Table 4. In this example, mixer 1 takes the form of continuous mixer 502 in the form of an extruder having a high shear section with high shear extruder elements suitable for dispersive mixing followed by a low shear section with lower shear elements suitable for distributive mixing. The high shear elements may be generally provided between feed ports 521 and 523. The lower shear mixing elements may be provided between feed ports 524 and 526. While not illustrated, in this example, the high shear section and low shear section can be separated by a chiller portion, such as between feed port 523 and feed port 524.

In mixer 1 (continuous mixer 502), a set of gum base ingredients GBI^{x} are added that are sufficient to form a finished gum base (FGB). The FGB of the desired FG for this example forms approximately 30% by weight of the FG.

Thus, all of the gum base ingredients of gum base Example 5 are added to mixer 1. These gum base ingredients include a high molecular weight elastomer in the form of butyl rubber added at a rate of 5% by weight of the desired FGB along with a low molecular weight elastomer in the form of polyisobutylene at a rate of 15% by weight of the desired FGB added to mixer 502 at feed port 521. A filler in the form of talc is added at a rate of 15% by weight of the desired FGB also added at feed port 521. Elastomer plasticizers in the form of rosin esters at the rate of 10% by weight of the desired FGB are added at feed port 523. These gum base ingredients of GBI^{x} are used to form a compounded elastomer gum structure and are thus subjected to the high shear mixing at a temperature of approximately 325° F. Further added to the mixture of mixer 1 in one or more of feed ports 524-526 are an additional elastomer in the form of polyvinyl acetate at the rate of 25% by weight of the desired FGB. Also, plasticizers/emulsifiers in the form of lecithin, triacetin, and glycerol monosterate are added at a rate of 5% by weight of the desired FGB. Waxes at a rate of 5% by weight of the desired FGB and oils in the form of vegetable oils at the rate of 20% by weight of the desired FGB are added to mixer 1.

As mixer 1 employs a chiller to cool the mixture, with the temperature reduced, a set of subsequent gum ingredients SGI^{x} is added to mixer 1. Subsequent gum ingredients, which include bulk sweeteners in the form of maltitol at a rate of 30% by weight of the desired FG; xylitol at a rate of 10% by weight of the desired FG, and sorbitol at a rate of 30% by weight of the desired FG can be added to mixer 1 downstream of the chiller. The temperature of the mixture with the bulk sweeteners added is preferably held between 160° F. and 200° F. The combination of the finished gum base (FGB) and subsequent gum ingredients (SGI^{x}) is then expelled from continuous mixer 502 as a FGB+SGI^{x}.

Effluent FGB+SGI^{x} of continuous mixer 502 is then added to mixer 2 in the form of a continuous mixer(s) 504 in the form of a low shear extruder, where more subsequent gum ingredients SGI^{y} are added to complete the gum structure. As the process according Process 26 of Table 4 results in a finished gum structure after mixing by mixer 2, the additional set of subsequent gum ingredients SGI^{y} added to the gum structure is sufficient to form a finished set of gum ingredients. The set of subsequent gum ingredients SGI^{y} includes the following ingredients. Sweeteners in the form of erythritol added at a rate of 5% by weight of the desired FG, hydrogenated starch hydrolysates at a rate of 3% by weight of the desired FG and isomalt added at a rate of 5% by weight of the desired FG are added. Fluids in the form of glycerin are added at a rate of 1% by weight of the desired FG. The desired flavor is added at a rate of 2% by weight of the desired FG. Additional emulsifier such as in the form of lecithin is added at a rate of 2% by weight of the desired FG. Also, high intensity sweetners in the form of Ace-K is added at a rate of 1% by weight of the desired FG in addition to encapsulated sweetner in the form of apsartame encapsulated in PVA at a rate of 0.8% by weight of the desired FG. Finally, the desired color is added at a rate of 0.2% by weight of the desired FG. The subsequent gum ingredients of SGI^{y} are mixed at low temperatures such as approximately 90° F. to prevent degradation to the ingredients.

As can be seen from Example 10 of Table 3, all of the gum structure ingredients have now been added. Therefore, the effluent of continuous mixer 504 (the downstream mixing mixer) includes both a finished gum base (FGB) and a finished set of subsequent gum ingredients (FSGI), which forms a finished gum structure (FG).

### Specific Example 3

A third contemplated example relates to kitting and, particularly, kitting where a significant portion of bulk ingredients are added at a remote location. For reference in describing this example, reference will be made to mixing systems 100 of FIG. 1 and FIG. 13. Further, this example will use the gum structure of Example 6 of Table 3 and will employ a mixing process following Process 4 of Table 4 where the downstream mixing results in a finished gum composition (FG). The FGB of this FG forms approximately 30% by weight of the FG.

In this example, mixer 1 will take the form of continuous mixer 102 that is a high shear high temperature extruder used to compound the elastomeric portion of the gum base ingredients GBI^{x} of the finished gum composition. The set of gum base ingredients GBI^{x} added to mixer 1 will include the following ingredients. A high molecular weight elastomer in the form of butyl rubber is added at a rate of 10% by weight of the desired FGB along with a low molecular weight elastomer in the form of polyisobutylene at a rate of 10% by weight of the desired FGB at feed port 121. A portion of the ultimate weight percent of the filler in the form of calcium carbonate is added at a rate of 10% by weight of the desired FGB at feed port 321 to assist in compounding the elastomer. The portion of filler added to mixer 1 is only a portion of the total weight percent of filler added to the gum structure as the rest of the filler will be added at the remote location 114. In addition, elastomer plasticizers in the form of rosin esters are added at a rate of 5% by weight of the desired FGB at feed port 123. These gum base ingredients of GBI^{x} are used to form a compounded elastomer gum structure and are thus subjected to the high shear mixing at a temperature of approximately 325° F. However, as evident from the listing of ingredients for the gum base of Example 1 of Table 2, the GBI^{x} gum structure effluent of mixer 1 is not yet a finished gum base (it could be a master batch) for the contemplated finished gum composition of Example 6.

The effluent GBI^{x} is added to mixer 2 in the form of continuous mixer 104. Continuous mixer 104 is in the form of a low shear extruder. The partial gum base effluent GBI^{x} is mixed with an additional set of gum base ingredients GBI^{y} and a first set of subsequent gum ingredients SGI^{x}.

The set of gum base ingredients GBI^{y} includes the following gum base ingredients. An additional elastomer in the form of polyvinyl acetate at the rate of 5% by weight of the desired FGB is added. Also, plasticizers/emulsifiers in the form of lecithin, triacetin, and glycerol monosterate are added at a rate of 5% by weight of the desired FGB. Further, waxes at a rate of 5% by weight of the desired FGB are added to the gum structure with mixer 2.

Also added to mixer 2 is a set of subsequent gum ingredients SGI^{x} required for the finished gum composition of Example 6 of Table 3. In this example, the set of subsequent gum ingredients SGI^{x} added to mixer 2 includes the lower weight percent gum ingredients except for formula specific ingredients such as flavors, acids and colors. The higher weight percent subsequent gum ingredients, such as bulk sweeteners, and the formula specific ingredients will be added at the remote location 114. As such, fluids in the form of glycerin are added at a rate of 1% by weight of the desired FG. Additional emulsifier such as in the form of lecithin is added at a rate of 8% by weight of the desired FG.

Preferably the ingredients added to mixer 2 are added at a temperature between about 150-210° F.

In this example, the effluent of mixer 2 includes gum base ingredients GBI^{xy} that are less than a finished gum base and a set of subsequent gum ingredients that is less than a finished set of subsequent gum ingredients SGI^{x} forming an effluent illustrated as GBI^{xy}+SGI^{x}. Because this is an example of kitting, the effluent of mixer 2 will be passed to packaging system 116 for forming a storable gum structure in the forms of bricks or pellets. The storable gum structure effluent is then shipped using shipping system 118 to the second plant 114 where it is used as an ingredient by continuous mixer 106, which performs the downstream mixing of Table 4.

At remote location 114, the effluent GBI^{xy}+SGI^{x} of continuous mixer 104 is mixed with the rest of the ingredients to form a finished gum structure. To mix the effluent GBI^{xy}+SGI^{x}, which is delivered to remote location in a solid form, the effluent GBI^{xy}+SGI^{x} is first melted by preheating to a temperature of approximately 65° C. Once the effluent GBI^{xy}+SGI^{x} is melted, it is added to continuous mixer 106, such as at feed port 161.

To finish the gum structure, an additional set of gum base ingredients GBI^{z} and an additional set of subsequent gum ingredients SGI^{y} is added to effluent GBI^{xy}+SGI^{x} with continuous mixer 106. This final set of gum base ingredients includes the rest of the calcium carbonate filler which is added to the mixture at a rate of 30% by weight of the desired FGB. The gum base ingredient of oil is also added in the form of vegetable oils at a rate of 20% by weight of the desired FGB.

Also added to the gum structure at continuous mixer 106 is the final set of subsequent gum ingredients SGI^{y}. As such, bulk sweeteners in the form of sucrose will be added at a rate of 33% by weight of the desired FG and the form of corn syrup will be added at a rate of 20% by weight of the desired FG using continuous mixer 106.

Adding the bulk sweeteners, vegetable oils and the remainder of the filler at the remote location is believed to provide a beneficial result as these ingredients are contemplated to form a large weight percentage of finished gum and can typically be found in many foreign locations. Thus, potentially significantly reducing shipping costs and additional costs relating to these ingredients.

Further included in the set of subsequent gum ingredients SGI^{y} added to the mixture of continuous mixer 106 is the desired flavors added at a rate of 2.8% by weight of the desired FG, the desired acids at a rate of 1% by weight of the desired FG, and the colors added at a rate of 0.2% by weight of the desired FG. Further, high intensity sweeteners in the form of sucralose, ace-K and aspartame are added at rates of 1% by weight of the desired FG, 1% by weight of the desired FG and 3% by weight of the desired FG, respectively. These additional subsequent gum ingredients finish the gum structure. It is desirable to add these ingredients at the remote location 114 as these ingredients can be very location specific and merely varying the flavors and colors can result in various different finished gums. Further, adding much of any of these ingredients can significantly effect the appearance and taste of a finished gum product.

Now that some specific examples have been described to illustrate the formation of gum structures using processes and mixing systems of the present invention. Several more conceptual examples of potential ingredient sets will be provided.

Table 5 provides a map of potential gum base ingredients that could be included in sets of gum base ingredients such as GBI^{X}s, GBI^{y}s, and GBI^{z}s used in the Process 1-30 of Table 4.

TABLE 5

| GBI - | | | | | |
|---|---|---|---|---|---|
| Examples¹ | Elastomer | Filler | Plasticizer | Wax | Fats/Oils |
| 1 | X | | | | |
| 2 | X | X | | | |
| 3 | X | X | X | | |
| 4 | X | X | X | X | |
| 5 | X | X | X | X | X |
| 6 | X | X | | X | |
| 7 | X | X | | X | X |
| 8 | X | X | X | | X |
| 9 | X | X | | | X |
| 10 | X | | X | | |
| 11 | X | | X | X | |
| 12 | X | | X | X | X |
| 13 | X | | X | | X |
| 14 | X | | | X | |
| 15 | X | | | X | X |
| 16 | X | | | | X |
| 17 | | X | | | |
| 18 | | X | X | | |
| 19 | | X | X | X | |
| 20 | | X | X | X | X |
| 21 | | X | | X | |
| 22 | | X | | X | X |
| 23 | | X | X | | X |
| 24 | | X | | | X |
| 25 | | | X | | |
| 26 | | | X | X | |
| 27 | | | X | X | X |
| 28 | | | X | | X |
| 29 | | | | X | |
| 30 | | | | X | X |
| 31 | | | | | X |

¹Anti-oxidant is an optional ingredient that could be added to any one of these GBI options or could be a GBI ingredient itself.

From Table 5, it is clear that it is contemplated that a set of gum base ingredients that could be an effluent or added to a mixer as an ingredient itself is variable and may include one or a plurality of gum base ingredients. For example, a set of gum base ingredients GBI^{x}, GBI^{y}, and/or GBI^{z} used in the Processes 1-30 of Table 4, such as according to option 7 of Table 5, could comprise or consist of for example elastomer in the form of butyl rubber in combination with polyisobutylene; a filler in the form of calcium carbonate; waxes and oils in the form of vegetable oil. In another example, a set of gum base ingredients GBI^{x}, GBI^{y}, and/or GBI^{z} of the Processes 1-30 of Table 4, such as according to option 26 of Table 5, could comprise or consist of for example a plasticizer in the form of lecithin; a wax in the form of caranuba wax; and oils in the form of vegetable oil. In this second example, the set of gum base ingredients does not include any elastomer ingredients, but is still a set of gum base ingredients.

Further, when a single set of gum base ingredients includes more than one ingredient, not all of the ingredients need to be added at a single feed port or at the same time in a mixing cycle. Additionally, a single ingredient added to an individual mixer could be added to a mixer at various locations or at varying times. Further, an individual ingredient such as a filler can form a part of a first set of gum base ingredients GBI^{x} added to a gum structure using a first mixer as well as part of a second set of gum base ingredients GBI^{y} added to a gum structure using a second or third mixer.

Table 6 provides a map of potential gum base ingredients that could be included in sets of gum base ingredients such as SGI^{x}s, SGI^{y}s, and SGI^{z}s used in the Process 1-30 of Table 4.

TABLE 6

| GI- | | | | |
|---|---|---|---|---|
| Examples | Sweeteners¹ | Flavors | Emulsifier | Colors |
| 1 | X | | | |
| 2 | X | X | | |
| 3 | X | X | X | |
| 4 | X | X | X | X |
| 5 | X | | X | |
| 6 | X | | X | X |
| 7 | X | X | | X |
| 8 | X | | X | |
| 9 | X | | | X |
| 10 | | X | | |
| 11 | | X | X | |
| 12 | | X | X | X |
| 13 | | X | | X |
| 14 | | | X | |
| 15 | | | X | X |
| 16 | | | | X |

¹Sweeteners could be bulk sweeteners, high intensity sweeteners or the combination of bulk and high intensity sweeteners and could be in any suitable form

From Table 6, it is clear that it is contemplated that a set of subsequent gum ingredients that could be an effluent or added to a mixer as an ingredient itself is variable and may include one or a plurality of subsequent gum ingredients. For example, a set of subsequent gum ingredients SGI^{x}, SGI^{y}, and/or SGI^{z} used in the Processes 1-30 of Table 4, such as according to option 1 of Table 6, could comprise or consist of for example solely of sweeteners in the form of sorbitol, maltitol and maltitol. In another example, a set of subsequent gum ingredients SGI^{x}, SGI^{y}, and/or SGI^{z} used in the Processes 1-30 of Table 4, also according to option 1 of Table 6, could comprise or consist of for example bulk sweeteners in the form of sucrose and corn syrup. In yet a further example, a set of subsequent gum ingredients SGI^{x}, SGI^{y}, and/or SGI^{z} used in the Processes 1-30 of Table 4, such as according to option 13 of Table 6, could comprise or consist of for example colors and flavors. This option could be beneficial when a master batch has previously been formed and the only remaining processing required it to give the gum structure its final appearance and ultimate flavor.

Further, when a single set of subsequent gum ingredients includes more than one ingredient, not all of the ingredients need to be added at a single feed port or at the same time in a mixing cycle. Additionally, a single subsequent gum ingredient added to an individual mixer could be added to a mixer at various locations or at varying times. Further, an individual ingredient such as a sweetener can form a part of a first set of subsequent gum ingredients SGI^{x} added to a gum structure using a first mixer as well as part of a second set of subsequent gum ingredients SGI^{y} added to a gum structure using a second or third mixer. Further yet, an individual ingredient such as a sweetener can include a combination of a plurality of individual specific ingredients such as for example sorbitol, erithritol, xylitol and maltitol all in combination.

Table 7 provides a further conceptual map of ingredients that may be included in some potential combinations of sets of gum base ingredients (GBI^{x}s, GBI^{y}s, and/or GBI^{z}s) in combination with potential sets of subsequent gum ingredients (SGI^{x}s, SGI^{y}s, and/or SGI^{z}s) used in various ones of the Process 1-30 of Table 4.

TABLE 7

| GBI + SGI | | | | | |
|---|---|---|---|---|---|
| Examples | GBI¹ | Sweeteners² | Flavors | Emulsifier | Colors |
| 1 | X | X | | | |
| 2 | X | X | X | | |
| 3 | X | X | X | X | |
| 4 | X | X | X | X | X |
| 5 | X | X | | X | |
| 6 | X | X | | X | X |
| 7 | X | X | X | | X |
| 8 | X | X | | X | |
| 9 | X | X | | | X |
| 10 | X | | X | | |
| 11 | X | | X | X | |
| 12 | X | | X | X | X |
| 13 | X | | X | | X |
| 14 | X | | | X | |
| 15 | X | | | X | X |
| 16 | X | | | | X |

¹A GBI could be any GBI included in Table 5.
²Sweeteners could be bulk sweeteners, high intensity sweeteners or the combination of bulk and high intensity sweeteners.

From Table 7, it is clear that it is contemplated that a combination of a set of gum base ingredients and a set of subsequent gum ingredients that could be an effluent or added to a mixer as an ingredient itself is variable and may include one or a plurality of subsequent gum ingredients.

For example, a set of subsequent gum ingredients GBI^{x}, GBI^{y}, and/or GBI^{z} in combination with a set of subsequent gum ingredients SGI^{x}, SGI^{y}, and/or SGI^{z} used in various ones of Processes 1-30 of Table 4, such as according to option 17 of Table 5 in combination with option 1 of Table 7, could comprise or consist of for example solely of filler in the form of calcium carbonate and bulk sweeteners in the form of sorbitol, maltitol and maltitol. This may be the case, such as in kitting where the last ingredients added to the gum structure are the large weight percent bulk ingredients.

In another example, a set of subsequent gum ingredients GBI^{x}, GBI^{y}, and/or GBI^{z} a set of subsequent gum ingredients SGI^{x}, SGI^{y}, and/or SGI^{z} used in the Processes 1-30 of Table 4, according to option 3 of Table 5 with option 1 of Table 7, could comprise or consist of for example consist of for example elastomer in the form of butyl rubber in combination with polyisobutylene; a filler in the form of calcium carbonate; and a plasticizer in the form of rosin esters as well bulk sweeteners in the form of sucrose and corn syrup. In this example, the gum base ingredients GBI^{x}, GBI^{y}, and/or GBI^{z} would be added to provide a compounded elastomer portion of the gum structure, while the bulk sweetener would be added as a portion of the subsequent gum ingredients.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1-96. (canceled)

97. A method for making a gum structure, comprising:
mixing gum structures with at least two separate mixers arranged in series; and
wherein mixing includes combining gum base ingredients with a subsequent gum ingredient in at least one of said mixers prior to or simultaneously with making a gum base.

98. The method of claim 97, wherein mixing includes forming a first gum structure with a first one of the at least two separate mixers, forming a second gum structure with a second one of the at least two separate mixers, and forming a third gum structure with a third one of the at least two separate mixers.

99. The method of claim 97, wherein said mixing includes compounding elastomer with at least one filler and at least one plasticizer to generate a gum structure that is less than a gum base; and further comprising:
feeding at least one subsequent gum ingredient selected from the group consisting of: flavors, colors, bulk sweeteners, high intensity sweeteners, sensates, potentiators, acids, functional ingredients, and emulsifiers, downstream of said compounding; and
feeding at least one gum base ingredient along with or downstream of the feeding of the at least one subsequent gum ingredient.

100. The method of claim 99, wherein said mixing includes shearing the elastomer with sufficient shear force in a first mixer to compound the elastomer and form a first gum structure; further comprising outputting the first gum structure to a downstream mixer having a different capacity or operational characteristic than the first mixer, and operating the downstream mixer at a sufficiently lower temperature and/or shear for feeding of at least one subsequent gum ingredient.

101. The method of claim 97, further comprising temporarily storing one of the gum structures between mixers.

102. The method of claim 97, further including cooling the gum base ingredients prior to adding the subsequent gum ingredients, wherein a first residence temperature of the ingredients during compounding exceeds 300° F. and a second residence temperature of the ingredients while adding the subsequent gum ingredient does not exceed 250° F.

103. The method of claim 98, wherein a the gum base ingredients includes a filler, and wherein forming a first gum structure includes mixing a first portion of the filler into the first gum structure and forming of the third gum structure includes mixing a second portion of the filler into the third gum structure.

104. The method of claim 103, wherein the forming the second gum structure forms a gum structure that is less than a finished gum base and less than a finished set of gum ingredients.

105. The method of claim 104, wherein forming the third gum structure forms a finished gum structure by adding an additional set of gum base ingredients and an additional set of subsequent gum ingredients.

106. The method of claim 105, wherein additional set of gum base ingredients includes a first bulking agent and the additional set of subsequent gum ingredients is a second bulking agent; and
wherein the first bulking agent is a filler and the second bulking agent is a bulk sweetener.

107. A mixing system for making a chewing gum structure, comprising:
a first mixer;
a second mixer downstream of the first mixer and in series with the first mixer;
a plurality of ingredient feeders arranged to feed into the mixers, at least one of the ingredient feeders arranged to input at least one subsequent gum ingredient prior to or simultaneously with generating a finished gum base.

108. The mixing system of claim 107, wherein the first mixer is a continuous mixer and the second mixer is a batch mixer;
wherein at least one of the continuous mixers is an extruder;
wherein the extruder includes a high shear dispersive mixing portion and a low shear distributive mixing portion;
wherein the high shear dispersive mixing portion is upstream of the low shear distributive mixing portion and wherein the high shear portion is separated from the low shear portion by a chiller portion; and
wherein the chiller portion is proximate a neutral portion that has a reduced flow rate.

109. The mixing system of claim 107 further including a third mixer downstream of and in series with the second mixer.

110. The mixing system of claim 109, wherein the second and third mixers are located at a location remote from the first mixer; and
wherein a temporary storage device for forming a storable gum structure is downstream of the first mixer and upstream of the second mixer and located at the location of the first mixer.

111. The mixing system of claim 110, wherein the temporary storage device forms a storable gum structure that is selected from the group consisting of solidified pellets or bricks, and wherein a melting device is located at the remote location for melting the storable gum structure prior to the storable gum structure being added to a mixer at the remote location.

112. A method for making a gum structure, comprising:
compounding elastomer filler and elastomer plasticizer; and
combining additional gum base or subsequent gum ingredients with the compounded elastomer to generate a gum structure;
altering the gum structure into a storable gum structure for temporary storage; and
mixing the storable gum structure with at least one additional gum base ingredient to provide a finished gum base characteristic.

113. The method of claim 112, further comprising transporting the storable gum structure to a remote location prior to mixing the storable gum structure with the least one additional gum base ingredient.

114. The method of claim 113, further comprising combining an additional at least one subsequent gum ingredient with the compounded elastomer prior to altering the gum structure into the storable gum structure.

115. The method of claim 112, further comprising combining an additional at least one subsequent gum ingredient with the compounded elastomer after altering the gum structure into the storable gum structure.

116. The method of claim 113, wherein mixing the storable gum structure with at least one additional gum base ingredient to provide a finished gum base characteristic comprises adding filler to the storable gum structure.

117. The method of any one of claims 112, wherein mixing the storable gum structure with at least one additional gum base ingredient to provide a finished gum base characteristic consists of adding filler to the storable gum structure and further comprising adding bulk sweeteners to the storable gum structure.

118. A method for making a gum structure, comprising:
mixing gum base ingredients in a first mixer to generate a first gum structure being other than a gum base; and
mixing at least one additional gum base ingredient and at least one subsequent gum ingredient with the first gum structure in a second mixer to generate a second gum structure.

119. The method of claim 118, wherein the additional at least one gum base ingredient in combination with the first gum structure generates a gum base and the second gum structure is a gum base plus at least one additional subsequent gum ingredient.

120. The method of claim 118, wherein the additional at least one gum base ingredient in combination with the first structure generates a gum base and the at least one subsequent gum ingredient is a finished set of subsequent ingredients and the second gum structure is a finished gum.

121. The method of claim 118, further comprising including mixing at least one subsequent gum ingredient with the second gum structure in a third mixer to form a third gum structure.

122. The method of claim 121, wherein the at least one subsequent gum ingredient mixed with the second gum structure comprises a bulk sweetener.

123. The method of claim 122, wherein the at least one subsequent gum ingredient mixed with the second gum structure comprises a flavor.

124. The method of claim 123, wherein the at least one subsequent gum ingredient mixed with the second gum structure comprises an emulsifier.

125. A method of making a gum structure comprising:
mixing at least a plurality of subsequent gum ingredients in a first mixer to generate a first gum structure being less than a finished set of subsequent gum ingredients; and
mixing the first gum structure with one of at least one additional subsequent gum ingredient or at least one gum base ingredient in a second mixer to form a second gum structure, the second mixer being in series with the first mixer.

126. The method of claim 125, wherein mixing at least one additional subsequent gum ingredient with the first gum structure in the second mixer forms a second gum structure including a finished set of subsequent gum ingredients; and
further comprising mixing the second gum structure with a plurality of gum base ingredients in a third mixer to form a finished gum.

127. The method of claim 125, wherein mixing at least one additional subsequent gum ingredient with the first gum structure in the second mixer forms a second gum structure including a finished set of subsequent gum ingredients;
wherein the second gum structure only includes subsequent gum ingredients;
further including:
mixing the second gum structure with gum base ingredients including an elastomer in a third mixer; and
compounding the elastomer in the third mixer prior to mixing the gum base ingredients with the plurality of subsequent gum ingredients of the second gum structure.

128. The method of claim 127, further comprising cooling the compounded elastomer prior to mixing the compounded elastomer with second gum structure.

129. The method of claim 128, wherein a first residence temperature of the gum base ingredients during compounding exceeds 300° F. and a second residence temperature of the ingredients while adding the second gum structure does not exceed 250° F.

130. The method of claim 125, wherein mixing the at least one gum base ingredient in the second mixer forms a second gum structure including a finished gum base; and
further comprising feeding at least an elastomer portion of the finished gum base to the second mixer upstream of the location the first gum structure is added to the second mixer.

131. The method of claim 130, further comprising mixing the second gum structure with an additional at least one subsequent gum ingredient in a third mixer to form a third gum structure being a finished gum.

132. The method of claim 131, further comprising mixing the first gum structure with at least one additional subsequent gum ingredient in the second mixer.

133. The method of claim 125, further including mixing at least one gum base ingredient with the plurality of subsequent gum ingredients in the first mixer, wherein the first gum structure is less than a finished gum base.

134. The method of claim 133, wherein the second gum structure is less than a finished set of subsequent gum ingredients and is less than a finished gum base.

135. The method of claim 134, further including mixing an additional at least on gum base ingredient and an additional at least one subsequent gum ingredient with the second gum structure in a third mixer to form a third gum structure

136. The method of claim 135, further comprising forming the second gum structure into a storable gum structure.

137. The method of claim 136, further comprising transporting the storable gum structure to a remote location prior to mixing the storable gum structure with the least one additional gum base ingredient and the additional at least one subsequent gum ingredient in the third mixer.

138. The method of claim 137, wherein the additional at least one subsequent gum ingredient in the third mixer includes a bulk sweetener and the additional at least one gum base ingredient in the third mixer includes a filler.

139. The method of claim 125, wherein one of the subsequent gum ingredients that is fed into the first mixer is the same as one of the subsequent gum ingredients that is fed into the second mixer;
wherein the ingredient that is fed into both the first and second mixers is a bulk sweetener; and
wherein the mixing in the first mixer occurs in a location remote from the mixing in the second mixer.

140. The method of claim 134, wherein one of the gum base ingredients that is fed into the first mixer is the same as one of the gum base ingredients that fed into the second mixer;
wherein the ingredient that is fed into both the first and second mixers is a filler;
wherein the mixing in the first mixer occurs in a location remote from the mixing in the second mixer; and
wherein the remote location is a different processing plant.
